(19) United States
(12) Patent Application Publication
(10) Pub. No.: US 2017/0030719 A1
(43) Pub. Date: Feb. 2, 2017

(54) SHAPE DETERMINATION DEVICE, SHAPE DETERMINATION PROGRAM, AND SHAPE DETERMINATION METHOD

(71) Applicant: NEC Corporation, Tokyo (JP)

(72) Inventor: Masahiko ISHIDA, Tokyo (JP)

(21) Appl. No.: 15/106,891

(22) PCT Filed: Sep. 17, 2014
(86) PCT No.: PCT/JP2014/004783

§ 371 Date: Jun. 21, 2016

(30) Foreign Application Priority Data
Dec. 27, 2013 (JP) 2013-271712

(51) Int. Cl. G01C 21/20; G09B 29/10; G08G 5/00

(52) U.S. Cl. CPC G01C 21/20; G08G 5/0095; G09B 29/10

(57) ABSTRACT

A position relation in a region of any shape or size on the earth is determined correctly and highly accurately. A shape determination device 100 includes a candidate point detection unit 31 and an intersection point detection unit 32. The candidate point detection unit 31 detects, as a candidate point, a point of intersection between a first reference circle to which an inputted first line segment on an inputted true sphere belongs and a second reference circle to which an inputted second line segment on the true sphere belongs. The intersection point detection unit 32 determines whether the candidate point is an intersection point between the first line segment and the second line segment.

### TECHNICAL FIELD

The present invention relates to a shape determination device, a shape determination program, and a shape determination method.

### BACKGROUND ART

Nowadays, to perform moving body monitoring on the earth, various navigation systems have been operated. To manage an operation of an aircraft having long moving distance among transport machines, it is necessary to calculate an azimuth and a distance in a wide range. In a navigation system of an aircraft, generally, in a wide region to the extent of a territory and a territorial airspace of a nation or an FIR (Flight Information Region), it is necessary to correctly and efficiently process large-scale space information.

An air route of an aircraft or the like can be expressed, for example, using a line segment connecting two spots on a true sphere. At that time, to secure the safety of the aircraft or the like, it is very important to determine whether two air routes intersect with each other. Further, an aircraft flights in an airspace where an operation thereof is permitted in an airspace set in the sky to secure safety. At that time, when adjacent airspaces are overlapped with each other, a plurality of aircrafts may enter the overlapped region, resulting in a problem from the viewpoint of securing safety. Therefore, in the above-described navigation system, to secure the safety of an aircraft, it is necessary to correctly detect the intersection of air routes or the overlapping of airspaces.

As one example, proposed is a position relation determination device that executes inside/outside determination of an arbitrary point for a polygon (equivalent to an airspace) on the earth (PTL 1). The position relation determination device determines the number of intersection points between a line passing through an object point to be determined and sides of a polygon, and determines in which one of the inside and the outside of the polygon the object point is present in accordance with the number of intersection points. The position relation determination device determines that, for example, when the number of intersection points is odd, the object point is present inside and when the number of intersection points is even, the object point is present outside.

Further, as one example, proposed is a device that executes inside/outside determination of a three-dimensional closed curve (equivalent to an airspace) on the earth using an image projected on a two-dimensional plane (PTL 2). The device projects a closed curve on the earth on a two-dimensional equatorial plane on the basis of a pole (the North Pole or the South Pole).

### CITATION LIST

### Patent Literature

PTL 1: Japanese Patent Application Laid-Open Publication No. 2012-88902
PTL 2: Japanese Patent Application Laid-Open Publication No. 2009-133798

### Non Patent Literature

NPL 1: “Chronological Scientific Tables 2012 (desk size)”, edited by National Astronomical Observatory of Japan, Maruzen Publishing Co., Ltd., p. 581, published on Nov. 25, 2011

### SUMMARY OF INVENTION

### Technical Problem

However, the inventor has found that there are problems in the aforementioned methods as described below. The device of PTL 1 executes inside/outside determination using only the number of intersection points and therefore it is unclear that the device is applicable even to an airspace of any shape, while being simple. Therefore, there is a problem in reliability with the device of PTL 1.

The device of PTL 2 projects a closed curve on the earth on an equatorial plane. Therefore, with respect to an airspace set on the northern hemisphere and the southern hemisphere across the equator, it is difficult for the device to execute indie/outside determination in the first place.

The present invention has been achieved in view of the above-described circumstances. An object of the present invention is to correctly and highly accurately determine a position relation in a region of any shape or size on the earth.

### Solution to Problem

A shape determination device according to an exemplary aspect of the invention includes: a candidate point detection means for detecting, as a candidate point, a point of intersection between a first reference circle to which an inputted first line segment on an inputted true sphere belongs and a second reference circle to which an inputted second line segment on the true sphere belongs; and an intersection point detection means for determining whether the candidate point is an intersection point between the first line segment and the second line segment.

A computer readable storage medium according to an exemplary aspect of the invention records thereon a shape determination program, causing a computer to perform a method including: detecting, as a candidate point, a point of intersection between a first reference circle to which an inputted first line segment on an inputted true sphere belongs and a second reference circle to which an inputted second line segment on the true sphere belongs; and determining whether the candidate point is an intersection point between the first line segment and the second line segment.

A shape determination method according to an exemplary aspect of the invention includes: detecting, as a candidate point, a point of intersection between a first reference circle to which an inputted first line segment on an inputted true sphere belongs and a second reference circle to which an inputted second line segment on the true sphere belongs; and determining whether the candidate point is an intersection point between the first line segment and the second line segment.

### Advantageous Effects of Invention

According to the present invention, it is possible to correctly and highly accurately determine a position relation in a region of any shape or size on the earth.

### BRIEF DESCRIPTION OF DRAWINGS

FIG. 1 is a block diagram schematically illustrating a configuration of a geographical information management device 100 according to a first exemplary embodiment.

FIG. 2 is a diagram illustrating information included in a basic shape database D1.

FIG. 3 is a diagram illustrating information included in an airspace information database D2.

FIG. 4 is a block diagram schematically illustrating a basic configuration of an arithmetic unit 3.

FIG. 5 is a flowchart illustrating an intersection point detection operation of the geographical information management device 100.

FIG. 6 is a diagram illustrating a relation between a spot P₁ and a spot P₂ on a true sphere CB.

FIG. 7 is a diagram illustrating a case in which an azimuth from the spot P₁ to the spot P₂ on the true sphere CB is eastward.

FIG. 8 is a diagram illustrating a case in which an azimuth from the spot P₁ to the spot P₂ on the true sphere CB is westward.

FIG. 9 is a diagram illustrating a circle CC1 on a true sphere CB.

FIG. 10 is a diagram illustrating a circular arc CC2 on a true sphere CB in which a direction from a start point to an end point is counterclockwise.

FIG. 11 is a diagram illustrating a circular arc CC3 on a true sphere CB in which a direction from a start point to an end point is clockwise.

FIG. 12 is a diagram illustrating a line segment L on a true sphere CB.

FIG. 13 is a diagram illustrating two line segments L₁ and L₂ on a true sphere CB.

FIG. 14 is a diagram illustrating a case in which a reference circle C₁ and a reference circle C₂ have two intersection points (are in intersecting contact).

FIG. 15 is a diagram illustrating a case in which the reference circle C₁ and the reference circle C₂ have a separation relation.

FIG. 16 is a diagram illustrating a case in which the reference circle C₁ and the reference circle C₂ have an inclusion relation.

FIG. 17 is a diagram illustrating a case in which the reference circle C₁ and the reference circle C₂ have a circumscribed relation.

FIG. 18 is a diagram illustrating a case in which the reference circle C₁ and the reference circle C₂ have an inscribed relation.

FIG. 19 is a diagram illustrating a case in which the reference circle C₁ and the reference circle C₂ coincide.

FIG. 20 is a diagram illustrating a case in which reference circles coincide and two line segments are separate.

FIG. 21 is a diagram illustrating a case in which reference circles coincide and a start point of one line segment and an end point of the other line segment are overlapped.

FIG. 22 is a diagram illustrating a case in which reference circles coincide and there is one overlapped portion between two line segments.

FIG. 23 is a diagram illustrating a case in which reference circles coincide, a start point of one line segment and an end point of the other line segment are overlapped, and there is one overlapped portion between the two line segments.

FIG. 24 is a diagram illustrating a case in which reference circles coincide and there are two overlapped portions between two line segments.

FIG. 25 is a diagram illustrating a line segment L₁ in which a central angle Ψ is 2π (Ψ=2π).

FIG. 26 is a diagram illustrating a line segment L₁ in which the central angle Ψ is equal to or more than π and less than 2π (π≦Ψ<2π).

FIG. 27 is a diagram illustrating a line segment L₁ in which the central angle Ψ is less than π (0<Ψ<π).

FIG. 28 is a flowchart illustrating an intersection point detection operation of line segments in the geographical information management device 100.

FIG. 29 is a flowchart illustrating candidate point registration processing.

FIG. 30 is a flowchart illustrating range verification processing.

FIG. 31 is a block diagram schematically illustrating a configuration of a geographical information management device 200 according to a second exemplary embodiment.

FIG. 32 is a diagram illustrating an example of an airspace set on a true sphere CB.

FIG. 33 is a diagram illustrating a case in which an airspace A and an airspace B have two intersection points.

FIG. 34 is a diagram illustrating a case in which the airspace A includes the airspace B.

FIG. 35 is a diagram illustrating a case in which the airspace B is inscribed in the airspace A.

FIG. 36 is a diagram illustrating a case in which the airspace A and the airspace B are circumscribed.

FIG. 37 is a flowchart illustrating steps of airspace overlapping determination of the geographical information management device 200.

FIG. 38 is a diagram illustrating an example in which two line segments present on great circles with respect to a true sphere CB have an intersection point.

FIG. 39 is a diagram illustrating a case in which a line segment LA and a line segment LB of FIG. 38 are looked down from the sky of an intersection point Pc.

FIG. 40 is a diagram illustrating another example in which two line segments present on great circles with respect to a true sphere CB have an intersection point.

FIG. 41 is a diagram illustrating a case in which a line segment LA and a line segment LB of FIG. 40 are looked down from the sky of an intersection point Pc.

FIG. 42 is a diagram illustrating an example in which a line segment present on a small circle with respect to a true sphere CB and a line segment present on the small circle or a great circle with respect to the true sphere CB intersect.

FIG. 43 is a diagram illustrating a case in which the line segment LA and the line segment LB of FIG. 42 are looked down from the sky of an intersection point Pc.

FIG. 44 is a diagram illustrating a position relation of a reference circle to which a section Aout belongs and a reference circle to which a section Bin belongs as viewed from directly above an intersection point Pc when Equation (40) is satisfied.

FIG. 45 is a diagram illustrating a position relation of a reference circle to which a section Aout belongs and a reference circle to which a section Bin belongs in which an intersection point Pc is a zenith when Equation (40) is satisfied.

FIG. 46 is a diagram illustrating a position relation of a reference circle to which a section Aout belongs and a reference circle to which a section Bin belongs as viewed from directly above an intersection point Pc when Equation (41) is satisfied.

FIG. 47 is a diagram illustrating a position relation of a reference circle to which a section Aout belongs and a reference circle to which a section Bin belongs in which an intersection point Pc is a zenith when Equation (41) is satisfied.

FIG. 48 is a diagram illustrating a position relation of a reference circle to which a section Aout belongs and a reference circle to which a section Bin belongs as viewed from directly above an intersection point Pc when Equation (42) is satisfied.

FIG. 49 is a diagram illustrating a position relation of a reference circle to which a section Aout belongs and a reference circle to which a section Bin belongs in which an intersection point Pc is a zenith when Equation (42) is satisfied.

FIG. 50 is a diagram illustrating a position relation of a reference circle to which a section Ain belongs and a reference circle to which a section Bout belongs as viewed from directly above an intersection point Pc when Equation (55) is satisfied.

FIG. 51 is a diagram illustrating a position relation of a reference circle to which a section Ain belongs and a reference circle to which a section Bout belongs in which an intersection point Pc is a zenith when Equation (55) is satisfied.

FIG. 52 is a diagram illustrating a position relation of a reference circle to which a section Ain belongs and a reference circle to which a section Bout belongs as viewed from directly above an intersection point Pc when Equation (56) is satisfied.

FIG. 53 is a diagram illustrating a position relation of a reference circle to which a section Ain belongs and a reference circle to which a section Bout belongs in which an intersection point Pc is a zenith when Equation (56) is satisfied.

FIG. 54 is a diagram illustrating a position relation of a reference circle to which a section Ain belongs and a reference circle to which a section Bout belongs as viewed from directly above an intersection point Pc when Equation (57) is satisfied.

FIG. 55 is a diagram illustrating a position relation of a reference circle to which a section Ain belongs and a reference circle to which a section Bout belongs in which an intersection point Pc is a zenith when Equation (57) is satisfied.

FIG. 56 is a flowchart illustrating steps of step S25.

FIG. 57 is a diagram illustrating an example of points set in separation determination executed in a second exemplary embodiment.

FIG. 58 is a diagram illustrating an example of points set in separation determination executed in the second exemplary embodiment.

FIG. 59 is a diagram illustrating an example of points set in separation determination executed in the second exemplary embodiment.

FIG. 60 is a diagram illustrating an example of points set in separation determination executed in the second exemplary embodiment.

FIG. 61 is a diagram illustrating an example of points set in separation determination executed in the second exemplary embodiment.

FIG. 62 is a diagram illustrating an example of points set in separation determination executed in the second exemplary embodiment.

FIG. 63 is a diagram illustrating an example of points set in separation determination executed in the second exemplary embodiment.

FIG. 64 is a diagram illustrating an example of points set in separation determination executed in the second exemplary embodiment.

FIG. 65 is a diagram illustrating an example of points set in separation determination executed in the second exemplary embodiment.

FIG. 66 is a flowchart illustrating steps of position determination of a spot according to a third exemplary embodiment.

FIG. 67 is a block diagram schematically illustrating a configuration of a geographical information management device 400.

FIG. 68 is a diagram illustrating information included in a transformation source information database D4.

FIG. 69 is a flowchart schematically illustrating an operation of the geographical information management device 400.

FIG. 70 is a diagram illustrating a relation between a spheroid EB and an observation object OBJ in the WGS 84 coordinate system.

FIG. 71 is a graph illustrating a latitude line interval ratio and a longitude line interval ratio in a spheroid EB.

FIG. 72 is a diagram illustrating a relation between a true sphere CB and an observation object OBJ.

FIG. 73 is a diagram illustrating information included in a parameter information database D3.

FIG. 74 is a graph illustrating a latitude dependency of a latitude line interval ratio in which a reference latitude θ₀ is a latitude of 36 degrees north.

FIG. 75 is a graph illustrating a latitude dependency of a longitude line interval ratio in which a reference latitude θ₀ is a latitude of 36 degrees north.

FIG. 76 is a graph illustrating latitude dependencies of an error rate Errθ of a latitude line interval and an error rate Errφ of a longitude line interval in which a reference latitude θ₀ is the equator (a latitude of 0 degrees north).

FIG. 77 is a graph illustrating latitude dependencies of an error rate Errθ of a latitude line interval and an error rate Errφ of a longitude line interval in which a reference latitude θ₀ is a latitude of 18 degrees north.

FIG. 78 is a graph illustrating latitude dependencies of an error rate Errθ of a latitude line interval and an error rate Errφ of a longitude line interval in which a reference latitude θ₀ is a latitude of 36 degrees north.

FIG. 79 is a graph illustrating latitude dependencies of an error rate Errθ of a latitude line interval and an error rate Errφ of a longitude line interval in which a reference latitude θ₀ is a latitude of 54 degrees north.

FIG. 80 is a graph illustrating latitude dependencies of an error rate Errθ of a latitude line interval and an error rate Errφ of a longitude line interval in which a reference latitude θ₀ is the North Pole (a latitude of 90 degrees north).

FIG. 81 is a table illustrating, upon changing a reference latitude, a latitude range where an error rate Errφ of a longitude line interval is less than a maximum error of 0.01% in a plane rectangular coordinate system and a latitude range where an error rate Errφ of a longitude line interval is less than an error of 0.04% at a standard meridian in the Universal Transverse Mercator.

FIG. 82 is a graph illustrating latitude dependencies of an error rate Errθ of a latitude line interval and an error rate Errφ of a longitude line interval in which a reference latitude θ₀ is a latitude of 18 degrees north.

FIG. 83 is a diagram illustrating ranges where an error rate Errφ of a longitude line interval near our country is less than 0.01% and less than 0.04% in which a latitude of 35 degrees north and a longitude of 135 degrees east are designated as a reference.

### DESCRIPTION OF EMBODIMENTS

With reference to the accompanying drawings, exemplary embodiments of the present invention will be described. In the drawings, the same element is assigned with the same reference sign, and therefore overlapping description will be omitted as appropriate.

### First Exemplary Embodiment

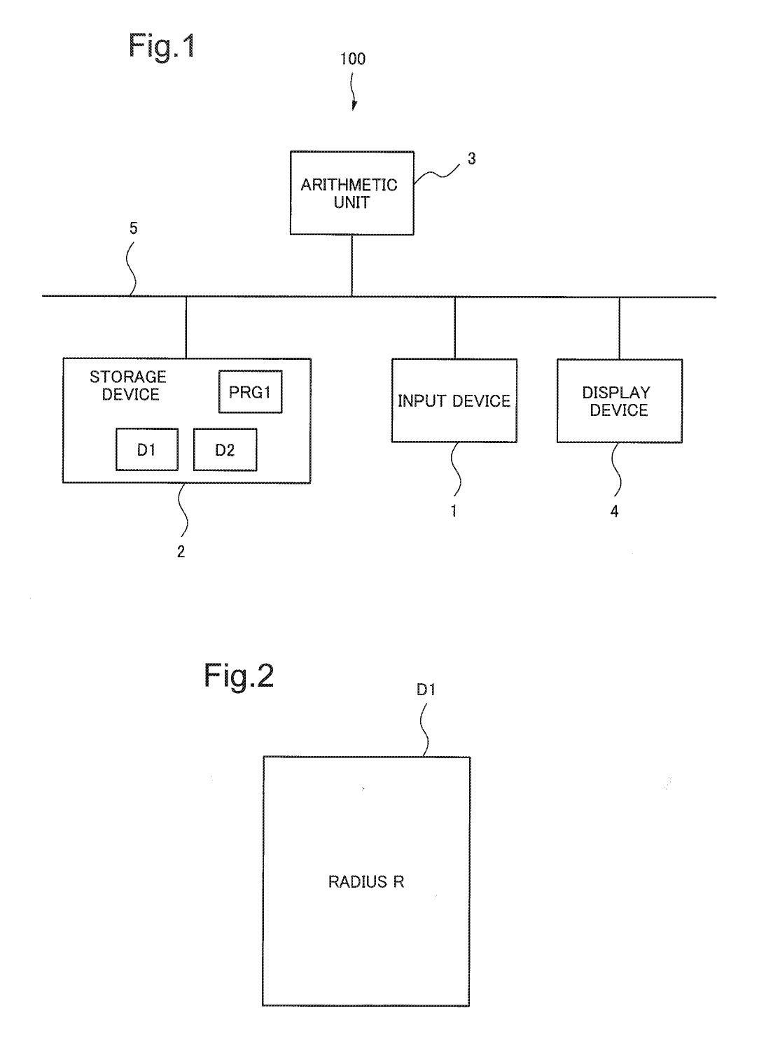

A geographical information management device 100 according to a first exemplary embodiment will be described. FIG. 1 is a block diagram schematically illustrating a configuration of the geographical information management device 100 according to the first exemplary embodiment. The geographical information management device 100 includes an input device 1, a storage device 2, an arithmetic unit 3, a display device 4, and a bus 5. The geographical information management device 100 is configured using a hardware resource such as a computer system or the like.

In general, in the control or navigation calculation of a moving body such as an aircraft or the like moving on the earth, it is necessary to execute arithmetic processing by quantifying map information. In the present exemplary embodiment, the geographical information management device 100 expresses a position on the earth as a position on a true sphere and determines the presence or absence of an intersection of line segments representing air routes on the true sphere or an overlapping of the air routes.

The input device 1 is used to input data from the outside to the geographical information management device 100. As the input device 1, applicable are various types of data input means such as a keyboard, a mouse, a DVD (Digital Versatile Disc) drive, a network connection, or the like.

The storage device 2 can store a database storing data provided via the input device 1 and a program serving for processing in the arithmetic unit 3. As the storage device 2, applicable are various types of storage devices such as a hard disc drive, a flash memory, or the like. Specifically, the storage device 2 stores a basic shape database D1 and an airspace information database D2.

The basic shape database D1 is specific information previously provided. FIG. 2 is a diagram illustrating information included in the basic shape database D1. The basic shape database D1 includes, for example, a radius R of a true sphere CB (the earth).

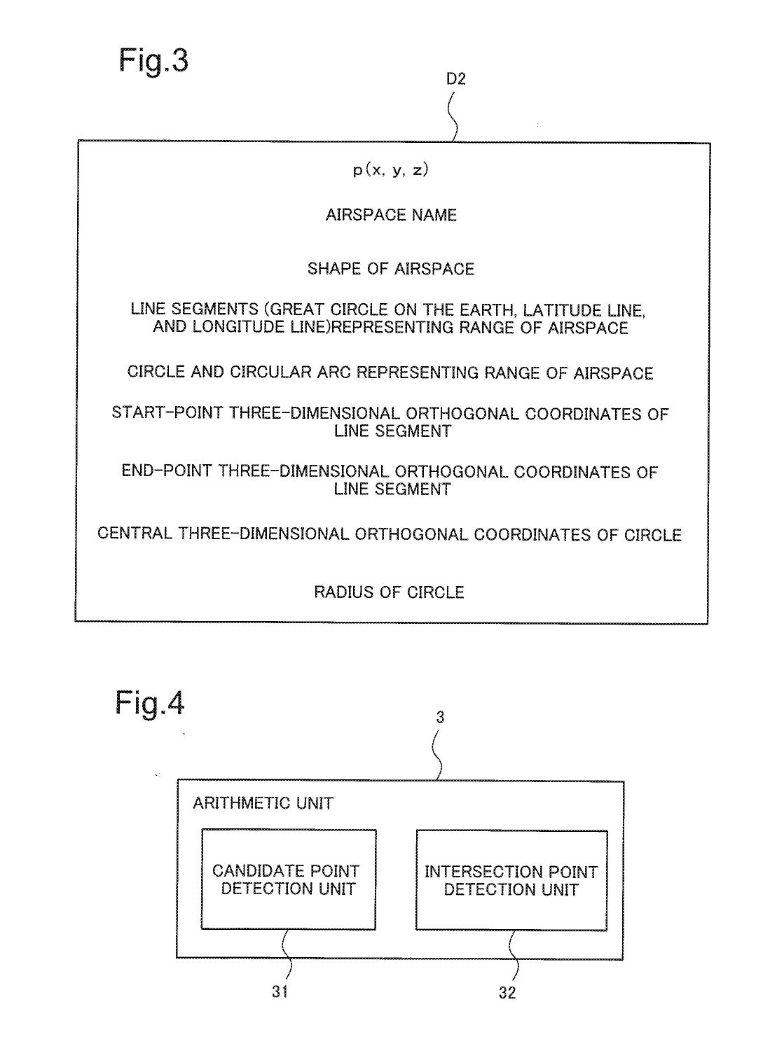

The airspace information database D2 includes coordinate information representing a line segment or an airspace on the true sphere CB. FIG. 3 is a diagram illustrating information included in the airspace information database D2. The airspace information database D2 includes coordinates P (X,Y,Z) of an aircraft in the true sphere CB, a line segment (air route) connecting two spots, an airspace name, and information indicating a shape (a circle, a rectangle, or the like) and a range of the airspace. The airspace information database D2 includes, for example, P(X,Y,Z), three-dimensional orthogonal coordinates of a start point of a line segment, three-dimensional orthogonal coordinates of an end point of the line segment, an airspace shape, line segments (a great circle on the earth, a latitude line, and a longitude line) representing a range of an airspace, information of a circle or a circular arc representing a range of an airspace, three-dimensional orthogonal coordinates of the center and a radius for representing a circle.

Further, the storage device 2 may store a program PRG1 that specifies arithmetic processing for intersection point detection of a line segment to be described later.

The arithmetic unit 3 can read out a program and a database from the storage device 2 and execute necessary arithmetic processing. The arithmetic unit 3 includes, for example, a logic circuit or a CPU (Central Processing Unit). The arithmetic unit 3 is configured as a shape determination device that determines a line segment or a shape of an airspace on the earth expressed by a true sphere.

FIG. 4 is a block diagram schematically illustrating a basic configuration of the arithmetic unit 3. The arithmetic unit 3 includes a candidate point detection unit 31 and an intersection point detection unit 32. Details of the candidate point detection unit 31 and the intersection point detection unit 32 will be described later. It is possible that the geographical information management device 100 includes only the arithmetic unit 3, and parts such as the storage device 2 and the like are present outside the device and connected via a cable, a communication path, or the like.

The display device 4 visibly displays coordinates of an aircraft, operation information, or the like in accordance with an arithmetic result in the arithmetic unit 3. Further, the display device 4 may display a result of intersection point detection of a line segment, to be described later, outputted from the arithmetic unit 3. As the display device 4, various types of display devices such as a liquid crystal monitor, or the like are applicable.

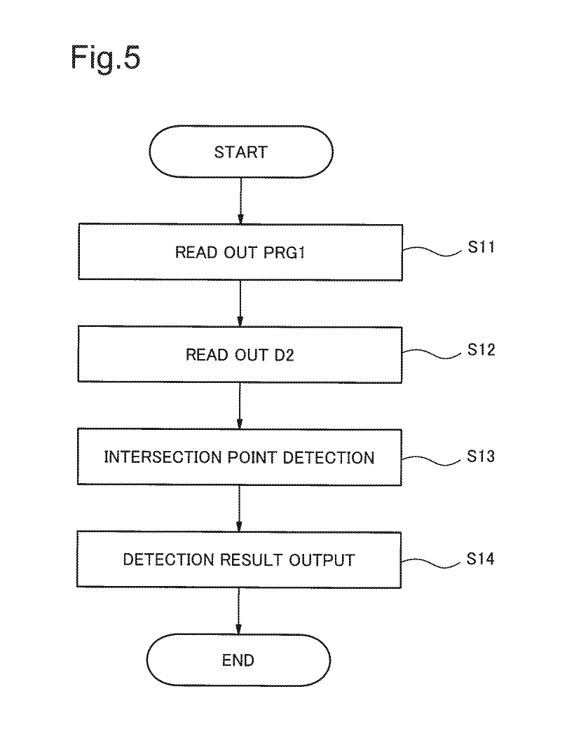

Next, an operation of intersection point detection of the geographical information management device 100 will be described. FIG. 5 is a flowchart illustrating an intersection point detection operation of the geographical information management device 100.

### Step S11

Initially, the arithmetic unit 3 reads the program PRG1. The program PRG1 is a program for determining whether two line segments on a true sphere CB have an intersection point using the airspace information database D2. Thereby, the arithmetic unit 3 functions as a shape determination device including the candidate point detection unit 31 and the intersection point detection unit 32. The program PRG1 is read out, for example, from the storage device 2.

In this example, description has been made, assuming that the arithmetic unit 3 includes a CPU and reads the program PRG1. However, it goes without saying that the arithmetic unit 3 can be configured as a physical entity, for example, a shape determination device interiorly including the candidate point detection unit 31 and the intersection point detection unit 32 including a logic circuit.

### Step S12

The arithmetic unit 3 reads out the airspace information database D2 from the storage device 2.

### Step S13

The arithmetic unit 3 substitutes information included in the airspace information database D2 into a mathematical equation specified by the program PRG1 and executes intersection point detection.

### Step S14

The arithmetic unit 3 outputs a detection result of whether two line segments provided by D2 have an intersection point to the outside. The arithmetic unit 3 outputs a result of the intersection point detection, for example, to the storage device 2.

Details of the intersection point detection in step S13 will be specifically described. To represent a spot of a true sphere CB (on the ground surface), in mathematical equations and figures used in the following description, a vector quantity is represented by a superscript arrow. For description simplification, all vector quantities are normalized. Specifically, a position vector representing a point on the true sphere CB is a normalized position vector obtained through division by a radius R of the true sphere CB included in the basic shape database D1. Hereinafter, for description simplification, a normalized vector will be referred to simply as a vector.

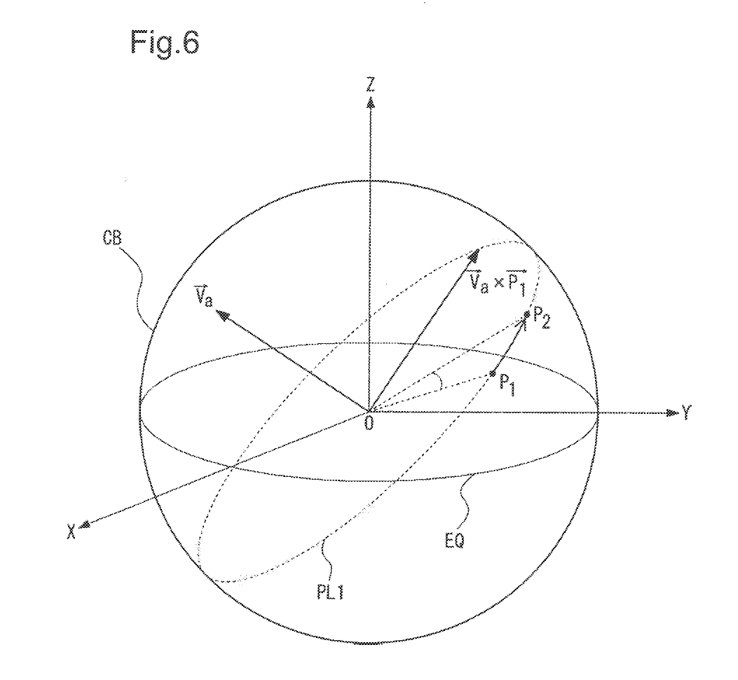

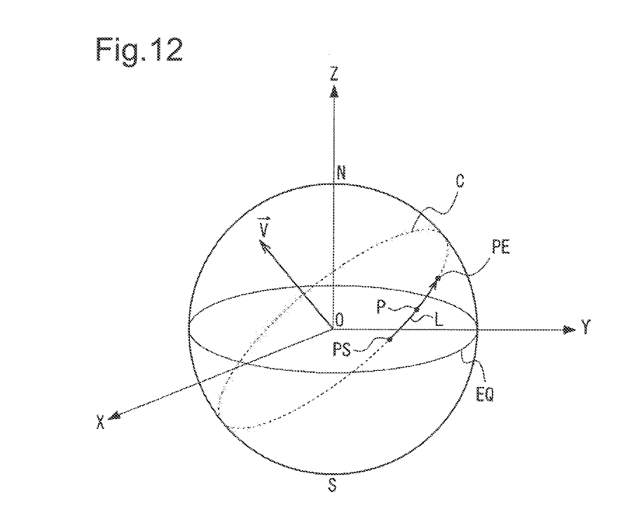

On the true sphere CB, an airspace can be defined as a region surrounded by one line segment or a plurality of line segments that do not intersect with each other. Also, with respect to the region, a left side and a right side of a line segment as viewed from the line segment moving around counterclockwise, i.e. toward a moving direction of the line segment, are defined as a region inside and a region outside, respectively. In general, a line segment on the true sphere CB is a circular arc. The circular arc can be represented as a section sandwiched by a start point and an end point on a circle that is a closed curve. Hereinafter, as an assumption for understanding intersection point detection according to the present exemplary embodiment, an expression method of a line segment on the true sphere CB will be described. In related drawings, for example, FIG. 6, FIG. 12, and following figures, the North Pole, the South Pole, and the equator are denoted as N, S, and EQ, respectively. Further, a position is denoted, unless otherwise specified, on the basis of three-dimensional orthogonal coordinates (hereinafter, referred to simply as three-dimensional coordinates) in which an axis passing through the South Pole and the North Pole in the north pole direction is designated as a Z axis, and two axes orthogonal to each other on a great circle including the equator are designated as an X axis and a Y axis.

### Shortest Route Between Two Spots on a True Sphere

A shortest route between a spot P₁ and a spot P₂ on a true sphere CB (on the ground surface) will be described. FIG. 6 is a diagram illustrating a relation between the spot P₁ and the spot P₂ on the true sphere CB. When a point on a shortest route connecting the spot P₁ and the spot P₂ on the true sphere CB is designated as P, a position vector P indicating the point P satisfies each vector equation represented in following Equation (1). Herein, Va is a unit normal vector with respect to a plane PL1 to which a line segment representing a shortest route between the spot P₁ and the spot P₂ belongs. In addition, sₐ is a cosine of an angle created by the unit normal vector Va and the position vector of the point P and is 0 in this example.

$$\begin{matrix}[ Math . 1 ] & \\ \vec{{V}_{a}} = \frac{( \vec{{P}_{1}} \times \vec{{P}_{2}} )}{\vert \vec{{P}_{1}} \times \vec{{P}_{2}} \vert} \\ ( \vec{{V}_{a}} \cdot \vec{P} ) = {s}_{a} & ( 1 )\end{matrix}$$

### Latitude Line Connecting Two Spots of the Same Latitude

A latitude line connecting the spot P₁ and the spot P₂ of the same latitude on a true sphere CB (on the ground surface) will be described. A latitude line on the true sphere CB (on the ground surface) can be understood as a flight line between two spots in the same latitude on the true sphere CB.

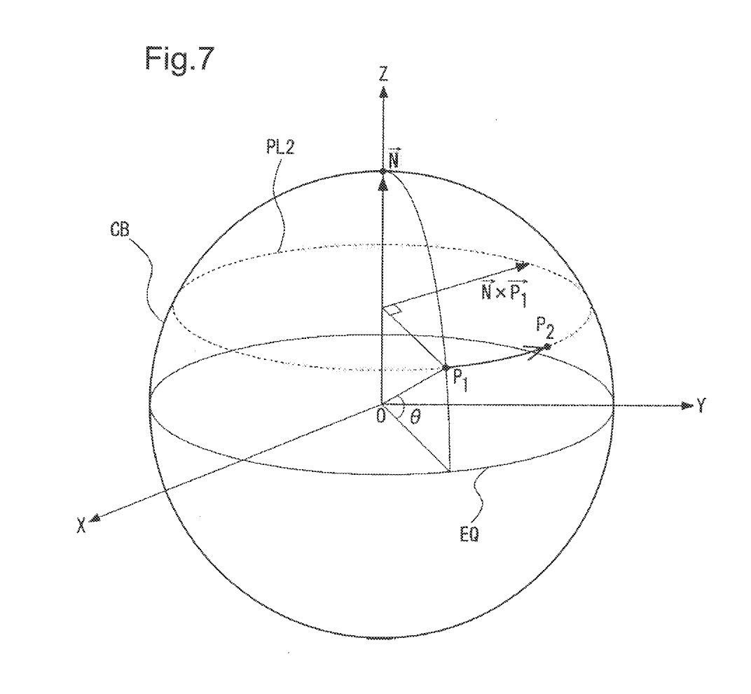

A case in which an azimuth from the spot P₁ (start point) to the spot P₂ (end point) is eastward will be described. FIG. 7 is a diagram illustrating a case in which an azimuth from the spot P₁ to the spot P₂ on a true sphere CB is eastward. When a point on a latitude line where the spot P₁ and the spot P₂ on the true sphere CB are present is designated as P, a position vector of the point P satisfies each vector equation represented in Equation (2). Herein, Vb is a unit normal vector with respect to a plane PL₂ to which the latitude line where the spot P₁ and the spot P₂ are present belongs. A pole N is the North Pole of the true sphere CB. The pane PL₂ is parallel to the latitude line, and therefore the unit normal vector V_{b} and a position vector of the pole N coincide.

[Math. 2]

\vec{V_{b}}=\vec{N}=(0,0,1)

(\vec{V_{b}}·\vec{P})=s_{b} (2)

wherein s_{b} is a sine of an angle θ created by a position vector of the spot P₁ and the spot P₂ and the equatorial plane and is represented by following Equation (3).

[Math. 3]

s_{b}=sin θ (3)

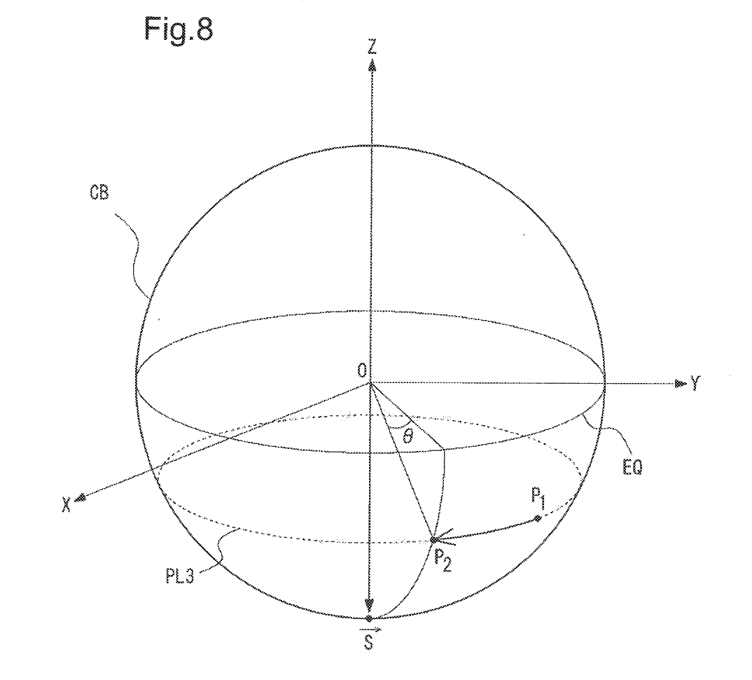

A case in which an azimuth from the spot P₁ (start point) to the spot P₂ (end point) is westward will be described. FIG. 8 is a diagram illustrating a case in which an azimuth from the spot P₁ to the spot P₂ on a true sphere CB is westward. When a point on a latitude line where the spot P₁ and the spot P₂ on the true sphere CB are present is designated as P, a position vector of the point P satisfies each vector equation represented in Equation (4). Herein, V_{c} is a unit normal vector with respect to a plane PL3 to which the latitude line where the spot P₁ and the spot P₂ are present belongs. A pole S (the South Pole of the earth) of the true sphere CB is defined. A position vector representing the pole S is represented by following Equation (4). A plane PL3 is parallel to the latitude line, and therefore the unit normal vector V_{c} and a position vector representing the pole S coincide.

[Math. 4]

\vec{V_{c}}=\vec{S}=(0,0,−1)

(\vec{V_{c}}·\vec{P})=s_{c} (4)

wherein s_{c} is equal in value to a sine of an angle θ created by a position vector of the spot P₁ and the spot P₂ and the equatorial plane and is opposite in sign to the case (FIG. 7) in which an azimuth from the spot P1 (start point) to the spot P2 (end point) is eastward, and is represented by following Equation (5).

[Math. 5]

s_{c}=−sin θ (5)

Circle on a True Sphere

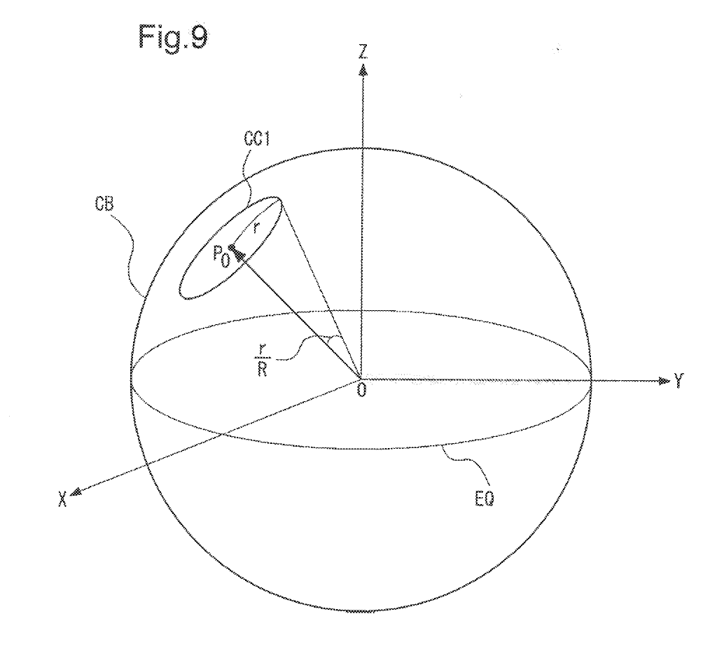

A circle on a true sphere CB will be described. FIG. 9 is a diagram illustrating a circle CC1 on the true sphere CB. The circle CC1 on the true sphere CB can be understood as a set of points where a distance from a given position P₀ is r. A position vector of a point P on a circumference of the circle CC1 satisfies each vector equation of following Equation (6) using the position vector of the point P₀. Herein, R represents a radius of the true sphere CB. V_{d} is a unit normal vector of a plane to which the circle CC1 belongs and coincides with the position vector of the point P₀.

[Math. 6]

\vec{V_{d}}=\vec{P₀}

(\vec{V_{d}}·\vec{P})=s_{d} (6)

wherein s_{d} is a cosine of an angle created by the point P₀ and the point P on the true sphere CB and is represented by following Equation (7).

$$\begin{matrix}[ Math . 7 ] & \\ {s}_{d} = cos ( \frac{r}{R} ) & ( 7 )\end{matrix}$$

Circular Arc Connecting Two Spots on a True Sphere

A circular arc on a true sphere CB will be described. The circular arc on the true sphere CB can be understood as a set of points where a distance from the point P₀ on the true sphere CB is r.

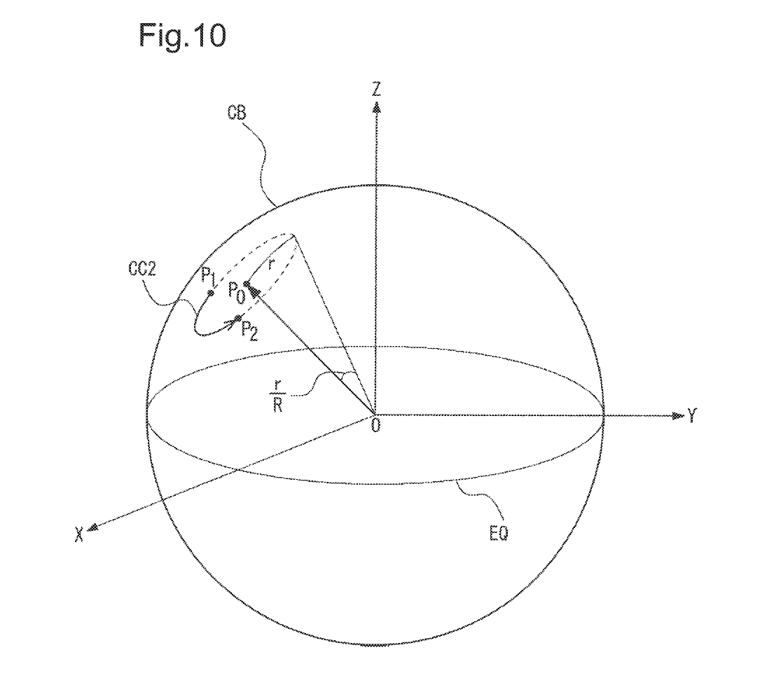

A case in which a direction from a start point to an end point of a circular arc is counterclockwise will be described. FIG. 10 is a diagram illustrating a circular arc CC2 on a true sphere CB in which the direction from the start point to the end point is counterclockwise. When a direction between two points is counterclockwise, a position vector of a point P on the circular arc CC2 satisfies each vector equation of following Equation (8). Herein, R represents a radius of the true sphere CB. Vₑ is a unit normal vector of a plane to which the circular arc CC2 belongs and coincides with a position vector of the point P₀.

[Math. 8]

\vec{Vₑ}=\vec{P₀}

(\vec{Vₑ}·\vec{P})=sₑ (8)

wherein sₑ is a cosine of an angle created by the spot P₀ and the point P on the true sphere and is represented by following Equation (9).

$$\begin{matrix}[ Math . 9 ] & \\ {s}_{e} = cos ( \frac{r}{R} ) & ( 9 )\end{matrix}$$

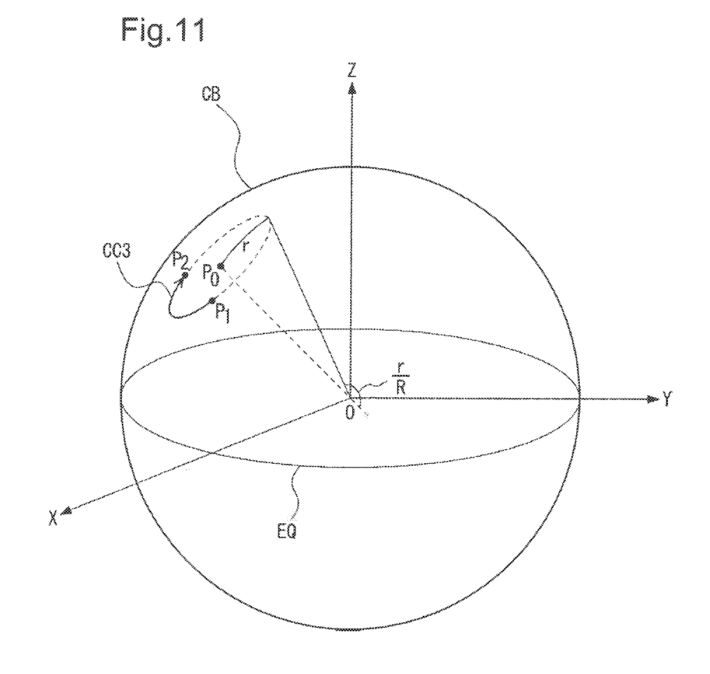

A case in which a direction from a start point to an end point of a circular arc is clockwise will be described. FIG. 11 is a diagram illustrating a circular arc CC3 on a true sphere CB in which a direction from a start point to an end point is clockwise. When a direction between two points is clockwise, a position vector of a point P on the circular arc CC3 satisfies each vector equation of following Equation (10). Herein, R represents a radius of the true sphere CB. Ve is a unit normal vector of a plane to which the circular arc CC3 belongs and is opposite in direction to a position vector of the point P₀. To treat a circular arc as being counterclockwise around a normal vector, the normal vector is opposite in direction to the case of FIG. 10. In other words, a moving direction of a right screw upon moving from a start point to an end point on the circular arc CC3 on a plane is assumed to be a direction of a normal vector of the plane.

[Math. 10]

\vec{Vₑ}=−P₀

(\vec{Vₑ}·\vec{P})=sₑ (10)

wherein sₑ is equal to a cosine of an angle created by the spot P₀ and an arbitrary point P on a circular arc on the true sphere CB and has a negative sign, and is represented by following Equation (11).

$$\begin{matrix}[ Math . 11 ] & \\ {s}_{e} = - cos ( \frac{r}{R} ) & ( 11 )\end{matrix}$$

Next, treatment of a line segment in intersection point detection will be described. Hereinafter, a circle including, as a part thereof, a circular arc that is a line segment on a true sphere CB will be referred to as a reference circle. In this case, it is represented that the circular arc belongs to the reference circle.

FIG. 12 is a diagram illustrating a line segment L on a true sphere CB. In this example, a reference circle to which the line segment L that is a circular arc on the true sphere CB belongs is designated as C. Further, a point on a circumference of the reference circle C is designated as P. When the reference circle is looked down from the sky of the true sphere CB, a route leading from a start point PS to an end point PE counterclockwise on the circumference of the reference circle is defined as a line segment L belonging to the reference circle C. A position vector of the point P on the reference circle C satisfies following Equation (12). In Equation (12), s is a parameter indirectly representing a radius (curvature radius) of the reference circle C. V is a unit normal vector with respect to a plane to which the reference circle C belongs.

[Math. 12]

(\vec{V}·\vec{P})=s (12)

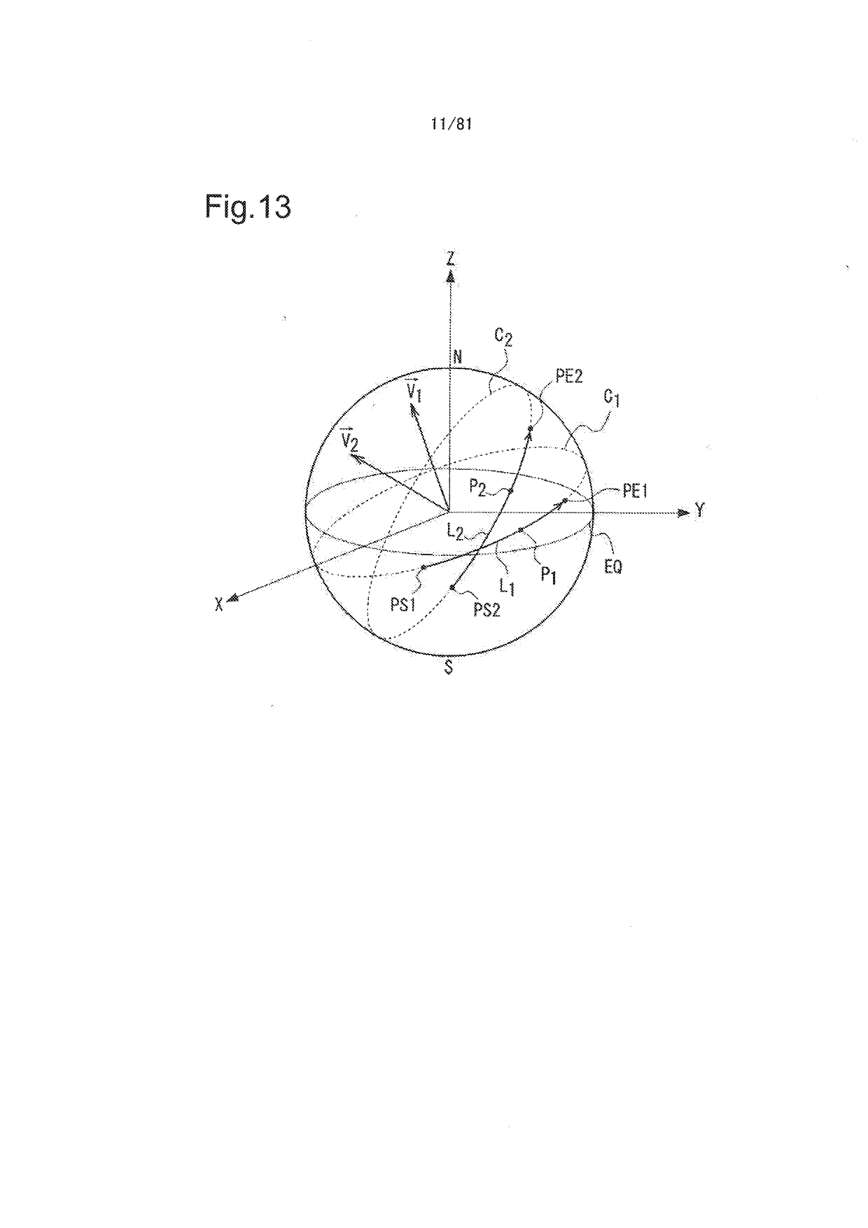

On the basis of the above-described assumption, an example in which two line segments L₁ and L₂ are present on a true sphere CB will be described. FIG. 13 is a diagram illustrating two line segments L₁ and L₂ on a true sphere CB. A reference circle to which the line segment L₁ belongs is designated as C₁, and a reference circle to which the line segment L₂ belongs is designated as C₂. A parameter representing a radius (curvature radius) of the reference circle C₁ is designated as s₁, and a parameter representing a radius (curvature radius) of the reference circle C₂ is designated as s₂. A unit normal vector with respect to a plane to which the reference circle C₁ belongs is designated as V1, and a unit normal vector with respect to a plane to which the reference circle C₂ belongs is designated as V₂. A point on a circumference of the reference circle C₁ is designated as P₁, and a point on a circumference of the reference circle C₂ is designated as P₂. In this case, using Equation (12), following Equation (13) is obtained.

[Math. 13]

(\vec{V₁}·\vec{P₁})=s₁

(\vec{V₂}·\vec{P₂})=s₂ (13)

The candidate point detection unit 31 of the arithmetic unit 3 detects an intersection point (candidate point) between the reference circle C₁ and the reference circle C₂. In the detection, the candidate point detection unit 31 detects an intersection point using a discriminant D described below. Hereinafter, derivation of the discriminant D will be described.

An intersection point between the reference circle C₁ and the reference circle C₂ is designated as Pc. A position vector of the intersection point Pc can be defined by following Equation (14). In Equation (14), β, γ, and δ each are a real number to be described later.

[Math. 14]

\vec{P_{c}}=β\vec{V₁}+γ\vec{V₂}+δ\vec{V₁}×\vec{V₂} (14)

The intersection point Pc needs to satisfy both of the equations in Equation (13). When Equation (14) is substituted into each equation of Equation (13), following Equation (15) is obtained.

[Math. 15]

(\vec{V₁}·\vec{P_{c}})=β+γ(\vec{V₁}·\vec{V₂})=s₁

(\vec{V₂}·\vec{P_{c}})=β(\vec{V₁}·\vec{V₂})+γ=s₂ (15)

When Equation (15) is solved with respect to β and γ, following Equation (16) is obtained.

$$\begin{matrix}[ Math . 16 ] & \\ β = \frac{{s}_{1} - {s}_{2} ( \vec{{V}_{1}} \cdot \vec{{V}_{2}} )}{1 - {( \vec{{V}_{1}} \cdot \vec{{V}_{2}} )}^{2}} \\ γ = \frac{{s}_{2} - {s}_{1} ( \vec{{V}_{1}} \cdot \vec{{V}_{2}} )}{1 - {( \vec{{V}_{1}} \cdot \vec{{V}_{2}} )}^{2}} & ( 16 )\end{matrix}$$

Further, in the intersection point Pc, following Equation (17) is established.

[Math. 17]

(\vec{P_{c}}·\vec{P_{c}})=1 (17)

When using Equation (14), Equation (17) is developed, following Equation (18) is obtained.

[Math. 18]

β₂+γ₂+2βγ(\vec{V₁}·\vec{V₂})+δ²(\vec{V₁}×\vec{V₂})²=1 (18)

When Equation (16) is substituted into Equation (18) which then is solved with respect to δ, following Equation (19) is obtained.

$$\begin{matrix}[ Math . 19 ] & \\ δ = \frac{\pm \sqrt{D}}{1 - {( \vec{{V}_{1}} \cdot \vec{{V}_{2}} )}^{2}} & ( 19 )\end{matrix}$$

wherein D indicated in Equation (19) is a discriminant for the presence or absence of an intersection point and is represented by following Equation (20).

[Math. 20]

D=1−(\vec{V₁}·\vec{V₂})−s₁²−s₂²+2s₁s₂(\vec{V₁}·\vec{V₂}) (20)

Equation (19) includes a square root of the discriminant D. Therefore, a solution of Equation (14) representing the intersection point Pc needs to be divided into cases depending on a value of the discriminant D.

A Case in which the Discriminant D has a Positive Value (D>0)

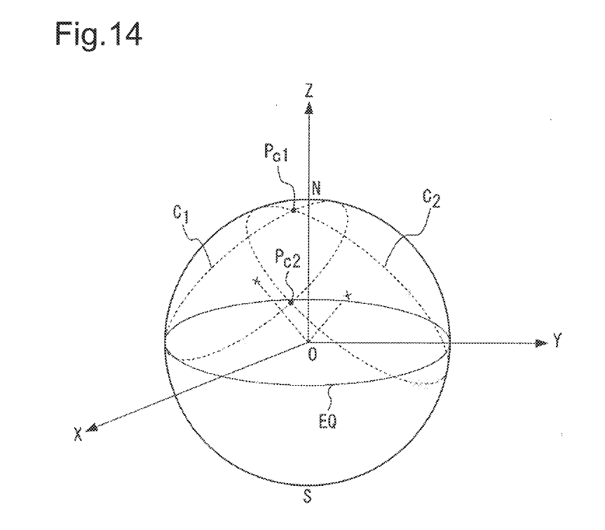

When the discriminant D has a positive value, δ has two values that are positive and negative values having the same absolute value. Therefore, two solutions are obtained for Equation (14) representing the intersection point Pc. In other words, in this case, the reference circle C₁ and the reference circle C₂ intersect at two intersection points Pc₁ and Pc₂ on the true sphere CB. FIG. 14 is a diagram illustrating a case in which the reference circle C₁ and the reference circle C₂ have two intersection points (are in intersecting contact).

When Equation (16) and Equation (19) are substituted into Equation (14), position vectors of the intersection points Pc₁ and Pc₂ are represented by following Equation (21).

$$\begin{matrix} [ Math . 21 ] & \\ \vec{{P}_{c 1}} = \frac{\{ {s}_{1} - {s}_{2} ( \vec{{V}_{1}} \cdot \vec{{V}_{2}} ) \} \vec{{V}_{1}} + \{ {s}_{2} - {s}_{1} ( \vec{{V}_{1}} \cdot \vec{{V}_{2}} ) \} \vec{{V}_{2}} + \sqrt{D} \vec{{V}_{1}} \times \vec{{V}_{2}}}{1 - {( \vec{{V}_{1}} \cdot \vec{{V}_{2}} )}^{2}} \\ \vec{{P}_{c 2}} = \frac{\{ {s}_{1} - {s}_{2} ( \vec{{V}_{1}} \cdot \vec{{V}_{2}} ) \} \vec{{V}_{1}} + \{ {s}_{2} - {s}_{1} ( \vec{{V}_{1}} \cdot \vec{{V}_{2}} ) \} \vec{{V}_{2}} + \sqrt{D} \vec{{V}_{1}} \times \vec{{V}_{2}}}{1 - {( \vec{{V}_{1}} \cdot \vec{{V}_{2}} )}^{2}} & ( 21 )\end{matrix}$$

A Case in which the Discriminant D has a Negative Value (D<0)

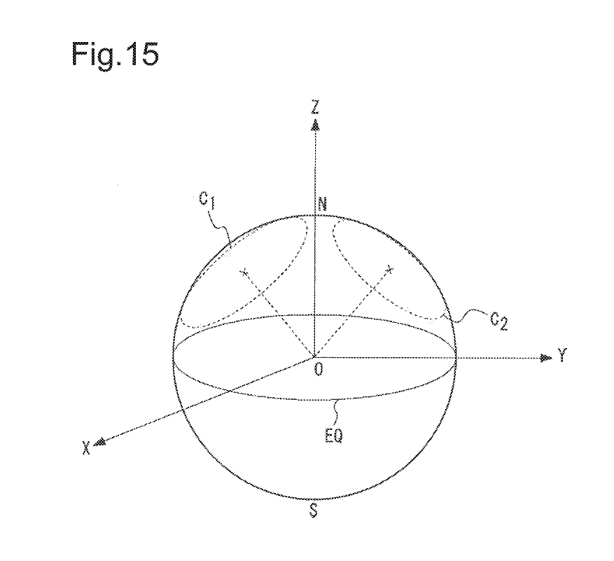

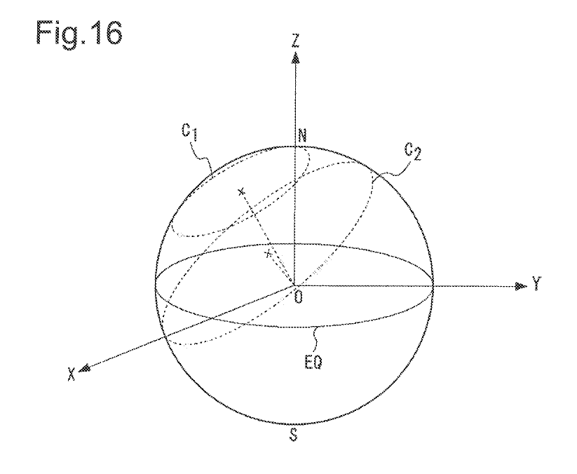

When the discriminant D has a negative value, δ has an imaginary number solution, and therefore the reference circle C₁ and the reference circle C₂ do not have an intersection point. When the reference circle C₁ and the reference circle C₂ do not have an intersection point, the reference circle C₁ and the reference circle C₂ have a separation or inclusion relation. FIG. 15 is a diagram illustrating a case in which the reference circle C₁ and the reference circle C₂ have a separation relation. In this case, as illustrated in FIG. 15, the reference circle C₁ and the reference circle C₂ are spatially isolated and do not have an intersection point. FIG. 16 is a diagram illustrating a case in which the reference circle C₁ and the reference circle C₂ have an inclusion relation. In this case, as illustrated in FIG. 16, while the reference circle C1 and the reference circle C₂ share a region on the true sphere CB, a line segment configuring the reference circle C₁ and a line segment configuring the reference circle C₂ do not have an intersection point.

A Case in which the Discriminant D is 0 (D=0)

When the discriminant D is 0, δ is also 0. In this case, the reference circle C₁ and the reference circle C₂ are in contact with each other. It is conceivable that a state where the reference circle C₁ and the reference circle C₂ are in contact is divided into two states. One state is a case in which the reference circle C₁ and the reference circle C₂ are circumscribed or inscribed having the intersection point Pc as a contact point. The other state is a case in which the reference circle C₁ and the reference circle C₂ coincide.

A Case in which the Reference Circle C₁ and the Reference Circle C₂ are Circumscribed or Inscribed

When the discriminant D is 0 and following Equation (22) is satisfied, the reference circle C₁ and the reference circle C₂ have one intersection point.

[Math. 22]

(\vec{V₁}·\vec{V₂})<1 (22)

In this case, a position vector of an intersection point Pc₀ between the reference circle C₁ and the reference circle C₂ is represented by following Equation (23) when Equation (16) and Equation (19) are substituted into Equation (14).

$$\begin{matrix}[ Math . 23 ] & \\ \vec{{P}_{c 0}} = \frac{\{ {s}_{1} - {s}_{2} ( \vec{{V}_{1}} \cdot \vec{{V}_{2}} ) \} \vec{{V}_{1}} + \{ {s}_{2} - {s}_{1} ( \vec{{V}_{1}} \cdot \vec{{V}_{2}} ) \} \vec{{V}_{2}}}{1 - {( \vec{{V}_{1}} \cdot \vec{{V}_{2}} )}^{2}} & ( 23 )\end{matrix}$$

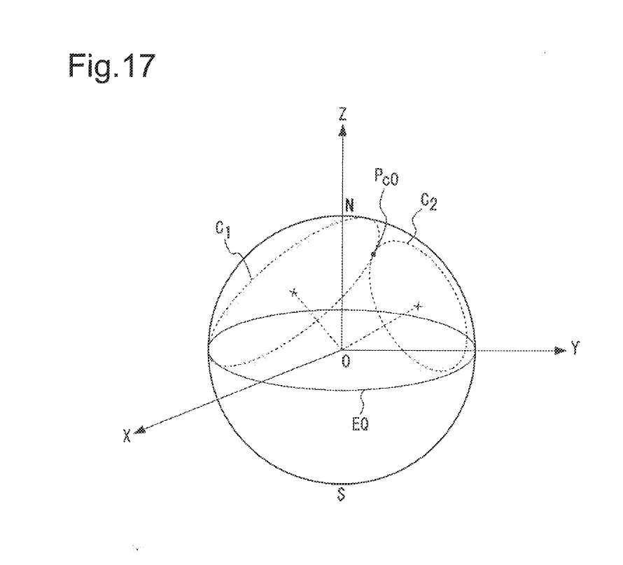

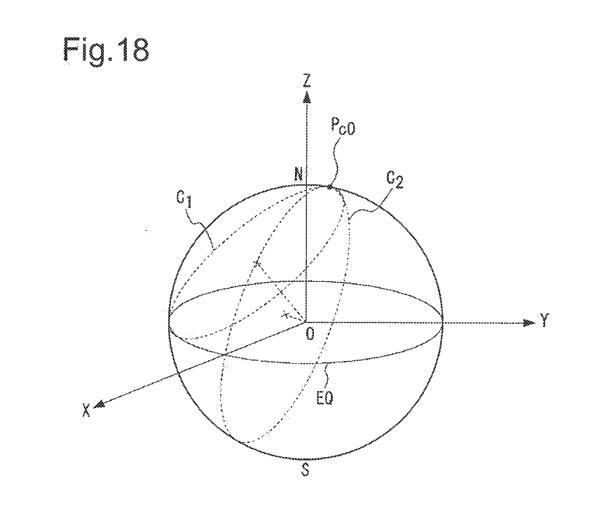

FIG. 17 is a diagram illustrating a case in which the reference circle C₁ and the reference circle C₂ have a circumscribed relation. In this example, the reference circle C₁ and the reference circle C₂ are circumscribed at the intersection point Pc₀. FIG. 18 is a diagram illustrating a case in which the reference circle C₁ and the reference circle C₂ have an inscribed relation. In this example, the reference circle C₁ is inscribed in the reference circle C₂ at the intersection point Pc₀.

A Case in which the Reference Circle C₁ and the Reference Circle C₂ Coincide

Further, when the discriminant D is 0 and following Equation (24) is satisfied, the reference circle C₁ and the reference circle C₂ coincide.

[Math. 24]

(\vec{V₁}·\vec{V₂})=1 (24)

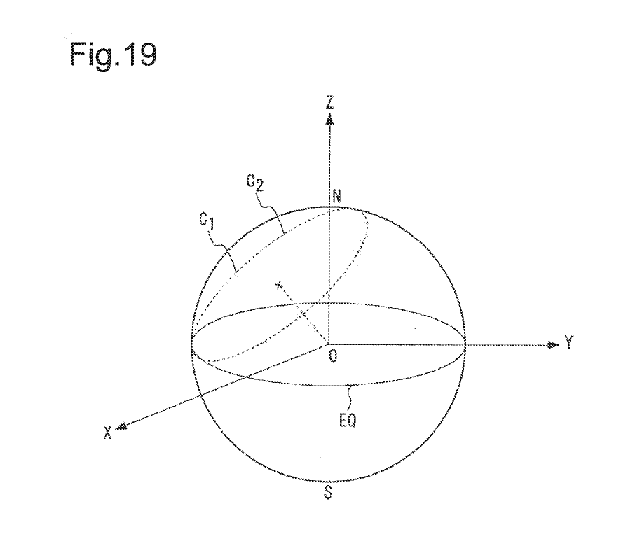

FIG. 19 is a diagram illustrating a case in which the reference circle C₁ and the reference circle C₂ coincide. In this example, the reference circle C₂ is the same circle as the reference circle C₁. In this case, intersection points are present at arbitrary points of the entire circumferences of the reference circle C₁ and the reference circle C₂. In this case, it is assumed that a start point and an end point of each of two line segments are intersection points.

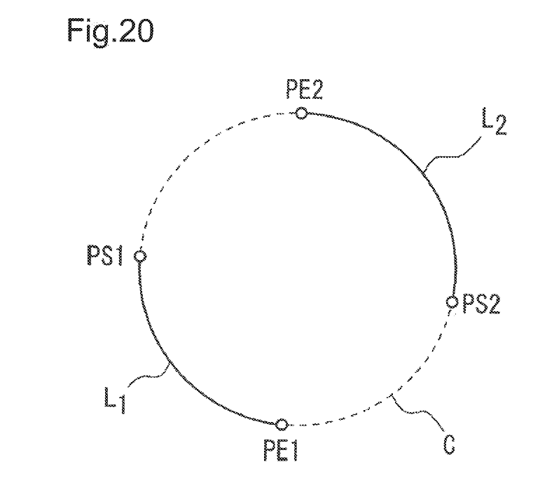

FIG. 20 is a diagram illustrating a case in which reference circles coincide and two line segments are separate. In this case, four points that are a start point PS1 of a line segment L₁, an end point PE1 of the line segment L₁, and a start point PS2 of a line segment L₂, and an end point PE2 of the line segment L₂ are intersection points Pc.

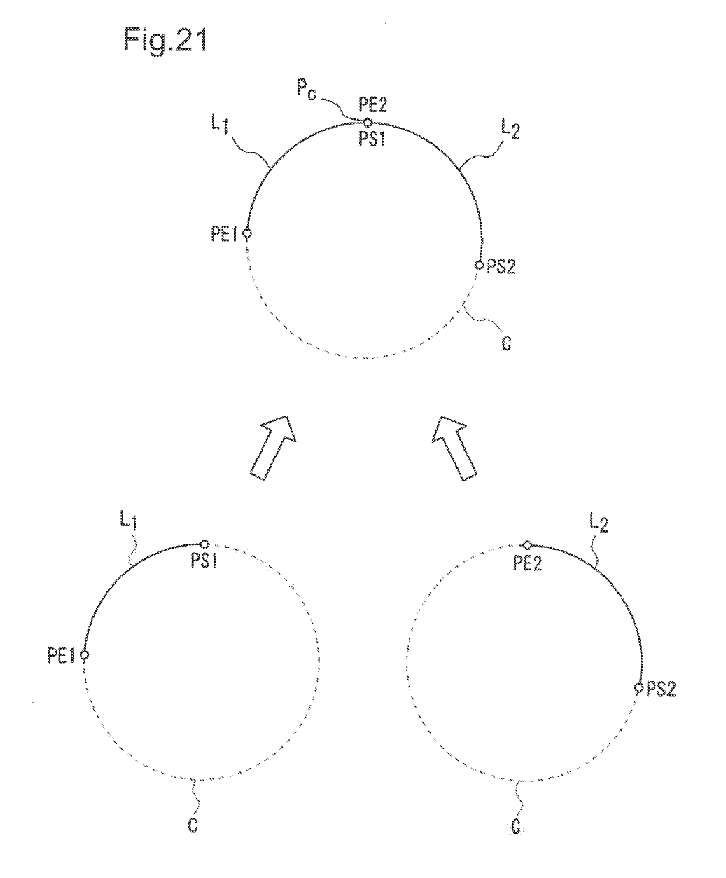

FIG. 21 is a diagram illustrating a case in which reference circles coincide and a start point of one line segment and an end point of the other line segment are overlapped. In this example, three points that are a point that is a start point PS1 of a line segment L₁ and also an end point PE2 of a line segment L₂, an end point PE1 of the line segment L₁, and a start point PS2 of the line segment L₂ are intersection points Pc.

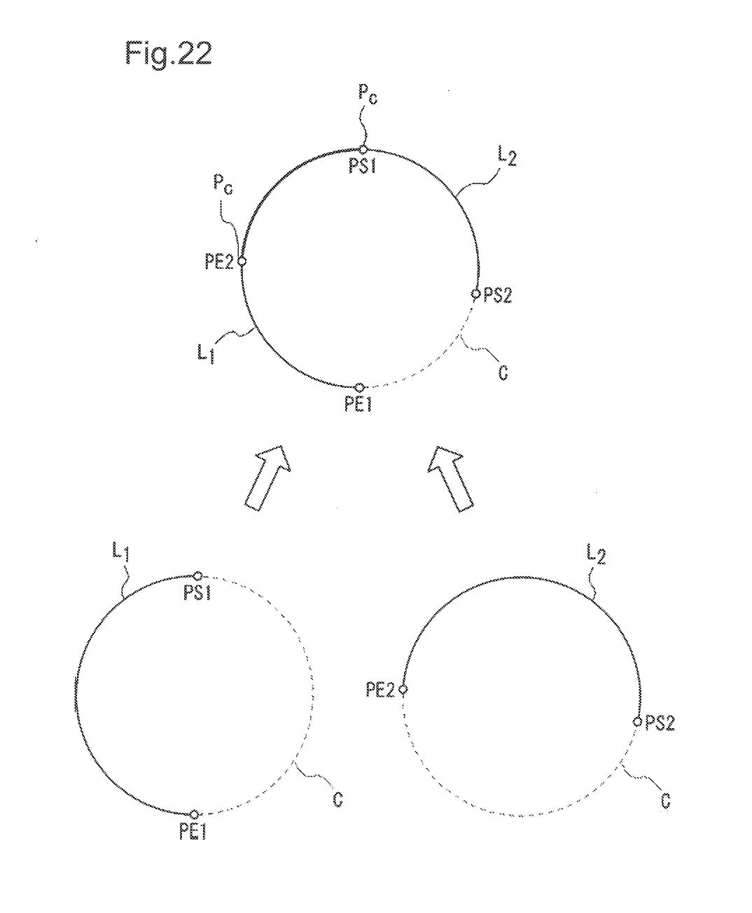

FIG. 22 is a diagram illustrating a case in which reference circles coincide and there is one overlapped portion between two line segments. In this example, four points that are a start point PS1 of a line segment L₁, an end point PE1 of the line segment L1, a start point PS2 of a line segment L₂, and an end point PE2 of the line segment L₂ are intersection points Pc.

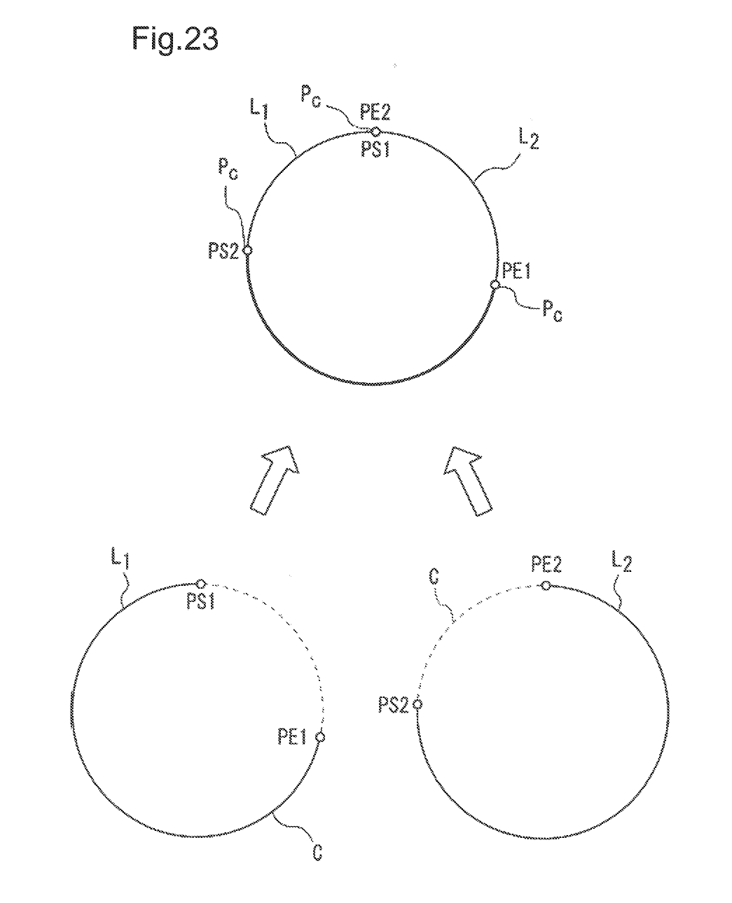

FIG. 23 is a diagram illustrating a case in which reference circles coincide, a start point of one line segment and an end point of the other line segment are overlapped, and there is one overlapped portion between the two line segments. In this case, three points that are a point that is a start point PS1 of a line segment L₁ and also an end point PE2 of a line segment L₂, an end point PE1 of the line segment L₁, and a start point PS2 of the line segment L₂ are intersection points P_{c}.

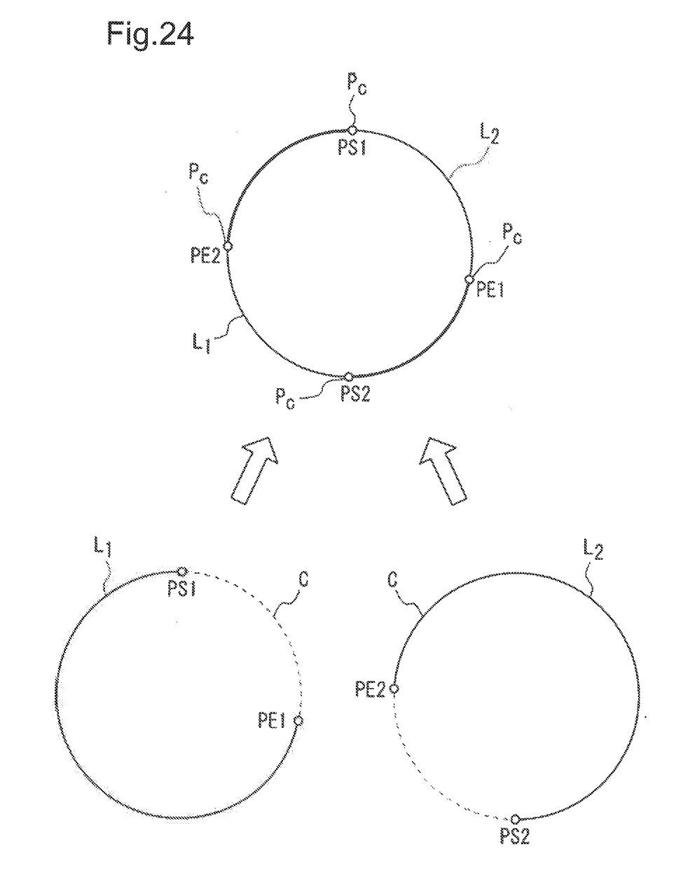

FIG. 24 is a diagram illustrating a case in which reference circles coincide and there are two overlapped portions between two line segments. In this example, four points that are a start point PS1 of a line segment L₁, an end point PE1 of the line segment L₁, a start point PS2 of a line segment L₂, and an end point PE2 of the line segment L₂ are intersection points Pc.

Description has been made on whether two reference circles have an intersection point or two reference circles coincide. Regarding a matter of whether two line segments have an intersection point, it is necessary to consider a section of a line segment on a reference circle. In other words, when an intersection point between the reference circle C₁ and the reference circle C₂ is not present in sections of the line segment L₁ and the line segment L₂, the line segment L₁ and the line segment L₂ do not have an intersection point.

Therefore, an intersection point between the reference circle C₁ and the reference circle C₂ is not always an intersection point between the line segment L₁ and the line segment L₂. Therefore, to discriminate the intersection point between the reference circle C₁ and the reference circle C₂ from the intersection point between the line segment L₁ and the line segment L₂, the intersection point detected as described above between the reference circle C₁ and the reference circle C₂ is referred to as a candidate point.

Hereinafter, a method in which the intersection point detection unit 32 determines whether a line segment L₁ on a reference circle C₁ includes a candidate point Pc represented by Equation (14) will be described. Upon determination, the intersection point detection unit 32 executes case division in accordance with a central angle Ψ of the line segment L₁.

A Case in which the Central Angle Ψ is Equal to or More than π and Equal to or Less than 2π (2≦Ψ≦2π)

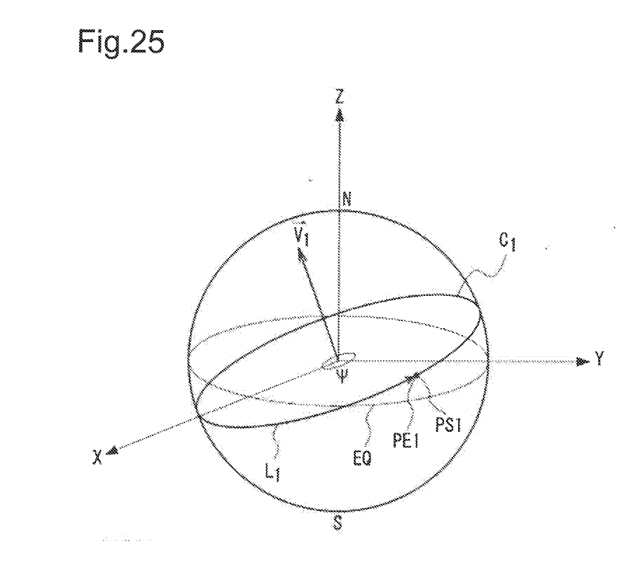

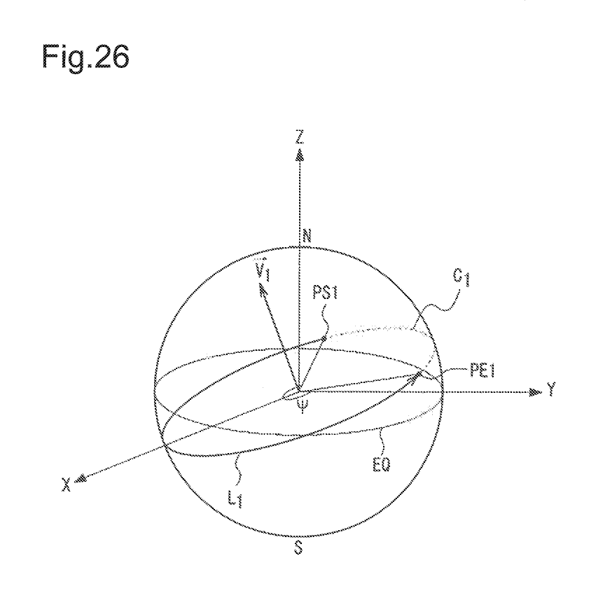

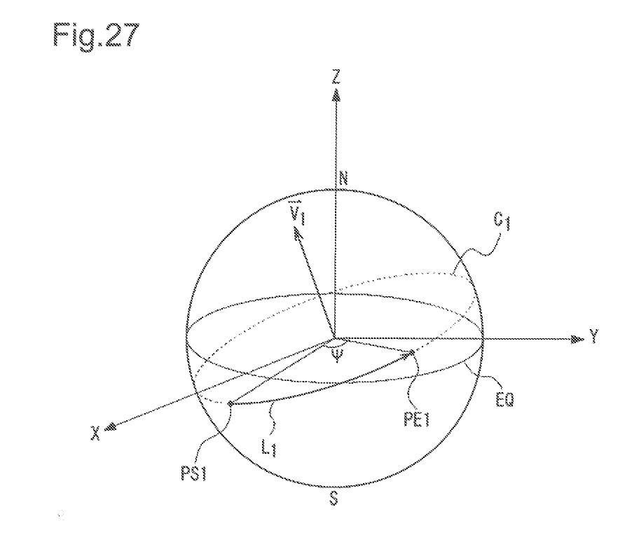

FIG. 25 is a diagram illustrating a line segment L₁ in which a central angle Ψ is 2π (Ψ=2π). When the central angle Ψ is 2π, a candidate point Pc is present on the line segment L₁. Further, FIG. 26 is a diagram illustrating a line segment L₁ in which the central angle Ψ is equal to or more than π and less than 2π (π≦Ψ<2π). In this case, the line segment L₁ is a semi-circular arc or a major arc and following Equation (25) is satisfied. In Equation (25) and Equation (26), PS and PE are a start point and an end point of L₁ and represent the same points as PS1 and PE1, respectively, in FIG. 26 and FIG. 27, for example.

[Math. 25]

(\vec{PS}×\vec{PE})·\vec{V₁}≦0 (25)

The candidate point Pc is present on the line segment L₁ when following Equation (26) or Equation (27) are satisfied.

[Math. 26]

\vec{P_{c}}·(\vec{V₁}×\vec{PS})≧0 (26)

[Math. 27]

\vec{P_{c}}·(\vec{V₁}×\vec{PE})≦0 (27)

A Case in which the Central Angle Ψ is Less than 2π (0<Ψ<2π)

FIG. 27 is a diagram illustrating a line segment L₁ in which the central angle is less than π (0<<27). In this case, the circular arc is a minor arc and following Equation (28) is satisfied.

[Math. 28]

(\vec{PS}×\vec{PE})·\vec{V₁}>0 (28)

When both the above-described Equation (26) and Equation (27) are satisfied, the candidate point Pc is present on the line segment L₁.

While a method for determining whether a line segment L₁ has an intersection point has been described, it can be determined whether a line segment L₂ has an intersection point in the same manner.

From the above, when a line segment L₁ and a line segment L₂ include the same candidate point Pc, this point can be determined as an intersection point Pc. In this case, the intersection point detection unit 32 can determine that the line segment L₁ and the line segment L₂ intersect at two points (this case is referred to as intersecting contact), make contact at one point, or coincide.

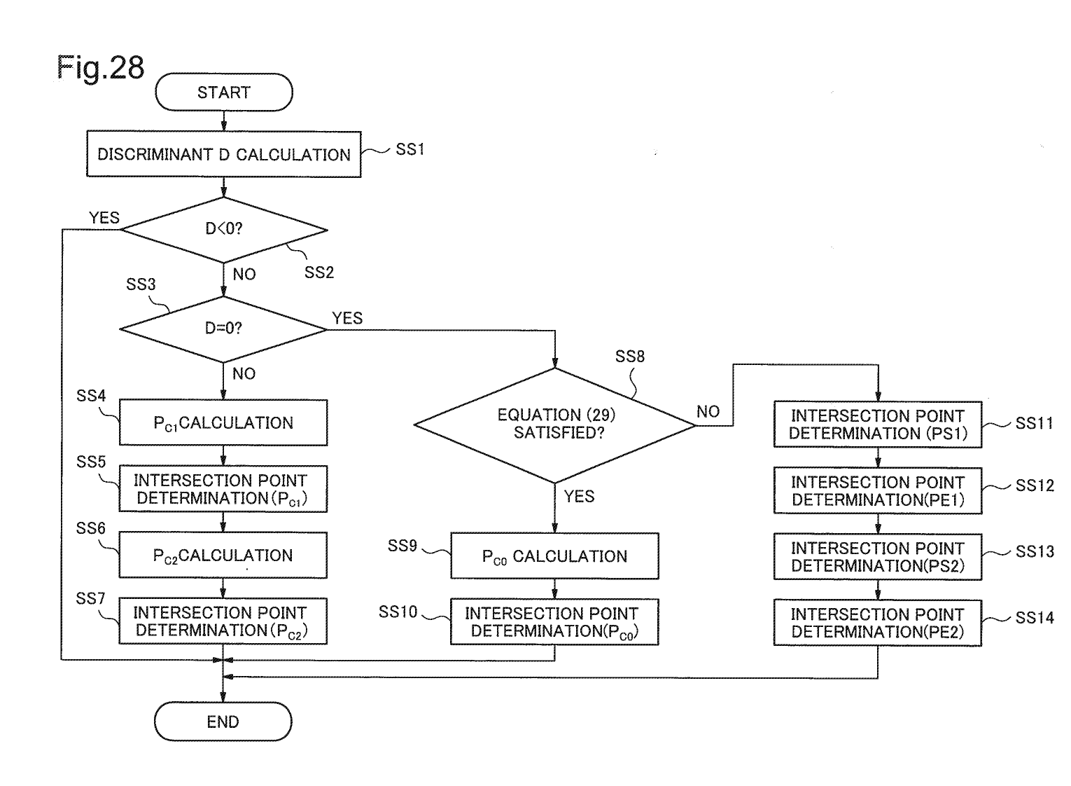

Hereinafter, steps of the above-described intersection detection (step S13 of FIG. 5) will be organized. FIG. 28 is a flowchart illustrating an intersection point detection operation of line segments in the geographical information management device 100.

### Step SS1

The candidate point detection unit 31 calculates a discriminant D.

### Step SS2

The candidate point detection unit 31 determines whether the discriminant D is less than 0. Thereby, the candidate point detection unit 31 can determine whether there is a candidate point. When the discriminant D is less than 0, there is no candidate point. When the discriminant D is equal to or more than 0, there are at least one or more candidate points.

### Step SS3

When the discriminant D is equal to or more than 0, the candidate point detection unit 31 determines whether the discriminant D is 0.

### Step SS4

When the discriminant D is more than 0, the intersection point detection unit 32 calculates a candidate point Pc₁.

### Step SS5

The intersection point detection unit 32 executes intersection point determination processing for the candidate point Pc₁. The intersection point determination processing will be described later.

### Step SS6

The intersection point detection unit 32 calculates a candidate point Pc₂.

### Step SS7

The intersection point detection unit 32 executes intersection point determination processing for the candidate point Pc₂. The intersection point determination processing will be described later.

### Step SS8

When the discriminant D is 0, the candidate point detection unit 31 determines whether Equation (29) is satisfied.

[Math. 29]

(\vec{V₂}≦\vec{V₁})²<1 (29)

### Step SS9

When Equation (29) is satisfied, the intersection point detection unit 32 calculates a candidate point Pc₀.

### Step SS10

The intersection point detection unit 32 executes intersection point determination processing for the candidate point Pc₀. The intersection point determination processing will be described later.

### Step SS11

When Equation (29) is not satisfied, the intersection point detection unit 32 executes intersection point determination processing for a start point PS1 of a line segment L₁.

### Step SS12

The intersection point detection unit 32 executes intersection point determination processing for an end point PE1 of the intersection point line segment L₁.

### Step SS13

The intersection point detection unit 32 executes intersection point determination processing for a start point PS2 of an intersection point line segment L₂.

### Step SS14

The intersection point detection unit 32 executes intersection point determination processing for an end point PE2 of the intersection point line segment L₂.

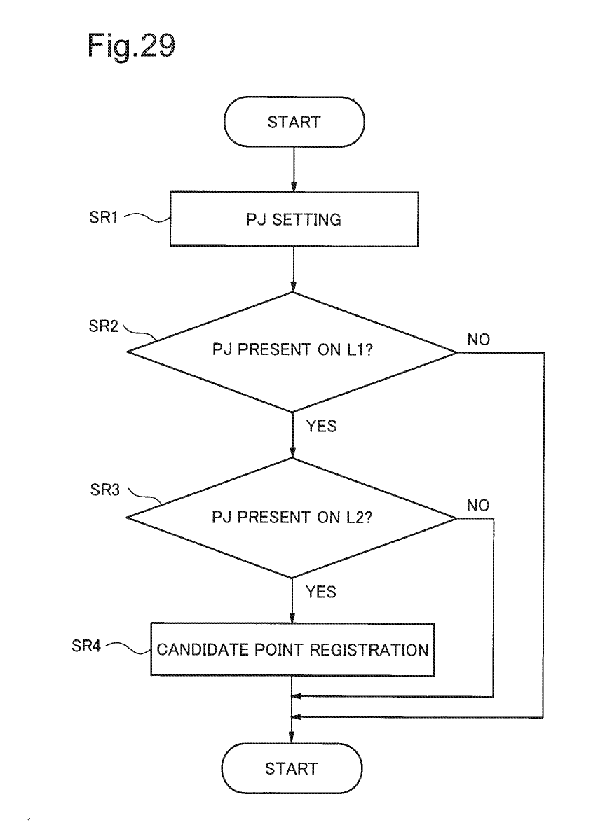

Next, intersection point determination processing will be described. FIG. 29 is a flowchart illustrating intersection point determination processing.

### Step SR1

The intersection point detection unit 32 sets a candidate point calculated in an immediately prior step as a determination object point PJ.

### Step SR2

The intersection point detection unit 32 executes range verification processing for determining whether the determination object point PJ is present on the line segment L₁. Details of the range verification processing will be described later. When the determination object point PJ is not present on the line segment L₁, the processing is terminated.

### Step SR3

When the determination object point PJ is present on the line segment L₁, the intersection point detection unit 32 executes range verification processing for determining whether the determination object point PJ is present on the line segment L₂. Details of the range verification processing will be described later. When the determination object point PJ is not present on the line segment L₂, the processing is terminated.

### Step SR4

When the determination object point PJ is present on the line segments L₁ and L₂, the intersection point detection unit 32 registers the determination object point PJ as a candidate point.

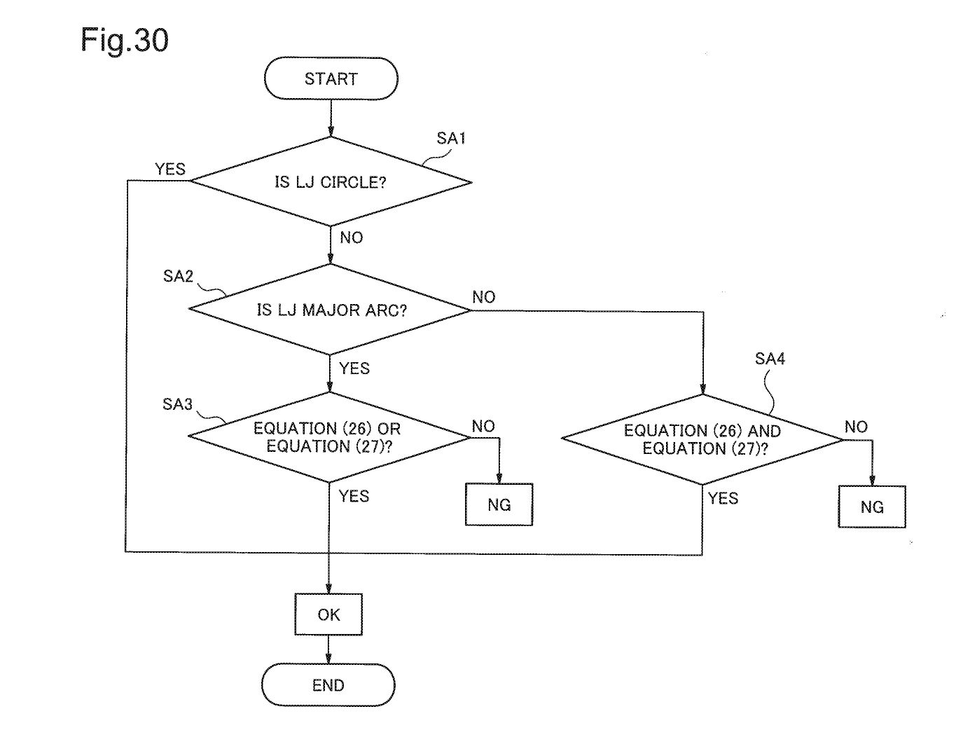

The range verification processing in steps SR2 and SR3 described above will be described. FIG. 30 is a flowchart illustrating range verification processing. Herein, a line segment to be verified is referred to as LJ.

### Step SA1

The intersection point detection unit 32 determines whether a determination object line segment LJ is a circle.

### Step SA2

When the determination object line segment LJ is not a circle, the intersection point detection unit 32 determines whether the line segment is a major arc.

### Step SA3

When the determination object line segment LJ is a major arc, the intersection point detection unit 32 determines whether at least any one of Equation (26) or Equation (27) is satisfied. When at least any one of Equation (26) or Equation (27) is satisfied, the determination object point PJ is present on the determination object line segment LJ (YES determination). When any one of Equation (26) and Equation (27) is not satisfied, the determination object point PJ is not present on the determination object line segment LJ (NO determination).

### Step SA4

When the determination object line segment LJ is a minor arc or a semi-circular arc, the intersection point detection unit 32 determines whether both Equation (26) and Equation (27) are satisfied. When both Equation (26) and Equation (27) are satisfied, the determination object point PJ is present on the determination object line segment LJ (YES determination). When at least one of Equation (26) or Equation (27) is not satisfied, the determination object point PJ is not present on the determination object line segment LJ (NO determination).

From the above, the shape determination device of the geographical information management device 100 of the present exemplary embodiment can reliably determine whether two line segments set on a true sphere have an intersection point. Thereby, it is possible for the geographical information management device 100 to reliably determine whether two air routes expressed by a circular arc on a true sphere intersect or whether line segments configuring an airspace on a true sphere intersect. The reason is that the candidate point detection unit 31 detects an intersection point of a reference circle to which two line segments belong and the intersection point detection unit 32 determines whether the detected intersection point of the reference circle is included in the two line segments.

### Second Exemplary Embodiment

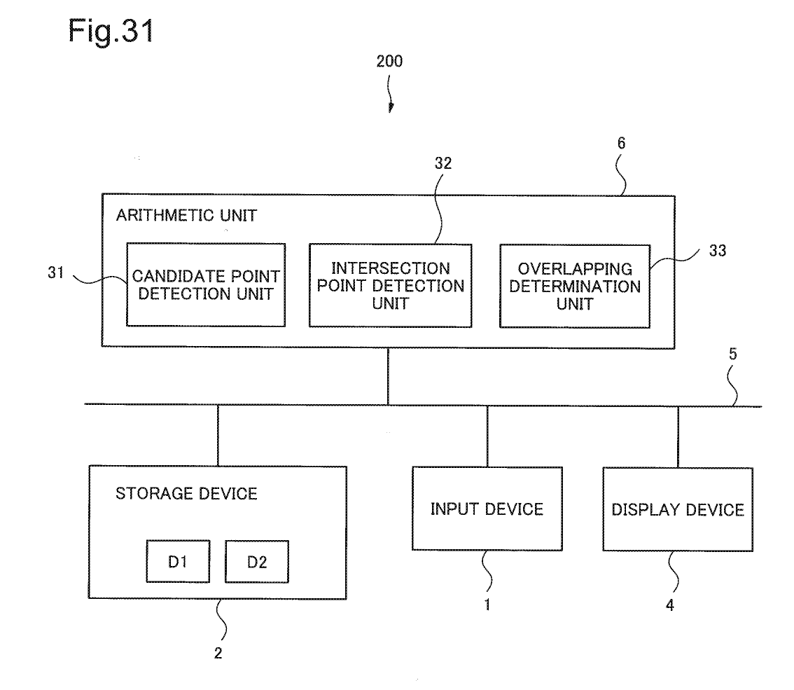

A geographical information management device 200 according to a second exemplary embodiment will be described. FIG. 31 is a block diagram schematically illustrating a configuration of the geographical information management device 200 according to the second exemplary embodiment. The geographical information management device 200 includes a configuration in which the arithmetic unit 3 of the geographical information management device 100 according to the first exemplary embodiment is replaced with an arithmetic unit 6. The arithmetic unit 6 includes a configuration in which an overlapping determination unit 33 is added to the arithmetic unit 3. The other configuration of the geographical information management device 200 is the same as in the geographical information management device 100, and therefore description thereof will be omitted.

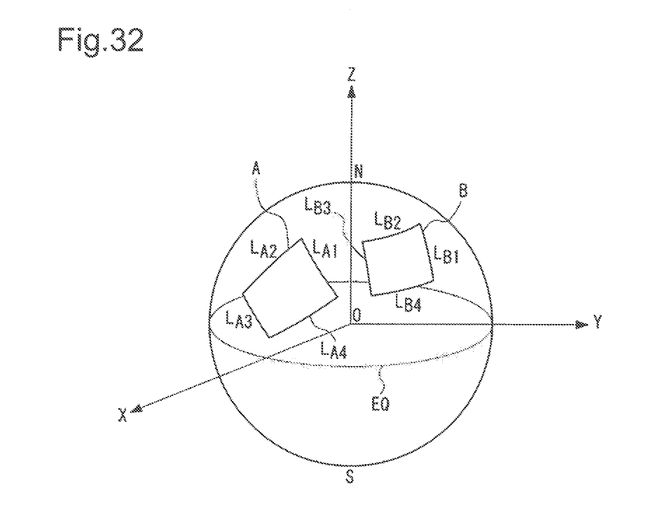

FIG. 32 is a diagram illustrating an example of an airspace set on a true sphere CB. FIG. 32 illustrates an example in which an airspace A is surrounded by line segments LA1 to LA4, and an airspace B is surrounded by line segments LB1 to LB4. FIG. 32 is merely illustrative, and therefore the number of line segments surrounding each of the airspace A and the airspace B can be 1 or a plural number other than 4.

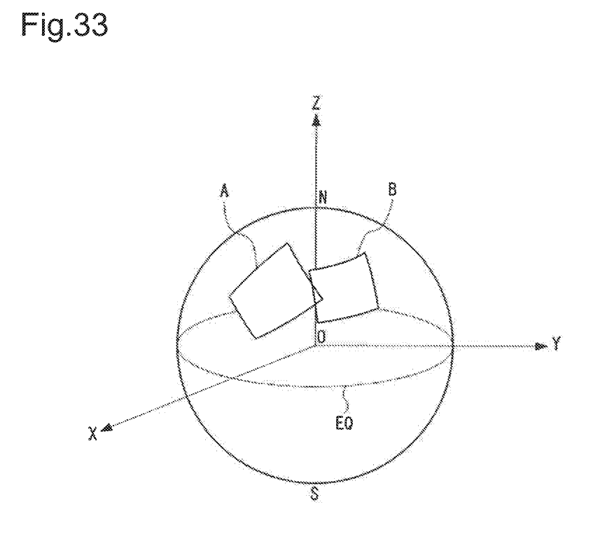

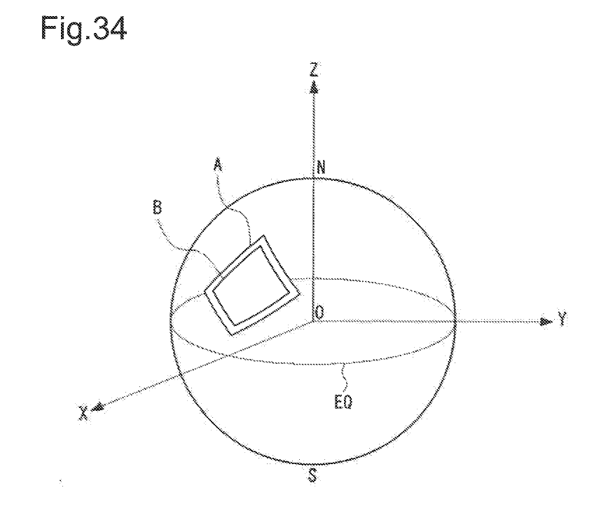

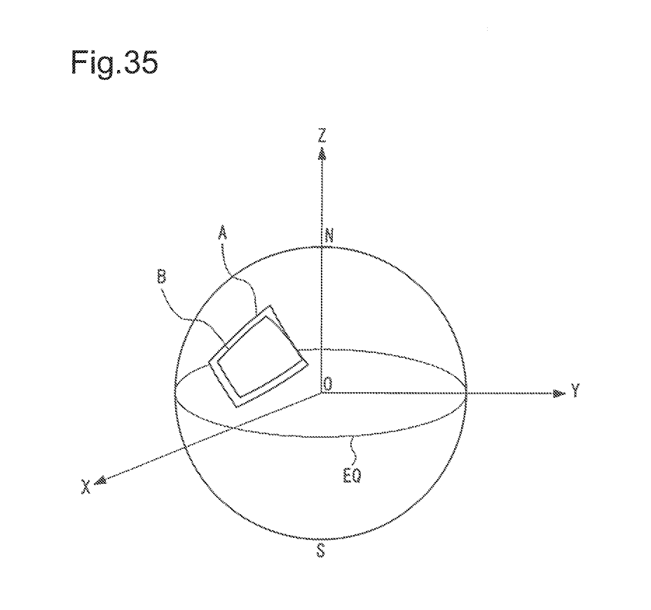

When two airspaces that are an airspace A and an airspace B are present on a true sphere CB, to secure the safety of an aircraft flying in each of the airspaces, it is necessary to cause the airspace A and the airspace B not to intersect. FIG. 33 is a diagram illustrating a case in which the airspace A and the airspace B have two intersection points. FIG. 34 is a diagram illustrating a case in which the airspace A includes the airspace B. FIG. 35 is a diagram illustrating a case in which the airspace B is inscribed in the airspace A. In FIGS. 33 to 35, the airspace A and the airspace B are overlapped. To simplify the drawings, in FIGS. 33 to 35, indication of reference signs assigned to the line segments is omitted.

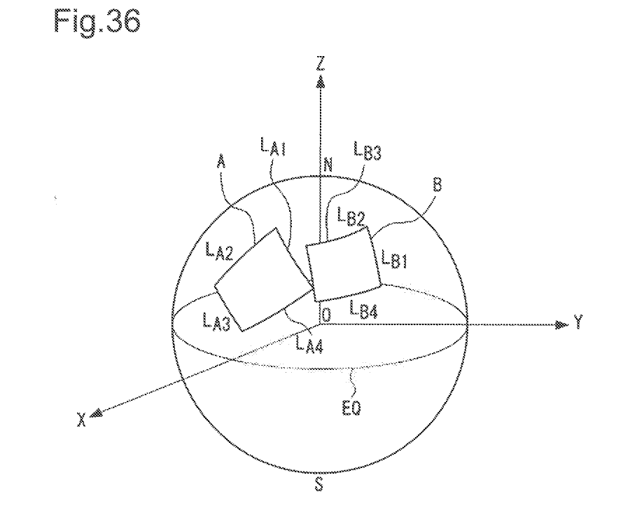

In other words, to secure the safety of an aircraft, the airspace A and the airspace B may be separated or circumscribed. FIG. 32 described above illustrates a case in which the airspace A and the airspace B are separated. FIG. 36 is a diagram illustrating a case in which the airspace A and the airspace B are circumscribed. In the examples of FIG. 32 and FIG. 36, the airspace A and the airspace B are set so as not to be overlapped.

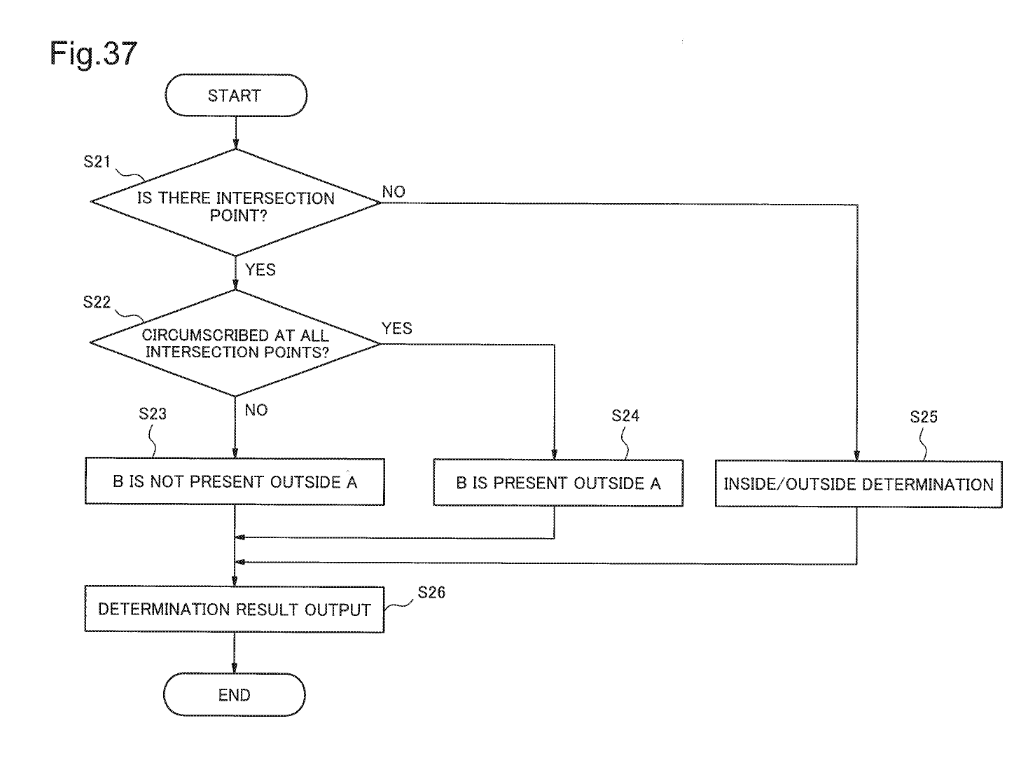

The geographical information management device 200 according to the present exemplary embodiment determines whether the airspace A and the airspace B are separated or circumscribed, or whether the airspaces are overlapped. FIG. 37 is a flowchart illustrating steps of airspace overlapping determination of the geographical information management device 200.

### Step S21

As illustrated in FIG. 32, an airspace is set by being surrounded by one or a plurality of line segments that are circular arcs. In other words, when the airspace A and the airspace B are overlapped, any one of line segments surrounding the airspace A and any one of line segments surrounding the airspace B generally have an intersection point except for a case of inclusion. Therefore, the overlapping determination unit 33 initially determines whether any one of the line segments surrounding the airspace A and any one of the line segments surrounding the airspace B have an intersection point. This determination is made possible by applying the intersection point detection of line segments described in the first exemplary embodiment to the line segments surrounding the airspace A and the line segments surrounding the airspace B.

### Step S22

When any one of the line segments surrounding the airspace A and any one of the line segments surrounding the airspace B have an intersection point, in the intersection point, the airspace A and the airspace B have a circumscribed, inscribed, or intersecting contact relation. Then, the overlapping determination unit 33 initially determines whether the airspace A and the airspace B are circumscribed, inscribed, or in intersecting contact in each intersection point.

As described above, with respect to a region, a left side and a right side of a line segment as viewed from the line segment moving around counterclockwise are defined as a region inside and a region outside, respectively. Therefore, upon determining whether regions are circumscribed, inscribed, or in intersecting contact in each intersection point, the overlapping determination unit 33 determines on which one of the right and left sides, as viewed from a line segment moving around in each intersection point, the other boundary line is present.

Hereinafter, description will be made, assuming that in each intersection point, there are four line segments that are a section Ain (referred to also as an incoming line Ain, hereinafter, the same) and a section Aout (referred to also as an outgoing line Aout, hereinafter, the same) of a line segment surrounding an airspace A and a section Bin and a section Bout of a line segment surrounding an airspace B. A start point of a line segment LA passing through an intersection point Pc is designated as A₁ and an end point is designated as A₂. A portion going from the start point A1 to the intersection point Pc is designated as a section Ain. A portion going from the intersection point Pc to the end point A₂ is designated as a section Aout. A start point of a line segment LB passing through the intersection point Pc is designated as B₁ and an end point is designated as B₂. A portion going from the start point B₁ to the intersection point Pc is designated as a section Bin. A portion going from the intersection point Pc to the end point B₂ is designated as a section Bout.

Under the above assumption, on the basis of a relative relation among the four sections, the overlapping determination unit 33 can determine on which one of the right and left sides the airspace B is present, as viewed from the airspace A. In other words, the overlapping determination unit 33 determines on which one of the right and left sides the airspace B is present, as viewed from the incoming line Ain and the outgoing line Aout of the airspace A. The overlapping determination unit 33 determines on which one of the right and left sides the incoming line Bin of the airspace B is present, initially as viewed from the incoming line Ain of the airspace A.

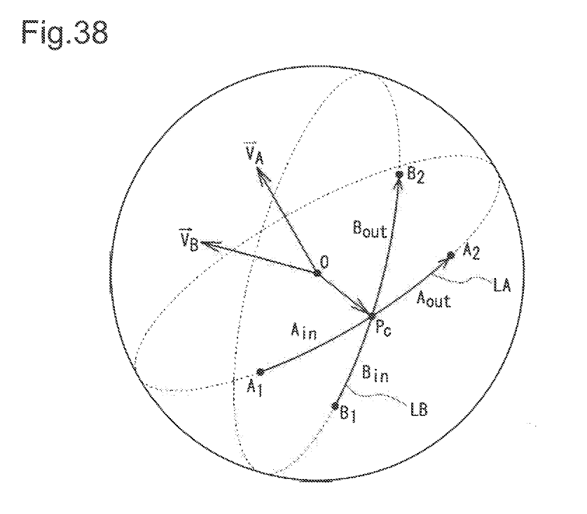

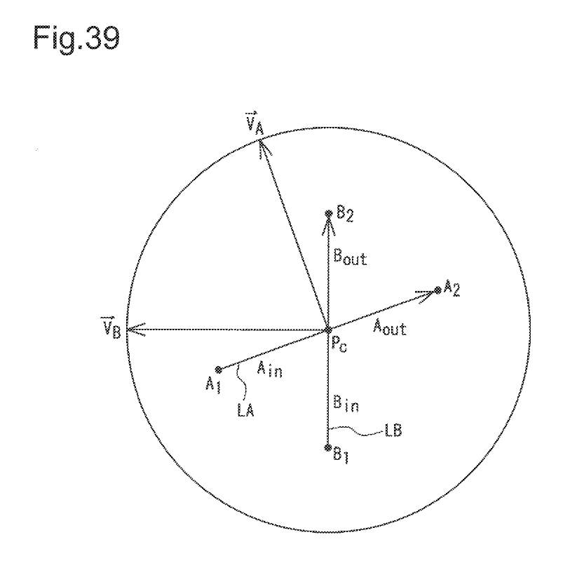

FIG. 38 is a diagram illustrating an example in which four line segments present on a true sphere CB have an intersection point. In FIG. 38, a line segment LA indicates one of line segments dividing an airspace A. A line segment LB indicates one of line segments dividing an airspace B. The line segment LA and the line segment LB intersect at an intersection point Pc. FIG. 39 is a diagram illustrating a case in which the line segment LA and the line segment LB of FIG. 38 are looked down from the sky of the intersection point Pc.

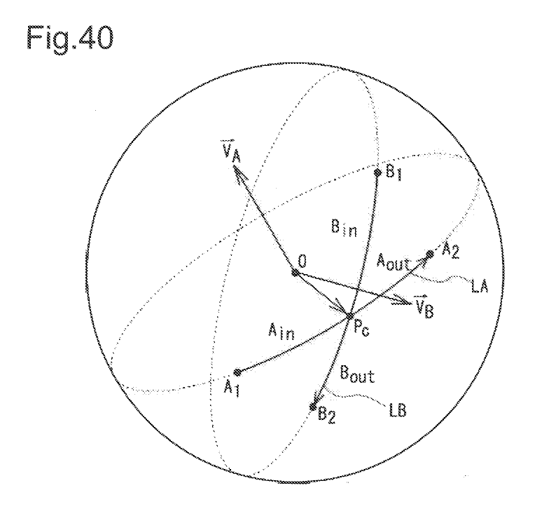

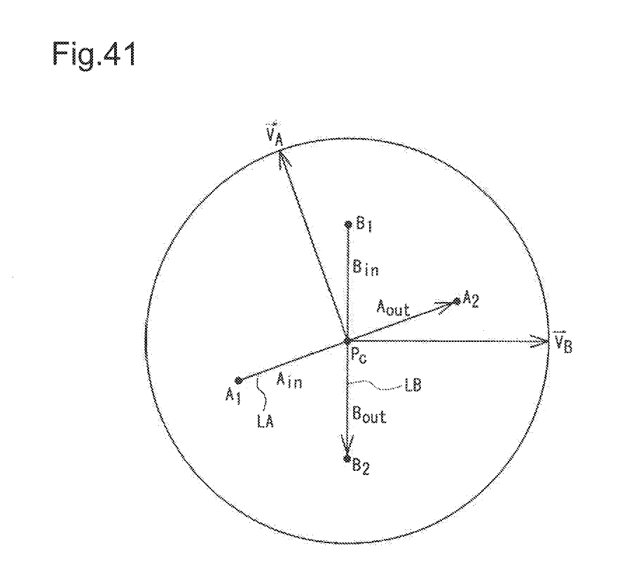

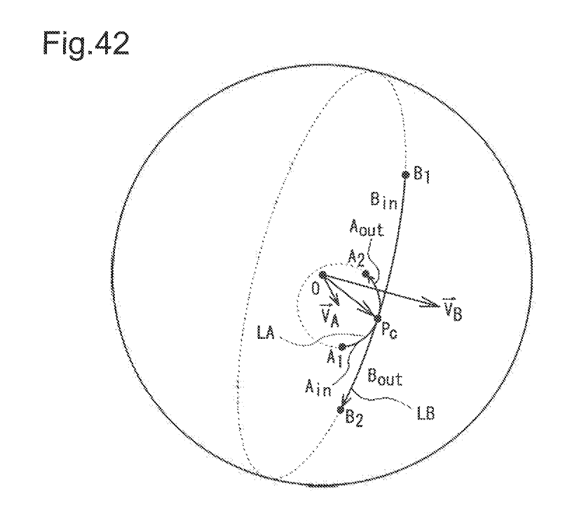

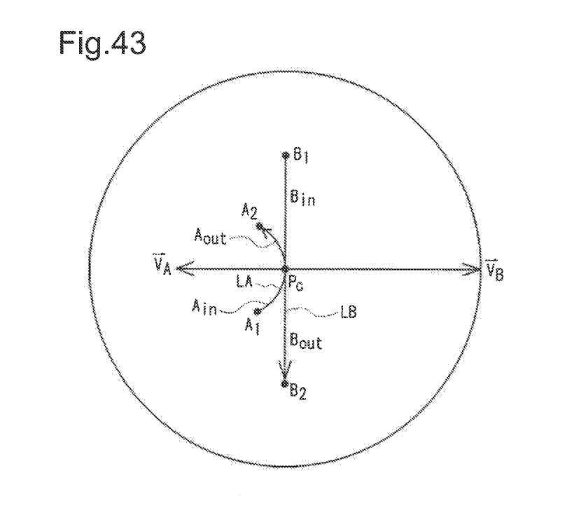

FIG. 40 is a diagram illustrating another example in which four line segments present on a true sphere CB have an intersection point. In FIG. 40, in the same manner as in FIG. 38, a line segment LA indicates one of line segments dividing an airspace A. A line segment LB indicates one of line segments dividing an airspace B. The line segment LA and the line segment LB intersect at an intersection point Pc. However, in the example of FIG. 40, compared with the example of FIG. 38, a direction of the line segment LB is reversed. FIG. 41 is a diagram illustrating a case in which the line segment LA and the line segment LB of FIG. 40 are looked down from the sky of the intersection point Pc. FIG. 42 is a diagram illustrating an example in which a line segment present on a small circle with respect to a true sphere CB and a line segment present on the small circle or a great circle with respect to the true sphere CB intersect. FIG. 43 is a diagram illustrating a case in which the line segment LA and the line segment LB of FIG. 42 are looked down from the sky of an intersection point Pc.

A start point of a line segment LA passing through an intersection point Pc is designated as A₁ and an end point is designated as A₂. A portion going from the start point A₁ to the intersection point Pc is designated as a section Ain. A portion going from the intersection point Pc to the end point A₂ is designated as a section Aout. A start point of a line segment LB passing through the intersection point Pc is designated as B₁ and an end point is designated as B₂. A portion going from the start point B₁ to the intersection point Pc is designated as a section Bin. A portion going from the intersection point Pc to the end point B₂ is designated as a section Bout.

A normal vector of the section Ain, a normal vector of the section Aout, a normal vector of the section Bin, and a normal vector of the section Bout are designated as V_{Ain}, V_{Aout}, V_{Bin}, and V_{Bout}, respectively. A normal vector of a section refers to a normal vector of a reference circle to which the section belongs. FIGS. 38 to 43 each illustrate a case in which the normal vector V_{Ain} and the normal vector V_{Aout}, are the same and indicate these vectors as a normal vector V_{A}. Further, FIGS. 38 to 43 each illustrate a case in which the normal vector V_{Bin} and the normal vector V_{Bout} are the same and indicate these vectors as a normal vector V_{B}.

Determination of a position relation between the section Bin and the airspace A will be described. Initially, a position relation between the section Bin and the section Ain is examined. When following Equation (30) is satisfied, the section Bin is present on a left side of the section Ain. “A right side of a section” or “a left side of a section” to be referred to means the right or the left upon facing a direction of the section.

[Math. 30]

(\vec{P_{c}}·\vec{V_{Ain}}×\vec{V_{Bin}})<0 (30)

When following Equation (31) is satisfied, the section Bin is present on a right side of the section Ain.

[Math. 31]

(\vec{P_{c}}·\vec{V_{Ain}}×\vec{V_{Bin}})>0 (31)

Following Equation (32) may be satisfied.

[Math. 32]

(\vec{P_{c}}·\vec{V_{Ain}}×\vec{V_{Bin}})=0 (32)

When Equation (32) is established and Equation (33) is satisfied, the section Bin is parallel to the section Ain, and the section Bin is present on a left side of the section Ain.

[Math. 33]

(\vec{V_{Ain}}×\vec{P_{c}}·\vec{V_{Bin}}×\vec{P_{c}})>0 (33)

When Equation (32) is established and Equation (34) is satisfied, the section Bin is antiparallel to the section Ain, and the section Bin is present on a right side of the section Ain.

[Math. 34]

(\vec{V_{Ain}}×\vec{P_{c}}·\vec{V_{Bin}}×\vec{P_{c}})<0 (34)

A position relation between the section Bin and the section Aout is examined. When following Equation (35) is satisfied, the section Bin is present on a left side of the section Aout.

[Math. 35]

(\vec{P_{c}}·\vec{V_{Aout}}×\vec{V_{Bin}})<0 (35)

When following Equation (36) is satisfied, the section Bin is present on a right side of the section Aout.

[Math. 36]

(\vec{P_{c}}·\vec{V_{Aout}}×\vec{V_{Bin}})>0 (36)

Following Equation (37) may be satisfied.

[Math. 37]

(\vec{P_{c}}·\vec{V_{Aout}}×\vec{V_{Bin}})=0 (37)

When Equation (37) is established and Equation (38) is satisfied, the section Bin is parallel to the section Aout, and the section Bin is present on a right side of the section Aout.

[Math. 38]

(\vec{V_{Aout}}×\vec{P_{c}}·\vec{V_{Bin}}×\vec{P_{c}})>0 (38)

When Equation (37) is established and Equation (39) is satisfied, the section Bin is antiparallel to the section Aout.

[Math. 39]

(\vec{V_{Aout}}×\vec{P_{c}}·\vec{V_{Bin}}×\vec{P_{c}})<0 (39)

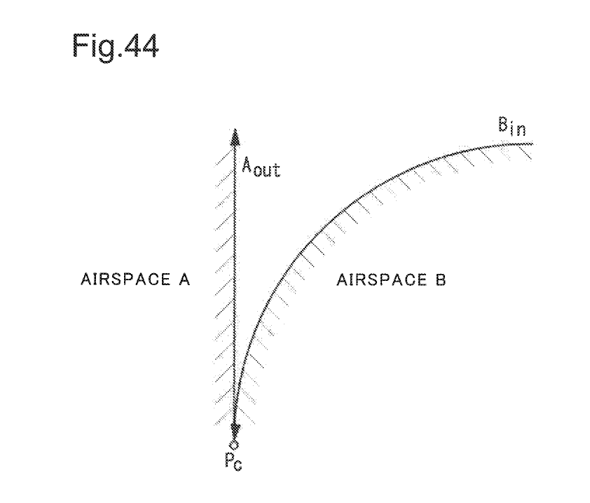

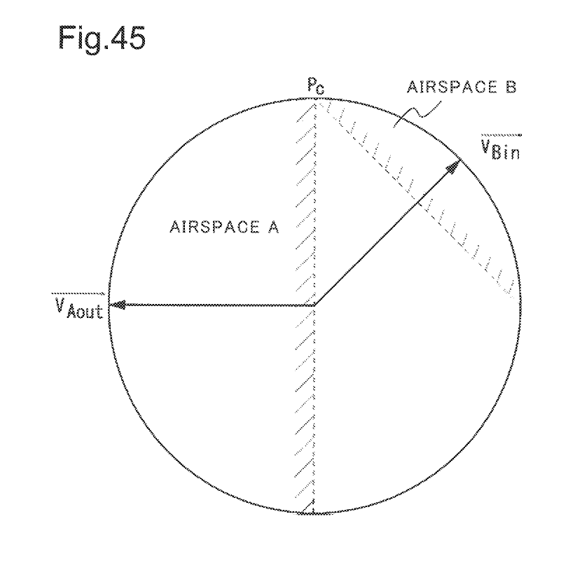

When Equation (37) is established and Equation (39) is satisfied, it is necessary to execute case division in accordance with a curvature of a boundary line. In this case, when following Equation (40) is satisfied, the section Bin and the section Aout make contact at a point Pc, and the section Bin is present on a right side, as viewed from the section Aout. FIG. 44 is a diagram illustrating a position relation of a reference circle to which the section Aout belongs and a reference circle to which the section Bin belongs as viewed from directly above the intersection point Pc when Equation (40) is satisfied. FIG. 45 is a diagram illustrating a position relation of a reference circle to which the section Aout belongs and a reference circle to which the section Bin belongs in which the intersection point Pc is a zenith when Equation (40) is satisfied.

[Math. 40]

(\vec{P_{c}}·\vec{V_{Aout}})+(\vec{P_{c}}·\vec{V_{Bin}})>0 (40)

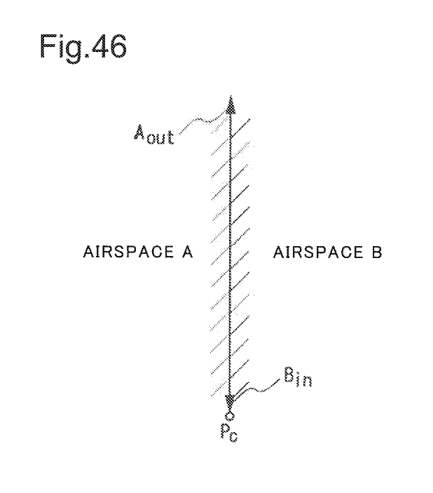

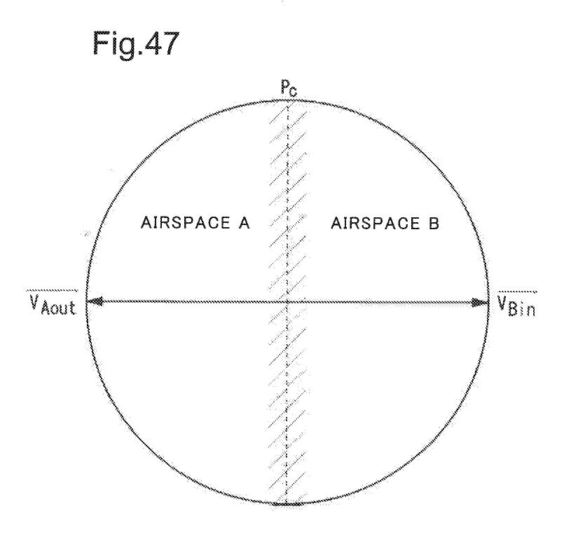

Further, in this case, when following Equation (41) is satisfied, the section Bin and the section Aout have a tangent relation, and the section Bin is present on a right side, as viewed from the section Aout. FIG. 46 is a diagram illustrating a position relation of a reference circle to which the section Aout belongs and a reference circle to which the section Bin belongs as viewed from directly above the intersection point Pc when Equation (41) is satisfied. FIG. 47 is a diagram illustrating a position relation of a reference circle to which the section Aout belongs and a reference circle to which the section Bin belongs in which the intersection point Pc is a zenith when Equation (41) is satisfied.

[Math. 41]

(\vec{P_{c}}·\vec{V_{Aout}})+(\vec{P_{c}}·\vec{V_{B}_{ᵢₙ}})=0 (41)

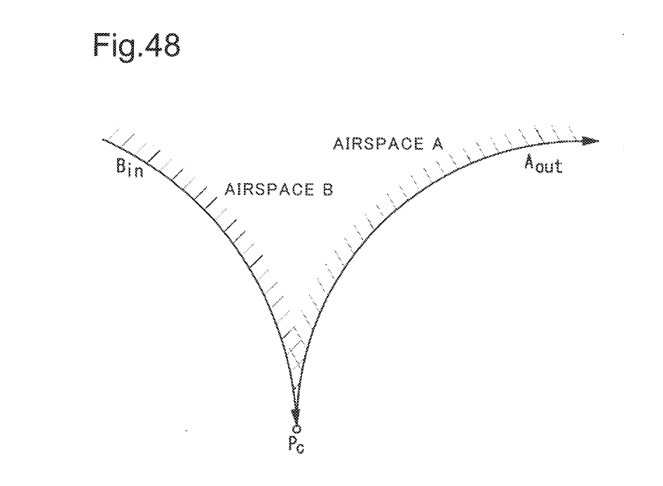

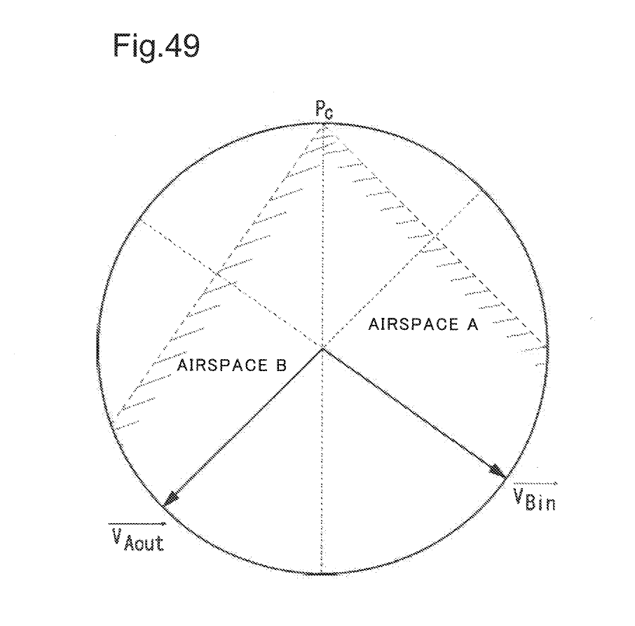

Further, in this case, when following Equation (42) is satisfied, the section Bin and the section Aout make contact at the point Pc, and the section Bin is present on a left side, as viewed from the section Aout. FIG. 48 is a diagram illustrating a position relation of a reference circle to which the section Aout belongs and a reference circle to which the section Bin belongs as viewed from directly above the intersection point Pc when Equation (42) is satisfied. FIG. 49 is a diagram illustrating a position relation of a reference circle to which the section Aout belongs and a reference circle to which the section Bin belongs in which the intersection point Pc is a zenith when Equation (42) is satisfied.

[Math. 42]

(\vec{P_{c}}·\vec{V_{Aout}})+(\vec{P_{c}}·\vec{V_{B}_{ᵢₙ}})<0 (42)

When Equation (43) is established, the region A bends to the left at the intersection point Pc or goes straight. In this case, when the section Bin is present on a right side as viewed from the section Ain or the section Aout, the section Bin is present on a right side with respect to the airspace A. In cases other than this case, the section Bin is present on a left side with respect to the airspace A.

[Math. 43]

(\vec{V_{Aout}}×\vec{V_{Aout}}·\vec{P_{c}})≧0 (43)

When Equation (44) is established, the region A bends to the right at the intersection point Pc. In this case, when the section Bin is present on a right side as viewed from the section Ain and the section Aout, the section Bin is present on a right side with respect to the airspace A. In cases other than this case, the section Bin is present on a left side with respect to the airspace A.

[Math. 44]

(\vec{V_{Aout}}×\vec{V_{Aout}}·\vec{P_{c}})<0 (44)

Next, determination of a position relation between the section Bout and the airspace A will be described. Initially, a position relation between the section Bout and the section Aout is described.

A position relation between the section Bout and the section Aout is examined. When following Equation (45) is satisfied, the section Bout is present on a left side of the section Aout.

[Math. 45]

(\vec{P_{c}}·\vec{V_{Aout}}×\vec{V_{B}_{ₒᵤₜ}})>0 (45)

When following Equation (46) is satisfied, the section Bout is present on a right side of the section Aout.

[Math. 46]

(\vec{P_{c}}·\vec{V_{Aout}}×\vec{V_{B}_{ₒᵤₜ}})<0 (46)

Following Equation (47) may be satisfied.

[Math. 47]

(\vec{P_{c}}·\vec{V_{Aout}}×\vec{V_{B}_{ₒᵤₜ}})=0 (47)

When Equation (47) is established and Equation (48) is satisfied, the section Bout is parallel to the section Aout, and the section Bout is present on a left side of the section Aout.

[Math. 48]

(\vec{V_{Aout}}×\vec{P_{c}}·\vec{V_{B}_{ₒᵤₜ}}×\vec{P_{C}})>0 (48)

When Equation (47) is established and Equation (49) is satisfied, the section Bout is antiparallel to the section Aout, and the section Bout is present on a right side of the section Aout.

[Math. 49]

(\vec{V_{Aout}}×\vec{P_{c}}·\vec{V_{B}_{ₒᵤₜ}}×\vec{P_{C}})<0 (49)

A position relation between the section Bout and the section Ain is examined. When following Equation (50) is satisfied, the section Bout is present on a left side of the section Ain.

[Math. 50]

(\vec{P_{c}}·\vec{V_{Ain}}×\vec{V_{B}_{ₒᵤₜ}})>0 (50)

When following Equation (51) is satisfied, the section Bout is present on a right side of the section Ain.

[Math. 51]

(\vec{P_{c}}·\vec{V_{Ain}}×\vec{V_{B}_{ₒᵤₜ}})<0 (51)

Following Equation (52) may be satisfied.

[Math. 52]

(\vec{P_{c}}·\vec{V_{Ain}}×\vec{V_{B}_{ₒᵤₜ}})=0 (52)

When Equation (52) is established and Equation (53) is satisfied, the section Bout is parallel to the section Ain, and the section Bout is present on a right side of the section Ain.

[Math. 53]

(\vec{V_{Ain}}×\vec{P_{c}}·\vec{V_{B}_{ₒᵤₜ}}×\vec{P_{c}})>0 (53)

When Equation (52) is established and Equation (54) is satisfied, the section Bout is antiparallel to the section Ain.

[Math. 54]

(\vec{V_{Ain}}×\vec{P_{c}}·\vec{V_{B}_{ₒᵤₜ}}×\vec{P_{c}})<0 (54)

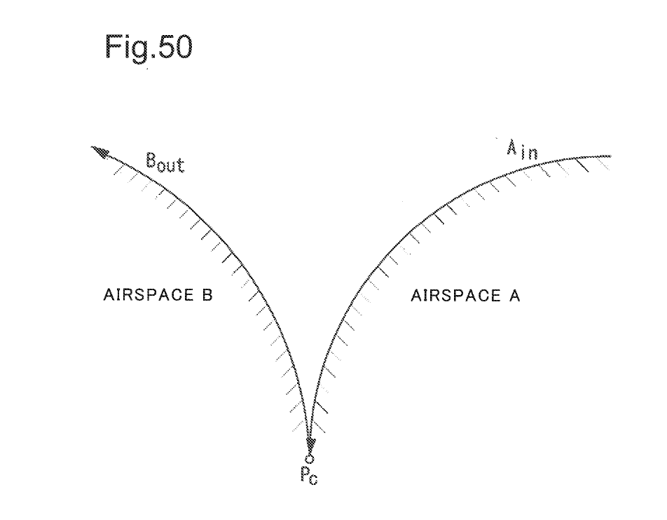

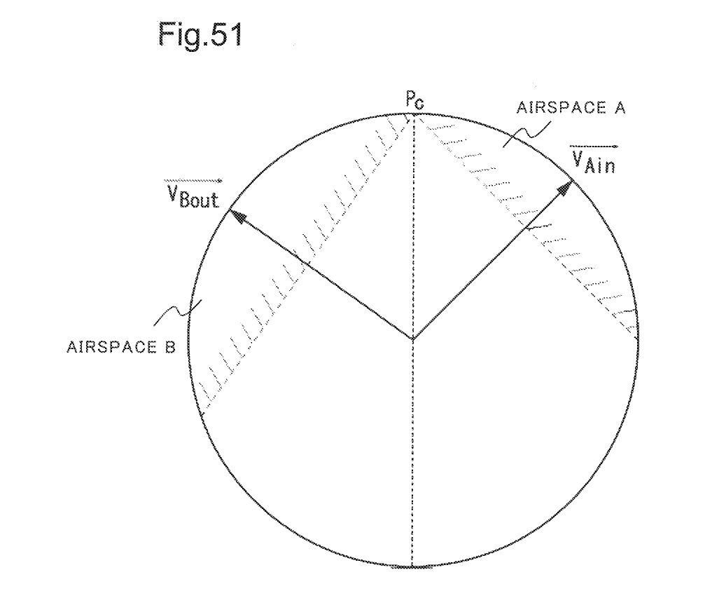

When Equation (52) is established and Equation (54) is satisfied, it is necessary to execute case division in accordance with a curvature of a boundary line. In this case, when following Equation (55) is satisfied, the section Bout and the section Ain make contact at the point Pc, and the section Bout is present on a right side as viewed from the section Ain. FIG. 50 is a diagram illustrating a position relation of a reference circle to which the section Ain belongs and a reference circle to which the section Bout belongs as viewed from directly above the intersection point Pc when Equation (55) is satisfied. FIG. 51 is a diagram illustrating a position relation of a reference circle to which the section Ain belongs and a reference circle to which the section Bout belongs in which the intersection point Pc is a zenith when Equation (55) is satisfied.

[Math. 55]

(\vec{P_{c}}·\vec{V_{Ain}})+(\vec{P_{c}}·\vec{V_{B}_{ₒᵤₜ}})>0 (55)

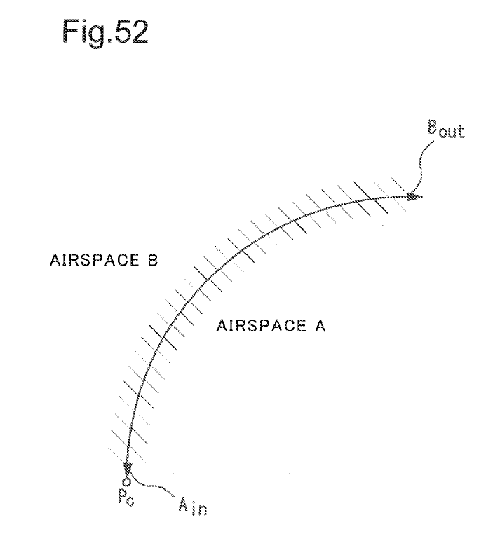

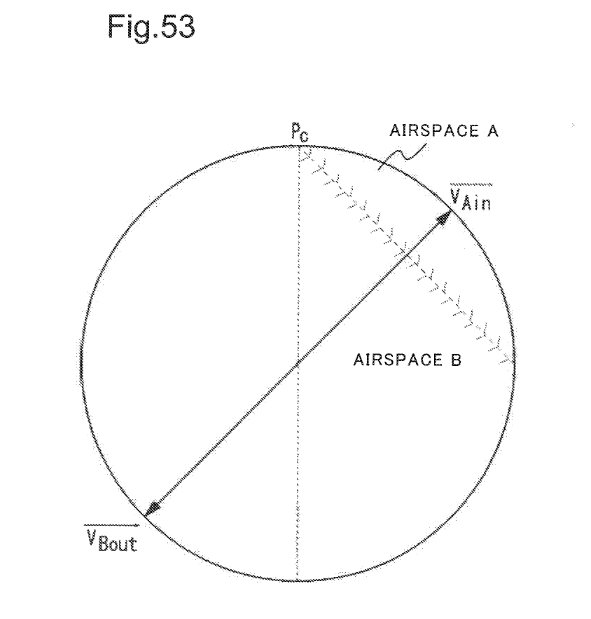

Further, in this case, when following Equation (56) is satisfied, the section Bout and the section Ain have a tangent relation, and the section Bout is present on a right side as viewed from the section Ain. FIG. 52 is a diagram illustrating a position relation of a reference circle to which the section Ain belongs and a reference circle to which the section Bout belongs as viewed from directly above the intersection point Pc when Equation (56) is satisfied. FIG. 53 is a diagram illustrating a position relation of a reference circle to which the section Ain belongs and a reference circle to which the section Bout belongs in which the intersection point Pc is a zenith when Equation (56) is satisfied.

[Math. 56]

(\vec{P_{c}}·\vec{V_{Ain}})+(\vec{P_{c}}·\vec{V_{B}_{ₒᵤₜ}})=0 (56)

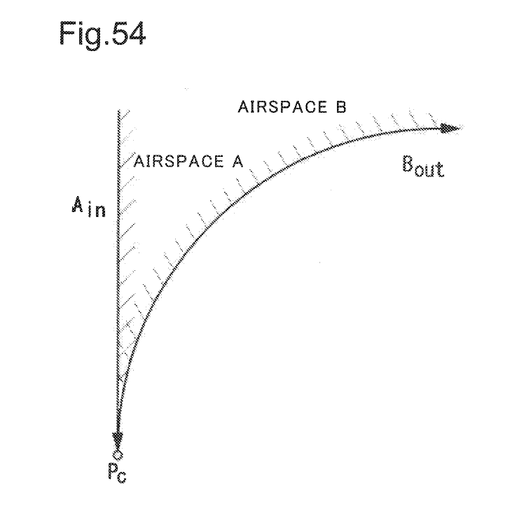

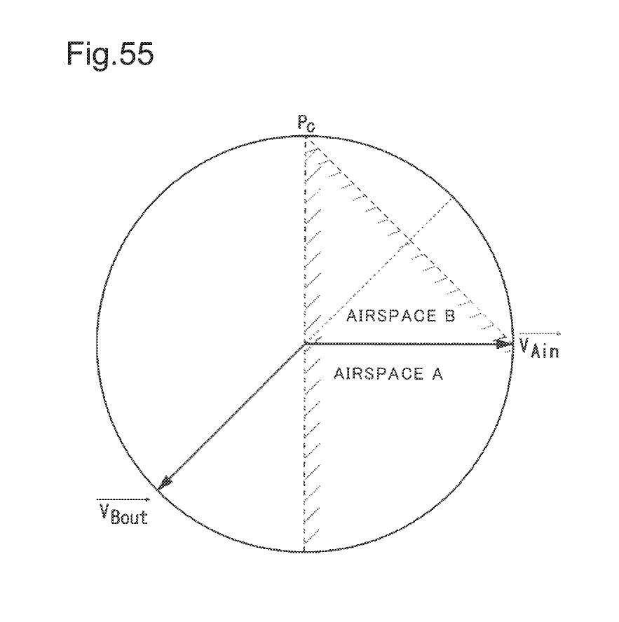

Further, in this case, when following Equation (57) is satisfied, the section Bout and the section Ain make contact at the point Pc, and the section Bout is present on a left side as viewed from the section Ain. FIG. 54 is a diagram illustrating a position relation of a reference circle to which the section Ain belongs and a reference circle to which the section Bout belongs as viewed from directly above the intersection point Pc when Equation (57) is satisfied. FIG. 55 is a diagram illustrating a position relation of a reference circle to which the section Ain belongs and a reference circle to which the section Bout belongs in which the intersection point Pc is a zenith when Equation (57) is satisfied.

[Math. 57]

(\vec{P_{c}}·\vec{V_{Ain}})+(\vec{P_{c}}·\vec{V_{B}_{ₒᵤₜ}})<0 (57)

When Equation (43) described above is established, the region A bends to the left at the intersection point Pc or goes straight. In this case, when the section Bout is present on a right side as viewed from the section Ain or the section Aout, the section Bout is present on a right side with respect to the airspace A. In cases other than this case, the section Bout is present on a left side with respect to the airspace A.

When Equation (44) described above is established, the region A bends to the right at the intersection point Pc. In this case, when the section Bout is present on a right side as viewed from the section Ain and the section Aout, the section Bout is present on a right side with respect to the airspace A. In cases other than this case, the section Bout is present on a left side with respect to the airspace A.

Therefore, when the section Bin and the section Bout are present on a right side of the airspace A at the intersection point Pc, the overlapping determination unit 33 can determine that at the intersection point Pc, the airspace B is present on a right side with respect to the airspace A, i.e. is circumscribed. When the airspace B is circumscribed to the airspace A at all of the intersection points between the airspace A and the airspace B (YES in step S22), the overlapping determination unit 33 can determine that the airspace B is present outside the airspace A (step S24). In cases other than this case (NO in step S22), the airspace B is inscribed in or is in intersecting contact with the airspace A, i.e. the overlapping determination unit 33 can determine that the airspace A and the airspace B are overlapped (step S23). A relative relation of the airspace A with respect to the airspace B is also the same, and therefore, description of details will be omitted.

Summarizing the above, when the airspace A is present outside the airspace B and also the airspace B is present outside the airspace A, the airspace A and the airspace B are circumscribed. When the airspace A is present outside the airspace B and also the airspace A is present inside the airspace B, the airspace B is inscribed in the airspace A. When the airspace A is present inside the airspace B and also the airspace B is present outside the airspace A, the airspace A is inscribed in the airspace B. In cases other than these cases, the airspace A and the airspace B are in intersecting contact.

### Step S24

When the airspace B is circumscribed to the airspace A at all of the intersection points, the overlapping determination unit 33 determines that the airspace B is present outside the airspace A.

### Step S23

When the airspace B and the airspace A are in intersecting contact or inscribed at all or a part of the intersection points, the overlapping determination unit 33 determines that the airspace B is not outside the airspace A (both are at least partially overlapped).

### Step S25

A case in which in step S21, it has been determined that any one of line segments surrounding the airspace A and any one of line segments surrounding the airspace B have no intersection point will be described. In this case, the overlapping determination unit 33 determines whether the airspace A and the airspace B are separate. At that time, all arbitrary spots P on a boundary line configuring the airspace B are present inside or outside the airspace A (since there is no intersection point between the airspace A and the airspace B, the airspace B is not present on a boundary line of the airspace A). In other words, the overlapping determination unit 33 can clarify an inside/outside relation of the airspace B with respect to the airspace A by selecting one arbitrary point on the boundary line configuring the airspace B and determining whether the point is present inside or outside the airspace A.

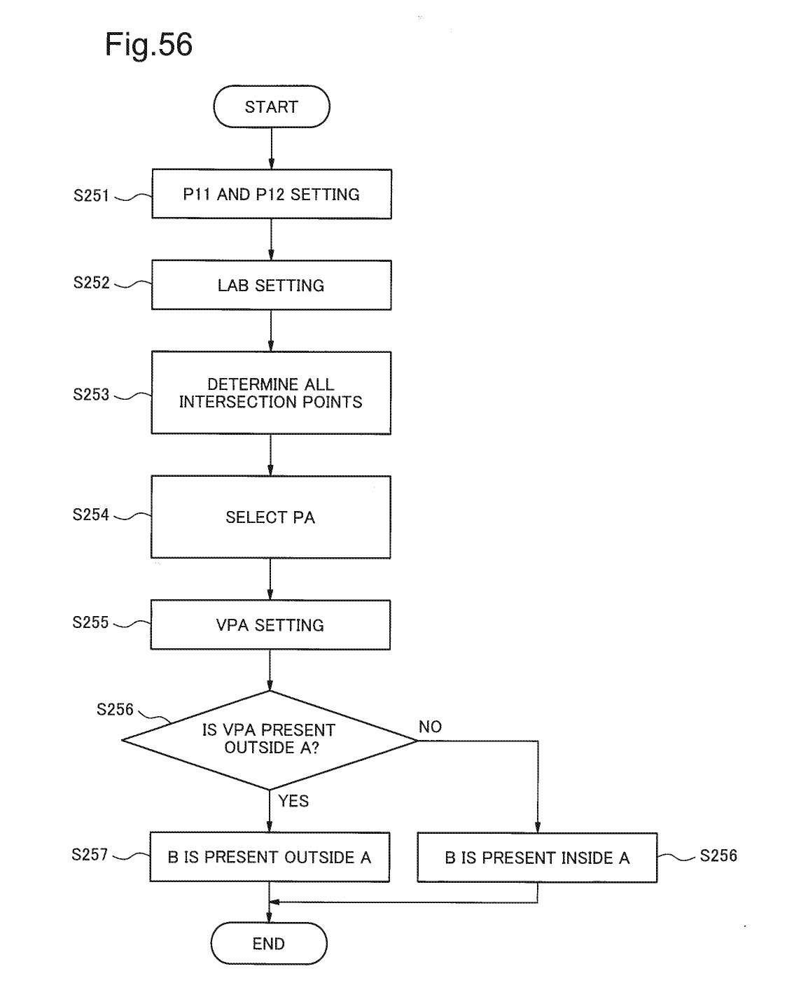

FIG. 56 is a flowchart illustrating steps of step S25.

### Step S251

The overlapping determination unit 33 sets a point P12 on an arbitrary line segment of line segments configuring the airspace B. Further, the unit sets a point P11 on an arbitrary line segment of line segments configuring the airspace A.

### Step S252

The overlapping determination unit 33 determines a straight line LAB passing through the point P11 and the point P12.

### Step S253

The overlapping determination unit 33 determines all intersection points between the straight line LAB and the airspace A. At that time, at least the point P11 is detected as an intersection point.

### Step S254

The overlapping determination unit 33 selects an intersection point PA between the straight line LAB and the airspace A closest to the point P12 from the intersection points between the airspace A and the straight line LAB. Specifically, the unit selects an intersection point in which an inner product with respect to a position vector of the point P11 is largest.

### Step S255

The overlapping determination unit 33 determines an outgoing line vector VPA going out of the intersection point PA and passing through the point P12.

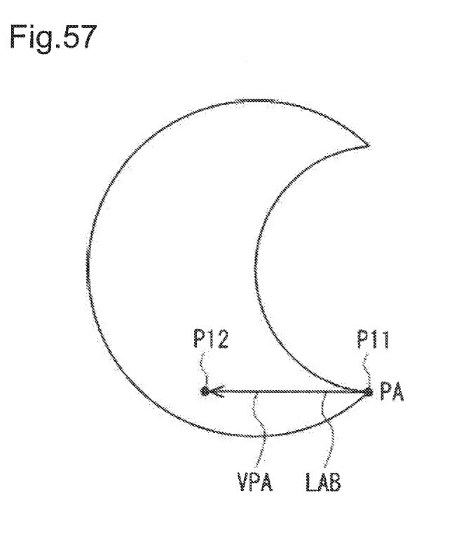

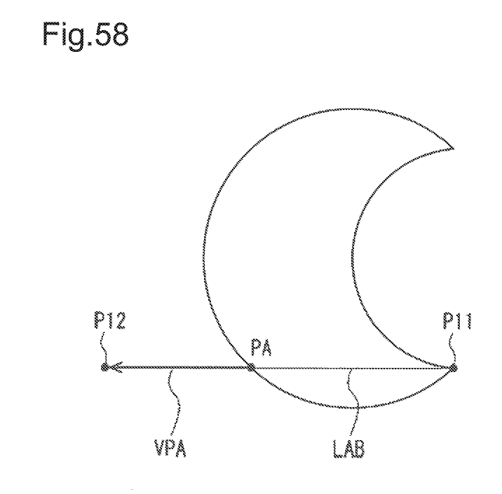

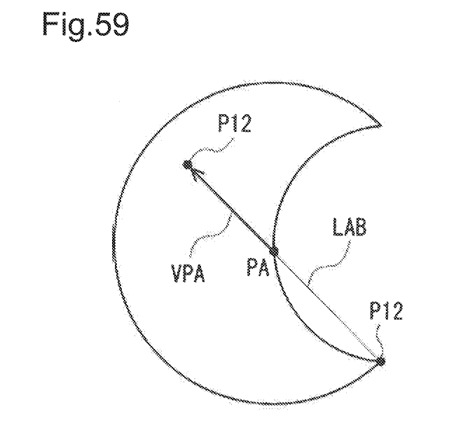

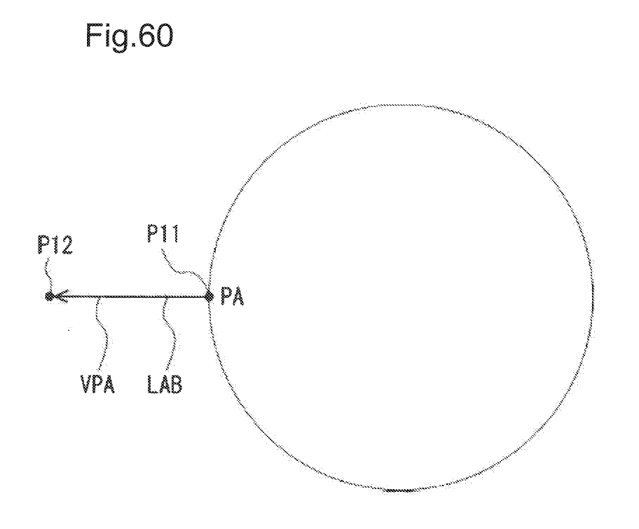

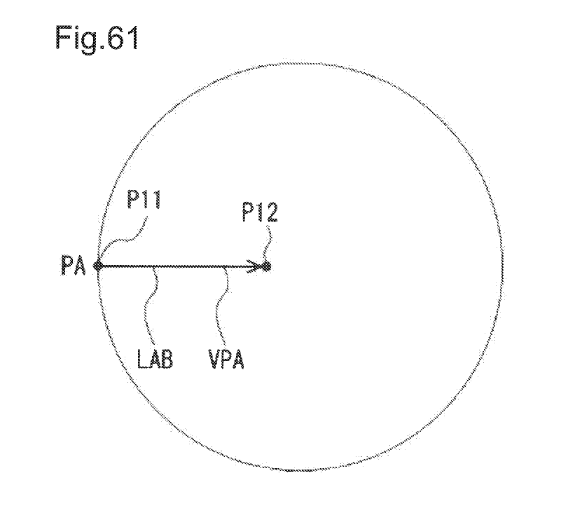

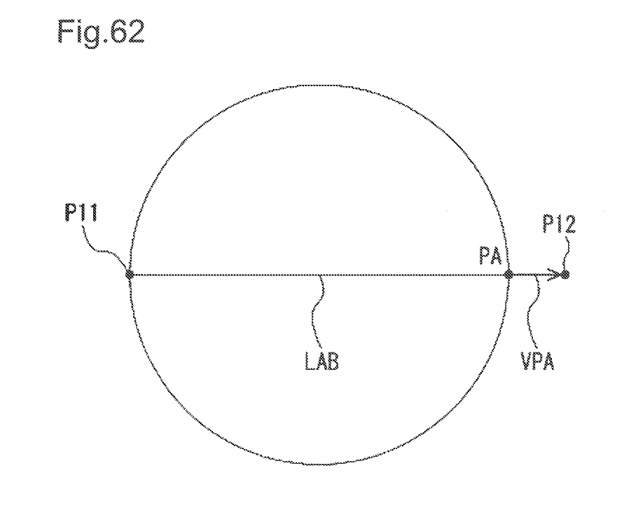

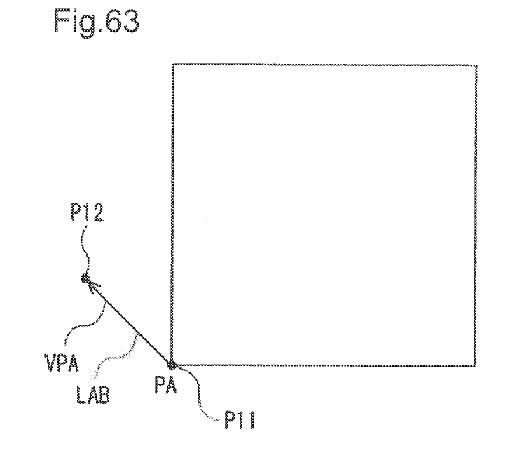

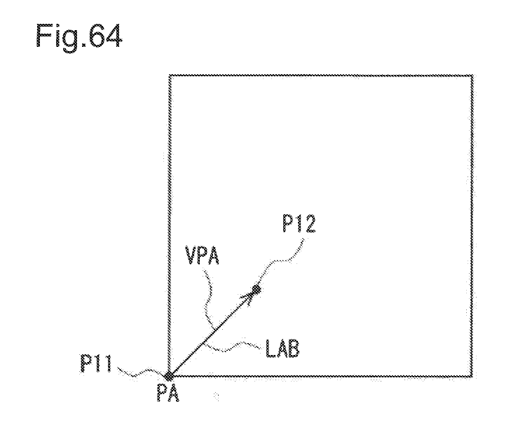

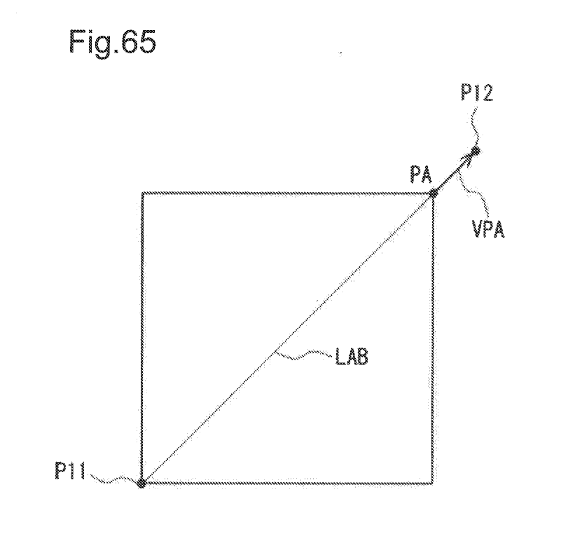

FIG. 57 to FIG. 65 each are a diagram illustrating an example of points set in inside/outside determination executed in the second exemplary embodiment.

### Step S256

Then, the overlapping determination unit 33 determines a position relation between the outgoing line vector VPA in the intersection point PA and the airspace A. The relation can be determined in the same manner by replacing the section Bout with the outgoing line vector VPA in above Equation (45) to Equation (57).

### Step S257

When it is determined that the outgoing line vector VPA is present outside the airspace A, the overlapping determination unit 33 determines that the airspace B is present outside the airspace A.

### Step S258

When it is determined that the outgoing line vector VPA is present inside the airspace A in step S256, the overlapping determination unit 33 determines that the airspace B is present inside the airspace A.

Inside/outside determination of the airspace A with respect to the airspace B is executed in the same manner.

Points of position determination will be described. When the airspace A is present outside the airspace B and the airspace B is present outside the airspace A, the airspace A and the airspace B are separate.

When the airspace A is present inside the airspace B and the airspace B is present outside the airspace A, the airspace A is included in the airspace B.

When the airspace B is present inside the airspace A and the airspace A is present outside the airspace B, the airspace B is included in the airspace A.

When the airspace A is present inside the airspace B and the airspace B is present inside the airspace A, the airspace A and the airspace B are in intersecting contact.

Return to FIG. 37 and steps after step S25 will be described.

### Step S26

After completion of overlapping determination of airspaces, the overlapping determination unit 33 outputs a determination result to the outside. The overlapping determination unit 33 outputs a result of intersection point detection, for example, to the storage device 2.

As describe above, the steps illustrated in FIG. 37 make it possible that the geographical information management device 200 reliably determines whether the airspace A and the airspace B are overlapped. Thereby, it becomes possible to reliably determine whether two airspaces surrounded by circular arcs on a true sphere are overlapped. The reason is that the overlapping determination unit 33 detects intersection points of line segments that surround a region and determines a position relation between the line segments and the region at each intersection point.

### Third Exemplary Embodiment

A geographical information management device according to a third exemplary embodiment will be described. The geographical information management device according to the present exemplary embodiment includes the same configuration as in the geographical information management device 200 according to the second exemplary embodiment. In the geographical information management device according to the present exemplary embodiment, the overlapping determination unit 33 of the arithmetic unit 6 executes position determination of a spot in addition to airspace overlapping determination. Hereinafter, the position determination of a spot will be described.

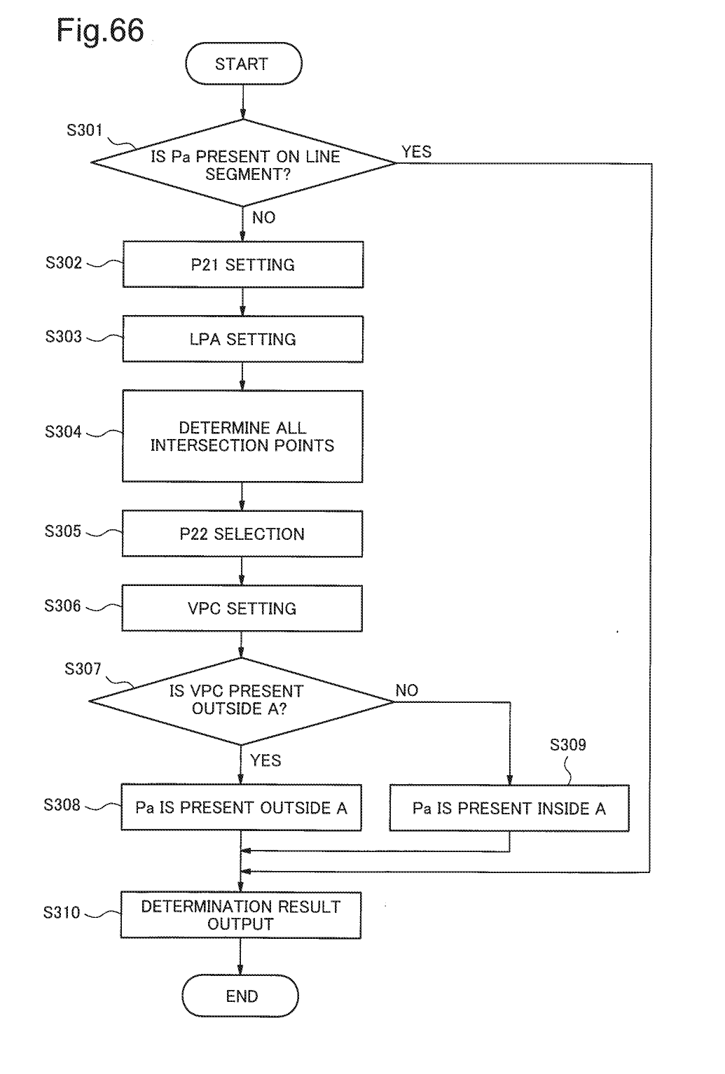

In the position determination of a spot according to the present exemplary embodiment, the overlapping determination unit 33 determines a position relation between an arbitrary point Pa and a given airspace. FIG. 66 is a flowchart illustrating steps of position determination of a spot according to the third exemplary embodiment.

### Step S301

Initially, the overlapping determination unit 33 determines whether a point Pa satisfies Equation (12) that is an equation of a line segment. When the point Pa satisfies the equation of a line segment, as described in the first exemplary embodiment, the overlapping determination unit 33 determines whether the point Pa is present on a line segment configuring an airspace A on the basis of a determination result obtained using Equations (25) to (28).

### Step S302

The overlapping determination unit 33 sets a point P21 on an arbitrary line segment of line segments configuring the airspace A.

### Step S303

The overlapping determination unit 33 determines a straight line LPA passing through the point Pa and the point P21.

### Step S304

The overlapping determination unit 33 determines all intersection points between the straight line LPA and the airspace A. At that time, at least one point that is the above-described point P21 is detected as an intersection point.

### Step S305

The overlapping determination unit 33 selects an intersection point P22 closest to the point Pa from the intersection points between the airspace A and the straight line LPA. Specifically, the unit selects an intersection point in which an inner product with respect to a position vector of the point Pa is largest.

### Step S306

An outgoing line vector VPC going out of the point 22 and passing through the point Pa is determined.

### Step S307

The overlapping determination unit 33 determines a position relation between the outgoing line vector VPC and the airspace A. The relation can be determined in the same manner by replacing Bout with the outgoing line vector VPC in above Equations (45) to (57).

### Step S308

When it is determined that the outgoing line vector VPC is present outside the airspace A, the overlapping determination unit 33 determines that the point Pa is present outside the airspace A.

### Step S309

When it is determined that the outgoing line vector VPC is present inside the airspace A, the overlapping determination unit 33 determines that the point Pa is present inside the airspace A.

### Step S310

The overlapping determination unit 33 outputs a position determination result of the spot to the outside. The overlapping determination unit 33 outputs the position determination result of the spot, for example, to the storage device 2.

As described above, according to the above-described position determination of a spot, it is possible to reliably determine whether an arbitrary spot on a true sphere CB is present on the inside/outside of a given airspace or a boundary line thereof.

This position determination may be executed by a unit other than the overlapping determination unit 33 of the arithmetic unit 6.

### Fourth Exemplary Embodiment

A geographical information management device 400 according to a fourth exemplary embodiment will be described. The geographical information management device 400 is configured using a hardware resource such as a computer system or the like.

In general, in the control or navigation calculation of a moving body such as an aircraft or the like moving on the earth, it is necessary to execute arithmetic processing by quantifying map information. However, the shape of the earth is not a true sphere but a spheroid that is pressed in the north-south direction and has the maximum radius near the equator. Therefore, when arithmetic processing is intended to be executed using coordinate values on the earth as are, massive and complicated processing is needed.

The geographical information management device 400 executes coordinate transformation processing for projecting coordinates in a spheroid to coordinates on a true sphere. Then, arithmetic processing is executed using the projection coordinates on the true sphere, and thereby the geographical information management device 400 realizes the control or navigation calculation of a moving body moving on the earth via simplification and speeding-up of processing and using a small-scale hardware resource. In other words, the geographical information management device 400 is one example of a coordinate transformation device configured to be able to execute coordinate transformation processing.

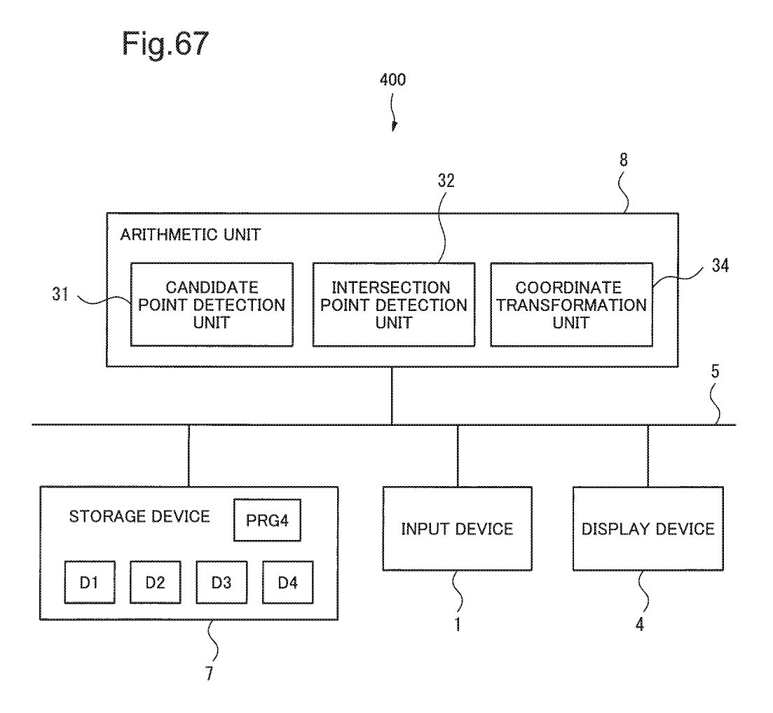

FIG. 67 is a block diagram schematically illustrating a configuration of the geographical information management device 400. The geographical information management device 400 includes a configuration in which the storage device 2 and the arithmetic unit 3 of the geographical information management device 100 according to the first exemplary embodiment are replaced with a storage device 7 and an arithmetic unit 8, respectively.

The storage device 7 stores a parameter information database D3 and a transformation source information database D4, in addition to the basic shape database D1 and the airspace information database D2. Further, the storage device 7 stores a coordinate transformation program PRG4 that specifies arithmetic processing for coordinate transformation. The arithmetic unit 8 includes a configuration in which a coordinate transformation unit 34 is added to the arithmetic unit 3. The other configuration of the geographical information management device 400 is the same as in the geographical information management device 100, and therefore description thereof will be omitted.

The parameter information database D3 includes parameters for transforming coordinate information in a spheroid of the airspace information database D2 to coordinate information on a true sphere. In other words, the coordinates of the spheroid are projected on the true sphere. Hereinafter, the transformed coordinates on the true sphere will be referred to as projection coordinates. Details of the parameter information database D3 will be described later.

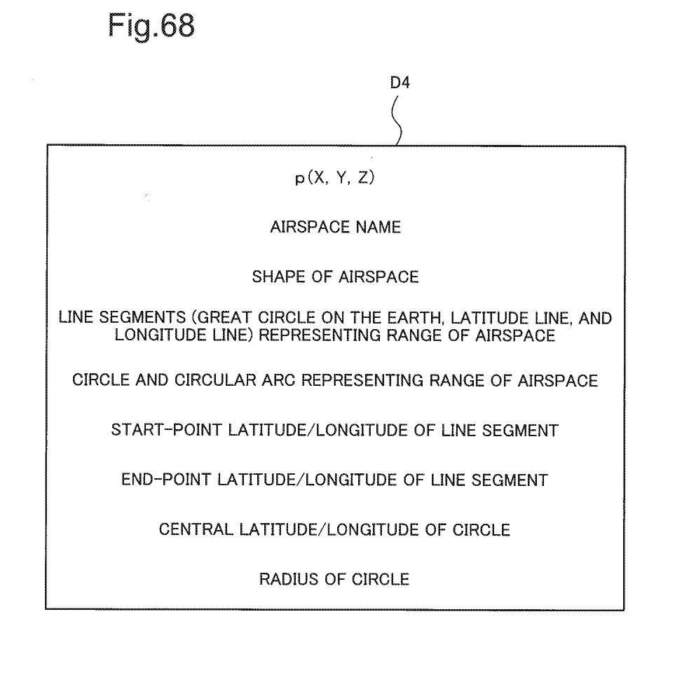

The transformation source information database D4 is information inputted, for example, via the input device 1 and includes information of coordinates of an aircraft to be monitored in a spheroid and coordinates of an airspace in the spheroid. FIG. 68 is a diagram illustrating information included in the transformation source information database D4. The transformation source information database D4 includes information indicating coordinates p(x,y,z) of an aircraft in a spheroid, a line segment (air route) connecting two spots, an airspace name, and a shape (a circle, a rectangle, or the like) and a range of the airspace. The transformation source information database D4 includes, for example, p(X,Y,Z), a start point latitude/longitude of a line segment, an end point latitude/longitude of the line segment, an airspace shape, line segments (great circle on the earth, latitude line, and longitude line) expressing a range of the airspace, information of a circle or a circular arc expressing a range of an airspace, and a central latitude/longitude and a radius for expressing the circle.

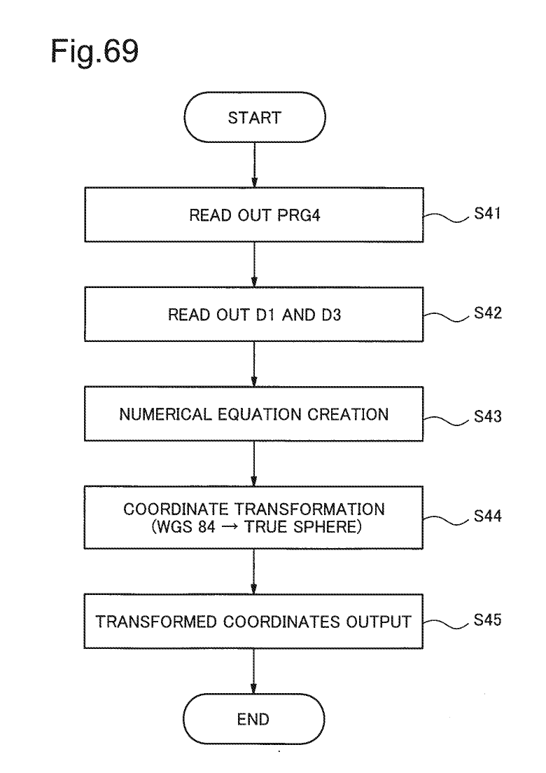

Next, an operation of the geographical information management device 400 will be described. FIG. 69 is a flowchart schematically illustrating the operation of the geographical information management device 400.

### Step S41

Initially, the coordinate transformation unit 34 of the arithmetic unit 3 reads out the coordinate transformation program PRG4. The coordinate transformation program PRG4 is a program for transforming coordinates in a spheroid to projection coordinates on a true sphere using the basic shape database D1, the parameter information database D3, and the transformation source information database D4. The coordinate transformation program PRG4 is read out, for example, from the storage device 7.

### Step S42

The coordinate transformation unit 34 reads out the basic shape database D1 and the parameter information database D3 from the storage device 7.

### Step S43

The coordinate transformation unit 34 substitutes information included in the basic shape database D1 and the parameter information database D3 into an equation specified by the coordinate transformation program PRG4 and creates an equation that executes coordinate transformation.

### Step S44

The coordinate transformation unit 34 reads out the transformation source information database D4 from the storage device 7, substitutes coordinate information included in the transformation source information database D4 into the created equation, and transforms coordinates of a spheroid to projection coordinates in a true sphere. In other words, the coordinate transformation unit 34 transforms the transformation source information database D4 to the airspace information database D2. Details of the coordinate transformation in step S44 will be described later.

### Step S45

The coordinate transformation unit 34 outputs the projection coordinates in the true sphere included in the airspace information database D2 to the outside. The coordinate transformation unit 34 outputs the airspace information database D2, for example, to the storage device 7.

In this example, description has been made, assuming that the arithmetic unit 3 includes a CPU and reads the program PRG4. However, it goes without saying that the arithmetic unit 3 can be configured as a physical entity, for example, a device interiorly including the coordinate transformation unit 34 including a logic circuit.

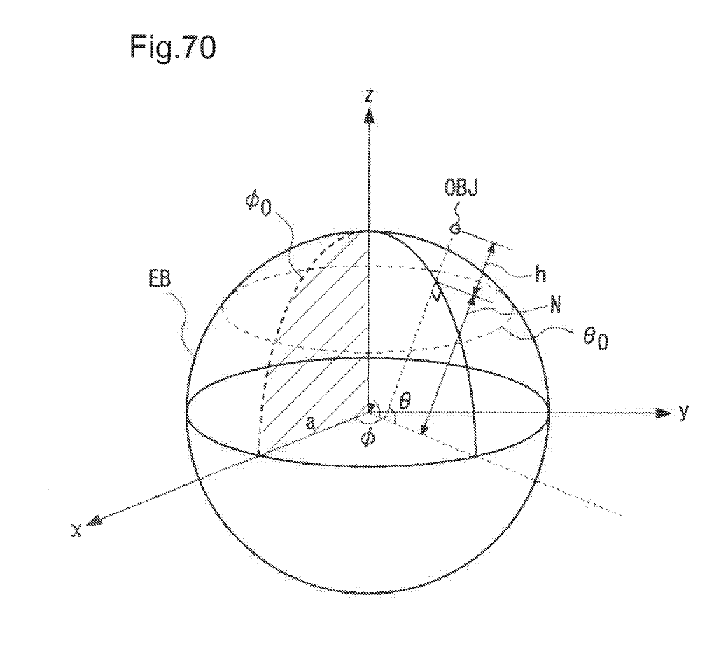

Next, an expression method for coordinates in a spheroid included in the transformation source information database D4 will be described. Coordinates of a spheroid are expressed using, for example, the World Geodetic System 1984 (hereinafter, referred to as the WGS 84 coordinate system). FIG. 70 is a diagram illustrating a relation between a spheroid EB and an observation object OBJ in the WGS 84 coordinate system. In FIG. 70, the sign a represents an equatorial radius of the spheroid EB. When the spheroid EB is the earth, a=6,378,137 m. The sign h represents an altitude on the spheroid EB of the observation object OBJ in the WGS 84 coordinate system. The sign θ represents a latitude on the spheroid EB of the observation object OBJ in the WGS 84 coordinate system. The sign φ represents a longitude on the spheroid EB of the observation object OBJ in the WGS 84 coordinate system. The sign N represents a radius of the spheroid EB at a current position of the observation object OBJ. A three-dimensional position of an observation object on the spheroid EB in the WGS 84 coordinate system is represented by following Equation (58).

$$\begin{matrix}[ Math . 58 ] & \\ x = ( N + h ) cos θcos φ \\ y = ( N + h ) cos θsinφ \\ z = ( N ( 1 - {e}^{2} ) + h ) sin θ \\ {e}^{2} = 2 f - {f}^{2} \\ N = \frac{a}{\sqrt{( 1 - {e}^{2} {sin}^{2} θ )}} & ( 58 )\end{matrix}$$

wherein the sign f represents a flattening. When the spheroid EB is the earth, f=1/298.257223563. The sign e represent an eccentricity. In the present exemplary embodiment, the basic shape database D1 includes an equatorial radius a, a reference latitude θo, a reference longitude φo, an eccentricity e, and a flattening f of the spheroid EB (the earth).

Next, properties of a latitude line interval and a longitude line interval of the spheroid EB will be examined. In general, an interval of latitude lines is constant in a true sphere. On the other hand, in the spheroid EB, an interval of latitude lines is minimum near the equator and is maximum near the North Pole or the South Pole at an altitude of 0 (the ground surface). A latitude line interval Dθ at the ground surface on the spheroid EB in the WGS 84 coordinate system is represented by following Equation (59) on the basis of Equation (58).

$$\begin{matrix}[ Math . 59 ] & \\ \begin{matrix}\frac{\partial x}{\partial θ} = \frac{\partial N}{\partial θ} cos θcosφ - N sin θcos ϕ \\ = \frac{a {e}^{2} sin {θcos}^{2} θcos φ}{\sqrt{{( 1 - {e}^{2} {sin}^{2} θ )}^{3}}} - \frac{a sin θcos φ}{\sqrt{( 1 - {e}^{2} {sin}^{2} θ )}} \\ = \frac{a sin θcos φ}{\sqrt{{( 1 - {e}^{2} {sin}^{2} θ )}^{3}}} ( {e}^{2} {cos}^{2} θ - 1 + {e}^{2} {sin}^{2} θ ) \\ = \frac{- a ( 1 - {e}^{2} ) sin θcos φ}{\sqrt{{( 1 - {e}^{2} {sin}^{2} θ )}^{3}}}\end{matrix} \\ \frac{\partial y}{\partial θ} = \frac{- a ( 1 - {e}^{2} ) sin θsin φ}{\sqrt{{( 1 - {e}^{2} {sin}^{2} θ )}^{3}}} \\ \begin{matrix}\frac{\partial z}{\partial θ} = \frac{\partial N}{\partial θ} ( 1 - {e}^{2} ) sin θ + N ( 1 - {e}^{2} ) cos θ \\ = \frac{a {e}^{2} ( 1 - {e}^{2} ) {sin}^{2} θcos θ}{\sqrt{{( 1 - {e}^{2} {sin}^{2} θ )}^{3}}} + \frac{a ( 1 - {e}^{2} ) cos θ}{\sqrt{( 1 - {e}^{2} {sin}^{2} θ )}} \\ = \frac{a ( 1 - {e}^{2} ) cos θ}{\sqrt{{( 1 - {e}^{2} {sin}^{2} θ )}^{3}}} ( {e}^{2} {sin}^{2} θ + 1 - {e}^{2} {sin}^{2} θ ) \\ = \frac{a ( 1 - {e}^{2} ) cos θ}{\sqrt{{( 1 - {e}^{2} {sin}^{2} θ )}^{3}}}\end{matrix} \\ \begin{matrix}{D}_{θ} = \sqrt{\{ {( \frac{\partial x}{\partial θ} )}^{2} + {( \frac{\partial y}{\partial θ} )}^{2} + {( \frac{\partial z}{\partial θ} )}^{2} \}} \\ = \frac{a ( 1 - {e}^{2} )}{\sqrt{{( 1 - {e}^{2} {sin}^{2} θ )}^{3}}}\end{matrix} & ( 59 )\end{matrix}$$

Next, an interval of longitude lines will be examined. On a true sphere, an interval of longitude lines is proportional to a cosine of a latitude, and has a maximum value of a at the equator and has a minimum value of 0 at the North Pole or the South Pole at an altitude of 0 (the ground surface). This is the same as in the spheroid EB. A longitude line interval Dφ at the ground surface on the true sphere and the spheroid EB in the WGS 84 coordinate system is represented by following Equation (60) on the basis of Equation (58).

$$\begin{matrix}[ Math . 60 ] & \\ \frac{\partial x}{\partial φ} = - N cos θ sin φ \\ \frac{\partial y}{\partial φ} = N cos θcos φ \\ \frac{\partial z}{\partial φ} = 0 \\ \begin{matrix}{D}_{φ} = \sqrt{\{ {( \frac{\partial x}{\partial φ} )}^{2} + {( \frac{\partial y}{\partial φ} )}^{2} + {( \frac{\partial z}{\partial φ} )}^{2} \}} \\ = N cos θ \\ = \frac{a cos θ}{\sqrt{( 1 - {e}^{2} {sin}^{2} θ )}}\end{matrix} & ( 60 )\end{matrix}$$

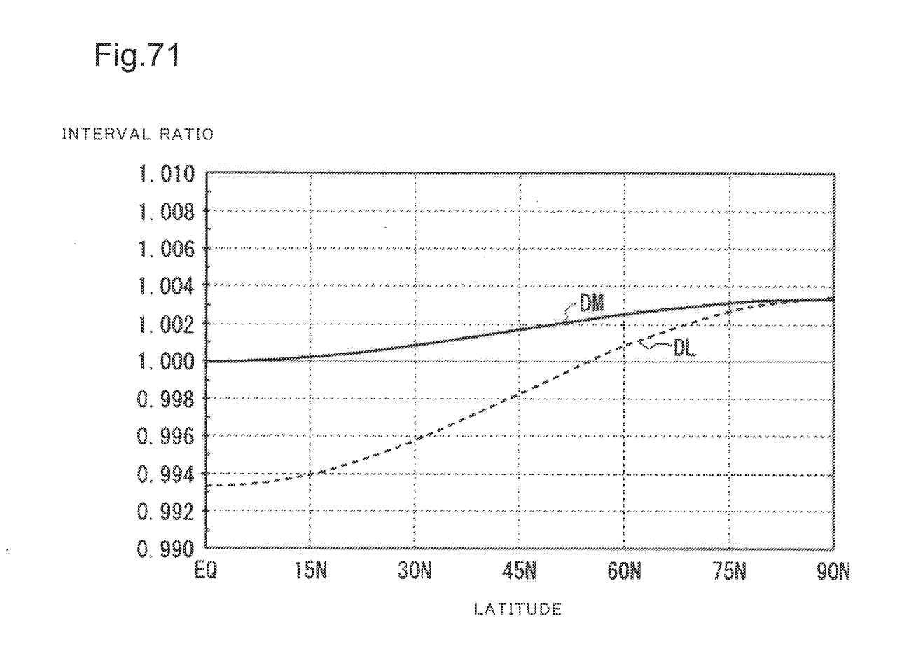

FIG. 71 is a graph illustrating a latitude line interval ratio and a longitude line interval ratio in a spheroid EB. Herein, the latitude line interval ratio DL is a value obtained by dividing a latitude interval by an equatorial radius a. The longitude line interval ratio DM is a value obtained by dividing a longitude line interval by an equatorial radius a and a cosine cos θ. As illustrated in FIG. 71, it can be understood that the latitude line interval ratio increases toward the North Pole from the equator. It can be understood that the longitude line interval ratio also increases toward the North Pole from the equator.

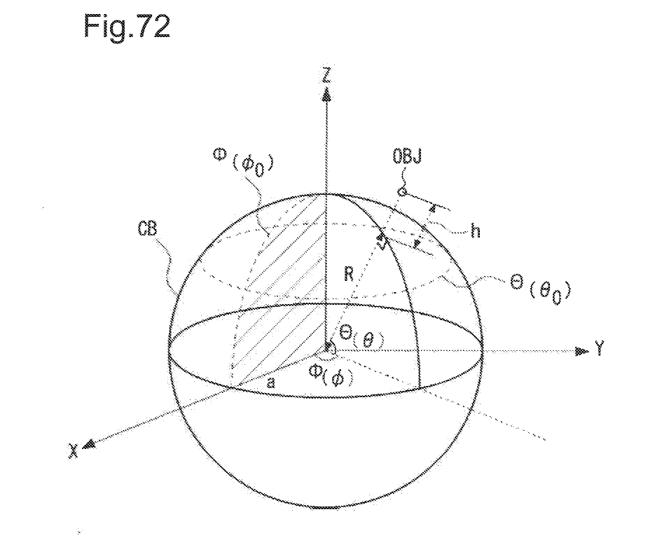

An expression method for projection coordinates on a true sphere included in the airspace information database D2 will be described. FIG. 72 is a diagram illustrating a relation between a true sphere CB and an observation object OBJ. In FIG. 72, the sign R represents a radius of the true sphere CB. The sign h represents an altitude of the observation object OBJ in the true sphere CB. Θ(θ) is a function of a latitude θ on a spheroid EB in the WGS 84 coordinate system and represents a projection latitude in the true sphere CB. Φ(φ) is a function of a longitude φ on the spheroid EB in the WGS 84 coordinate system and represents a projection longitude in the true sphere CB. A three-dimensional position (X,Y,Z) of the observation object OBJ on the true sphere CB is represented by following Equation (61) using three-dimensional polar coordinates.

[Math. 61]

X=(R+h)cos Θ cos Φ

Y=(R+h)cos Θ sin Φ

Z=(R+h)sin Θ (61)

Comparison between Equation (61) and Equation (58) makes it understandable that projection coordinates in the true sphere CB can be expressed using a function form simpler than coordinates in the spheroid EB.

A latitude line interval Δθ at the ground surface on a true sphere is represented by following Equation (62) on the basis of Equation (61).

$$\begin{matrix}[ Math . 62 ] & \\ \frac{\partial X}{\partial θ} = - R \frac{\partial Θ}{\partial θ} sin Θcos Φ \\ \frac{\partial Y}{\partial θ} = - R \frac{\partial Θ}{\partial θ} sin Θ sin Φ \\ \frac{\partial Z}{\partial θ} = R \frac{\partial Θ}{\partial θ} cos Θ \\ \begin{matrix}{Δ}_{θ} = \sqrt{\{ {( \frac{\partial x}{\partial φ} )}^{2} + {( \frac{\partial y}{\partial φ} )}^{2} + {( \frac{\partial z}{\partial φ} )}^{2} \}} \\ = R \frac{\partial Θ}{\partial θ}\end{matrix} & ( 62 )\end{matrix}$$

A longitude line interval Δφ at the ground surface on the true sphere is represented by following Equation (63) on the basis of Equation (61).

$$\begin{matrix}[ Math . 63 ] & \\ \frac{\partial X}{\partial φ} = - R \frac{\partial Φ}{\partial φ} cos Θsin Φ \\ \frac{\partial Y}{\partial φ} = R \frac{\partial Φ}{\partial φ} cos Θ cos Φ \\ \frac{\partial Z}{\partial φ} = 0 \\ \begin{matrix}{Δ}_{φ} = \sqrt{\{ {( \frac{\partial X}{\partial φ} )}^{2} + {( \frac{\partial Y}{\partial φ} )}^{2} + {( \frac{\partial Z}{\partial φ} )}^{2} \}} \\ = R \frac{\partial Φ}{\partial φ} cos Θ\end{matrix} & ( 63 )\end{matrix}$$

In the present exemplary embodiment, the coordinate transformation unit 34 transforms coordinates on a spheroid EB in the WGS 84 coordinate system described above to projection coordinates projected on a true sphere CB. Hereinafter, there will be described a transformation parameter for transforming the coordinates on the spheroid EB in the above-described WGS 84 coordinate system to the projection coordinates on the true sphere CB.

To project the spheroid EB on the true sphere CB with distortion as less as possible, it is necessary that at an altitude h of 0 and a predetermined latitude, i.e. a reference latitude θ₀, a latitude line interval Dθ on the spheroid EB and a latitude line interval Δθ on the true sphere CB be equal to each other (Δθ=Dθ). Therefore, following Equation (64) is obtained from Equation (59) and Equation (62).

$$\begin{matrix}[ Math . 64 ] & \\ {R ( \frac{\partial Θ}{\partial θ} )}_{{θ}_{0}} = \frac{a ( 1 - {e}^{2} )}{\sqrt{{( 1 - {e}^{2} {sin}^{2} {θ}_{0} )}^{3}}} & ( 64 )\end{matrix}$$

To project the spheroid EB on the true sphere CB with distortion as less as possible, it is necessary that at an altitude h of 0 and a reference latitude θ₀, a longitude line interval Dφ on the spheroid EB and a longitude line interval Δφ on the true sphere CB be equal to each other (Δφ=Dφ). Therefore, following Equation (65) is obtained from Equation (60) and Equation (63).

$$\begin{matrix}[ Math . 65 ] & \\ {R ( \frac{\partial Φ}{\partial φ} cos Θ )}_{{θ}_{0}} = \frac{a cos {θ}_{0}}{\sqrt{( 1 - {e}^{2} {sin}^{2} {θ}_{0} )}} & ( 65 )\end{matrix}$$

It is necessary that a first-order change rate of a latitude direction of a latitude line interval of the spheroid EB and a first-order change rate of a latitude direction of a latitude line interval on the true sphere CB be equal to each other at the reference latitude θ₀. Therefore, following Equation (66) is obtained from Equation (59) and Equation (62).

$$\begin{matrix}[ Math . 66 ] & \\ \frac{\partial {Δ}_{θ}}{\partial θ} = \frac{\partial {D}_{θ}}{\partial θ} \\ R \frac{{\partial }^{2} Θ}{\partial {θ}^{2}} = \frac{3 a ( 1 - {e}^{2} ) {e}^{2} sin θcos θ}{\sqrt{{( 1 - {e}^{2} {sin}^{2} θ )}^{5}}} \\ θ = {θ}_{0} \\ {R ( \frac{{\partial }^{2} Θ}{\partial {θ}^{2}} )}_{{θ}_{0}} = \frac{3 a ( 1 - {e}^{2} ) {e}^{2} sin {θ}_{0} cos {θ}_{0}}{\sqrt{{( 1 - {e}^{2} {sin}^{2} {θ}_{0} )}^{5}}} & ( 66 )\end{matrix}$$

It is necessary that a first-order change rate of a latitude direction of a longitude line interval of the spheroid EB and a first-order change rate of a latitude direction of a longitude line interval on the true sphere CB be equal to each other at the reference latitude θ₀. Therefore, following Equation (67) is obtained from Equation (60) and Equation (63).

$$\begin{matrix}[ Math . 67 ] & \\ \frac{\partial {Δ}_{φ}}{\partial θ} = \frac{\partial D φ}{\partial θ} \\ \begin{matrix}- R ( \frac{\partial Φ}{\partial φ} ) ( \frac{\partial Θ}{\partial θ} sin Θ ) = \frac{- a sin θ}{\sqrt{( 1 - {e}^{2} {sin}^{2} θ )}} + \frac{a {e}^{2} sin θ {cos}^{2} θ}{\sqrt{{( 1 - {e}^{2} {sin}^{2} θ )}^{3}}} \\ = \frac{- a sin θ}{\sqrt{{( 1 - {e}^{2} {sin}^{2} θ )}^{3 }}} ( 1 - {e}^{2} {sin}^{2} θ - {e}^{2} {cos}^{2} θ ) \\ = \frac{- a ( 1 - {e}^{2} ) sin θ}{\sqrt{{( 1 - {e}^{2} {sin}^{2} θ )}^{3}}}\end{matrix} & ( 67 ) \\ θ = {θ}_{0} \\ R {( \frac{\partial Φ}{\partial φ} )}_{{θ}_{0}} {( \frac{\partial Θ}{\partial θ} sin Θ )}_{{θ}_{0}} = \frac{a ( 1 - {e}^{2} ) sin {θ}_{0}}{\sqrt{{( 1 - {e}^{2} {sin}^{2} {θ}_{0} )}^{3}}} & \end{matrix}$$

It is assumed that a second-order change rate of a latitude direction of a longitude line interval of the spheroid EB and a second-order change rate of a latitude direction of a longitude line interval on the true sphere CB are equal to each other at the reference latitude θ₀. Therefore, following Equation (68) is obtained from Equation (60) and Equation (63).

$$\begin{matrix} [ Math . 68 ] & \\ \frac{{\partial }^{2} {Δ}_{φ}}{\partial {θ}^{2}} = \frac{{\partial }^{2} D φ}{\partial {θ}^{2}} \\ - R ( \frac{\partial Φ}{\partial φ} ) \{ ( \frac{{\partial }^{2} Θ}{\partial {θ}^{2}} ) sin Θ + {( \frac{\partial Θ}{\partial θ} )}^{2} cos Θ \} = \frac{- a ( 1 - {e}^{2} ) cos θ}{\sqrt{{( 1 - {e}^{2} {sin}^{2} θ )}^{3}}} - \frac{3 a ( 1 - {e}^{2} ) {e}^{2} {sin}^{2} θ cos θ}{\sqrt{{( 1 - {e}^{2} {sin}^{2} θ )}^{5 }}} = \frac{- a ( 1 - {e}^{2} ) cos θ}{\sqrt{{( 1 - {e}^{2} {sin}^{2} θ )}^{5 }}} ( 1 - {e}^{2} sin θ + 3 {e}^{2} {sin}^{2} θ ) = \frac{- a ( 1 - {e}^{2} ) cos θ}{\sqrt{{( 1 - {e}^{2} {sin}^{2} θ )}^{5}}} ( 1 + 2 {e}^{2} {sin}^{2} θ ) \\ θ = {θ}_{0} \\ {R ( \frac{\partial Φ}{\partial φ} )}_{{θ}_{0}} {\{ ( \frac{{\partial }^{2} Θ}{\partial {θ}^{2}} ) sin Θ + {( \frac{\partial Θ}{\partial θ} )}^{2} cos Θ \}}_{{θ}_{0}} = \frac{a ( 1 - {e}^{2} ) cos {θ}_{0}}{\sqrt{{( 1 - {e}^{2} {sin}^{2} {θ}_{0} )}^{5}}} ( 1 + 2 {e}^{2} {sin}^{2} {θ}_{0} ) & ( 68 )\end{matrix}$$

Hereinafter, using above-described equations, transformation parameters will be calculated. Initially, there is calculated a transformation parameter Pr for transforming an equatorial radius a of the spheroid EB in the WGS 84 coordinate system to a radius R of the true sphere CB. Initially, from Equation (67)×Equation (66)/Equation (64), following Equation (69) is obtained.

$$\begin{matrix}[ Math . 69 ] & \\ {R ( \frac{\partial Φ}{\partial φ} )}_{{θ}_{0}} {( \frac{{\partial }^{2} Θ}{\partial {θ}^{2}} sin Θ )}_{{θ}_{0}} = \frac{3 a ( 1 - {e}^{2} ) {e}^{2} {sin}^{2} {θ}_{0} cos {θ}_{0}}{\sqrt{{( 1 - {e}^{2} {sin}^{2} {θ}_{0} )}^{5}}} & ( 69 )\end{matrix}$$

Equation (69) is equal to the first term of the left side of Equation (68).

From Equation (65)×{Equation (64)}²/R², following Equation (70) is obtained.

$$\begin{matrix}[ Math . 70 ] & \\ {R ( \frac{\partial Φ}{\partial φ} )}_{{θ}_{0}} {( {( \frac{\partial Θ}{\partial θ} )}^{2} cos Θ )}_{{θ}_{0}} = \frac{{{a}^{3} ( 1 - {e}^{2} )}^{2} cos {θ}_{0}}{{R}^{2} \sqrt{{( 1 - {e}^{2} {sin}^{2} {θ}_{0} )}^{7 }}} & ( 70 )\end{matrix}$$

Equation (70) is equal to the second term of the left side of Equation (68).

Therefore, when Equation (69) and Equation (70) are substituted into Equation (68), as represented in following Equation (71), it is possible to calculate the transformation parameter Pr for transforming an equatorial radius a of the spheroid EB in the WGS 84 coordinate system to a radius R of the true sphere CB. Herein, represents an equivalent deformation of an equation.

[symbol]

$$\begin{matrix} [ Math . 71 ] & \\ \frac{a ( 1 - {e}^{2} ) cos {θ}_{0}}{\sqrt{{( 1 - {e}^{2} {sin}^{2} {θ}_{0} )}^{5}}} ( 1 + 2 {e}^{2} {sin}^{2} {θ}_{0} ) = \frac{3 a ( 1 - {e}^{2} ) {e}^{2} {sin}^{2} {θ}_{0} cos {θ}_{0}}{\sqrt{{( 1 - {e}^{2} {sin}^{2} {θ}_{o} )}^{5}}} + \frac{{{a}^{3} ( 1 - {e}^{2} )}^{2} cos {θ}_{0}}{{R}^{2} \sqrt{{( 1 - {e}^{2} {sin}^{2} {θ}_{0} )}^{7}}} \\ ⇔ 1 + 2 {e}^{2} {sin}^{2} {θ}_{0} = 3 {e}^{2} {sin}^{2} {θ}_{0} + \frac{{a}^{2} ( 1 - {e}^{2} )}{{R}^{2} ( 1 - {e}^{2} {sin}^{2} {θ}_{0} )} \\ ⇔ 1 - {e}^{2} {sin}^{2} {θ}_{0} = \frac{{a}^{2} ( 1 - {e}^{2} )}{{R}^{2} ( 1 - {e}^{2} {sin}^{2} {θ}_{0} )} \\ ⇔ {( R / a )}^{2} = \frac{1 - {e}^{2}}{{( 1 - {e}^{2} {sin}^{2} {θ}_{0} )}^{2}} \\ ∴ R / a = Pr = \frac{\sqrt{( 1 - {e}^{2} )}}{( 1 - {e}^{2} {sin}^{2} {θ}_{0} )} & ( 71 )\end{matrix}$$

In other words, the coordinate transformation unit 34 calculates Pr-a, and thereby can transform an equatorial radius a of a spheroid EB to an equatorial radius R of a true sphere.

Next, there will be calculated a transformation parameter for transforming a longitude φ in a spheroid EB to a projection longitude φ in a true sphere CB. Initially, from Equation (65)/R, following Equation (72) is obtained.

$$\begin{matrix}[ Math . 72 ] & \\ {( \frac{\partial Φ}{\partial φ} cos Θ )}_{{θ}_{0}} = \frac{( a / R ) cos {θ}_{0}}{\sqrt{( 1 - {e}^{2} {sin}^{2} {θ}_{0} )}} & ( 72 )\end{matrix}$$

Equation (71) is substituted into Equation (72), and thereby following Equation (73) is obtained.

$$\begin{matrix}[ Math . 73 ] & \\ {( \frac{\partial Φ}{\partial φ} cos Θ )}_{{θ}_{0}} = \frac{\sqrt{( 1 - {e}^{2} {sin}^{2} {θ}_{0} )}}{\sqrt{( 1 - {e}^{2} )}} cos {θ}_{0} & ( 73 )\end{matrix}$$

Then, from Equation (67)/Equation (64), following Equation (74) is obtained.

$$\begin{matrix}[ Math . 74 ] & \\ {( \frac{\partial Φ}{\partial φ} sin Θ )}_{{θ}_{0}} = sin {θ}_{0} & ( 74 )\end{matrix}$$

From {Equation (73)}²+{Equation (74)}², following Equation (75) is obtained.

$$\begin{matrix}[ Math . 75 ] & \\ \begin{matrix}{( \frac{\partial Φ}{\partial φ} )}_{{θ}_{0}}^{2} = {( \frac{\partial Φ}{\partial φ} cos Θ )}_{{θ}_{0}}^{2} + {( \frac{\partial Φ}{\partial φ} sin Θ )}_{{θ}_{0}}^{2} \\ = \frac{( 1 - {e}^{2} {sin}^{2} {θ}_{0} ) {cos}^{2} {θ}_{0}}{1 - {e}^{2}} + {sin}^{2} {θ}_{0}\end{matrix} & ( 75 )\end{matrix}$$

Therefore, from Equation (75), there is obtained a transformation parameter λ_{φ} for transforming the longitude φ in the spheroid EB to the projection longitude φ in the true sphere CB as represented by following Equation (76).

$$\begin{matrix}[ Math . 76 ] & \\ {λ}_{φ} = {( \frac{\partial Φ}{\partial φ} )}_{{θ}_{0}} = \sqrt{\frac{1 - {e}^{2} {sin}^{2} {θ}_{0} ( 1 + {cos}^{2} {θ}_{0} )}{1 - {e}^{2}}} & ( 76 )\end{matrix}$$

Therefore, the projection longitude φ is represented by following Equation (77). In other words, on the basis of Equation (76) and Equation (77), the coordinate transformation unit 34 can transform a longitude φ in a spheroid EB to a projection longitude φ on a true sphere.

[Math. 77]

Φ=λ_{φ}(φ−φ₀) (77)

Hereinafter, coordinate transformation of a latitude in step S44 will be described in detail. There will be described a method for transforming a reference latitude θ₀ in a spheroid EB to a projection reference latitude Θ₀ on a true sphere CB. From Equation (74)/Equation (73), following Equation (78) is obtained.

$$\begin{matrix}[ Math . 78 ] & \\ {( tan Θ )}_{{θ}_{0}} = \frac{\sqrt{1 - {e}^{2}}}{\sqrt{1 - {e}^{2} {sin}^{2} {θ}_{0}}} tan {θ}_{0} & ( 78 )\end{matrix}$$

Therefore, the projection reference latitude Θ₀ is represented by following Equation (79).

$$\begin{matrix}[ Math . 79 ] & \\ {Θ}_{0} = {tan}^{- 1} ( \frac{\sqrt{1 - {e}^{2}}}{\sqrt{1 - {e}^{2} {sin}^{2} {θ}_{0}}} tan {θ}_{0} ) & ( 79 )\end{matrix}$$

A method for transforming a latitude θ in a spheroid EB to a projection latitude Θ on a true sphere will be described. To project a spheroid EB on a true sphere CB with distortion as less as possible, setting in which at an altitude h of 0 and an arbitrary latitude θ, a latitude line interval Dθ on the spheroid EB and a latitude line interval Δθ on the true sphere CB are equal to each other (Δθ=Dθ) is made as a condition (equal latitude line interval condition). In this case, Equation (65) is deformed to obtain following Equation (80).

$$\begin{matrix}[ Math . 80 ] & \\ R ( \frac{\partial Θ}{\partial θ} ) = \frac{a ( 1 - {e}^{2} )}{\sqrt{{( 1 - {e}^{2} {sin}^{2} θ )}^{3}}} & ( 80 )\end{matrix}$$

Equation (80) is deformed to obtain following Equation (81).

$$\begin{matrix}[ Math . 81 ] & \\ \begin{matrix}Θ = ( a / R ) \int \frac{( 1 - {e}^{2} )}{\sqrt{{( 1 - {e}^{2} {sin}^{2} θ )}^{3}}} d θ \\ = \frac{a ( 1 - {e}^{2} )}{R} Π ( {e}^{2} ; θ , e ) + C\end{matrix} & ( 81 )\end{matrix}$$

wherein Π is a third-kind elliptical integral and C is an integral constant. The coordinate transformation unit 34 can transform the latitude θ in the spheroid EB to the projection latitude Θ on the true sphere on the basis of Equation (81).

The condition set as described is merely one example. The condition may be, for example, a condition in which at an arbitrary latitude θ, a longitude line interval Dφ on the spheroid EB and a longitude line interval Δφ on the true sphere CB are equal to each other (Δφ=Dφ) or a condition in which at an arbitrary latitude θ, an area on the spheroid EB and an area on the sphere CB are equal to each other (equivalent). Further, the condition may be another condition in which at an arbitrary latitude θ, a direction on the spheroid EB and a direction on the true sphere CB are equal to each other (equiangular). To practically execute coordinate transformation, operations using an elliptical function are complicated, and therefore, use of an approximate equation using a development equation (e.g. NPL 1) based on Helmert's formula makes handling easy. Hereinafter, calculation using a development equation based on Helmert's formula will be described. Herein, using a flattening f, a third flattening n is defined by following Equation (82).

$$\begin{matrix}[ Math . 82 ] & \\ n = \frac{f}{2 - f} & ( 82 )\end{matrix}$$

Using Equation (82), an approximate equation (83) of Equation (81) is obtained.

$$\begin{matrix} [ Math . 83 ] & \\ Θ \approx \frac{a}{( 1 + n ) R} \{ \begin{matrix}( 1 + \frac{{n}^{2}}{4} + \frac{{n}^{2}}{64} ) θ - \frac{3}{2} ( n - \frac{{n}^{3}}{8} ) sin 2 θ + \\ \frac{15}{16} ( {n}^{2} - \frac{{n}^{2}}{4} ) sin 4 θ - \frac{35}{48} {n}^{3} sin 6 θ + \frac{315}{512} {n}^{4} sin 8 θ\end{matrix} \} + C & ( 83 )\end{matrix}$$

Coefficients of terms of the right side of Equation (83) are defined as following Equations (84A) to (84F).

$$\begin{matrix} [ Math . 84 ] & \\ {λ}_{θ} = \frac{a}{( 1 + n ) R} ( 1 + \frac{{n}^{2}}{4} + \frac{{n}^{4}}{64} ) & ( 84 A ) \\ {λ}_{2} = \frac{- 3 a}{2 ( 1 + n ) R} ( n - \frac{{n}^{3}}{8} ) & ( 84 B ) \\ {λ}_{4} = \frac{15 a}{16 ( 1 + n ) R} ( {n}^{2} - \frac{{n}^{4}}{4} ) & ( 84 C ) \\ {λ}_{6} = \frac{- 35 a {n}^{3}}{48 ( 1 + n ) R} & ( 84 D ) \\ {λ}_{8} = \frac{315 a {n}^{4}}{512 ( 1 + n ) R} & ( 84 E ) \\ {λ}_{0} = {Θ}_{0} - ( {λ}_{θ} {θ}_{0} + {λ}_{2} sin 2 {θ}_{0} + {λ}_{4} sin 4 {θ}_{0} + {λ}_{6} sin 6 {θ}_{0} + {λ}_{8} sin 8 {θ}_{0} ) & ( 84 F )\end{matrix}$$

Using Equations (84A) to (84F), Equation (83) is transformed, and thereby a projection latitude θ on the true sphere CB is represented by following Equation (85).

[Math. 85]

Θ(θ)=λ₀θ+λ₂ sin 2θ+λ₄ sin 4θ+λ₆ sin 6θ+λ₈ sin 8θ+λ₀ (85)

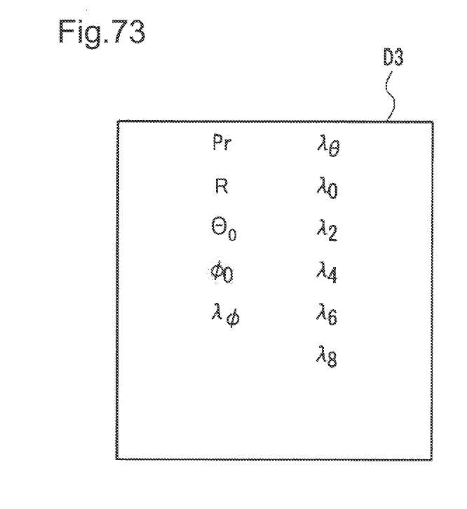

On the basis of the calculation results of the transformation parameters described above, details of the parameter information database D3 will be described. FIG. 73 is a diagram illustrating information included in the parameter information database D3. The parameter information database D3 includes a radius R of a true sphere CB, a parameter Pr for calculating the radius R of the true sphere CB, a projection reference latitude Θ₀, a transformation parameter λφ represented by Equation (76), and transformation parameters λ_{θ}, λ₀, λ₂, λ₄, λ₆, and λ₈ represented by Equation (84A) to Equation (84E). Thereby, the coordinate transformation unit 34 can acquire correction parameters necessary to transform the transformation source information database D4 to the airspace information database D2.

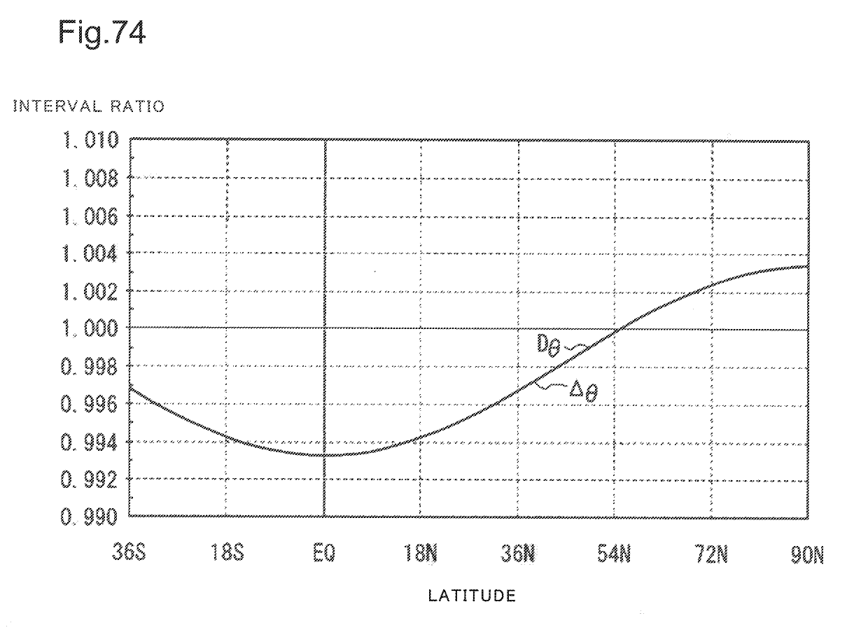

Next, a change of a latitude line interval will be described. FIG. 74 is a graph illustrating a latitude dependency of a latitude line interval ratio in which a reference latitude θ₀ is a latitude of 36 degrees north. An interval ratio of FIG. 74 is defined in the same manner as in FIG. 71. In FIG. 74, a line illustrated as Dθ is obtained by dividing a value determined by Equation (60) by an equatorial radius a. A line illustrated as A0 is obtained by dividing a value determined by Equation (62) and Equation (85) by an equatorial radius a. In the flowing description, when a latitude is illustrated in the graph, “N” is indicated after a number indicating a latitude for a north latitude, and “S” is indicated after a number indicating a latitude for a south latitude. For the equator, “EQ” is indicated.

From three-dimensional positions of two spots in a projection coordinate system on a true sphere CB, it is possible to easily calculate a distance d between a spot P₁ and a spot P₂ on the ground surface of an altitude h of 0. However, to ease the flowing numerical value calculation, in Equation (86) to Equation (88), a normalized vector is used.

A position of the spot P₁ is represented by following Equation (86) on the basis of Equation (61).

[Math. 86]

P₁=(X₁,Y₁,Z₁)

X₁=cos Θ₁ cos Φ₁

Y₁=cos Θ₁ sin Φ₁

Z₁=sin Θ₁ (86)

A position of the spot P₂ is represented by following Equation (87) on the basis of Equation (61).

[Math. 87]

P₂=(X₂,Y₂,Z₂)

X₂=cos Θ₂ cos Φ₂

Y₂=cos Θ₂ sin Φ₂

Z₂=sin Θ₂ (87)

Therefore, the distance d between the spot P₁ and the spot P₂ is represented by following Equation (88).

[Math. 88]

d=R cos⁻¹((P₁·P₂)) (88)

This corresponds to an equation (following Equation (89)) for distance calculation in spherical trigonometry.

[Math. 89]

d=R cos⁻¹(sin Θ₁ sin Φ₂+cos Θ₁ COS Θ₂ cos(Φ₂−Φ₁)) (89)

As illustrated in FIG. 74, a latitude dependency of a latitude line interval DΘ in a spheroid EB and a latitude dependency of a latitude line interval ΔΘ in projection coordinates coincide. In other words, it is understandable that there is substantially no error in projection coordinates of a latitude direction (south-north direction).

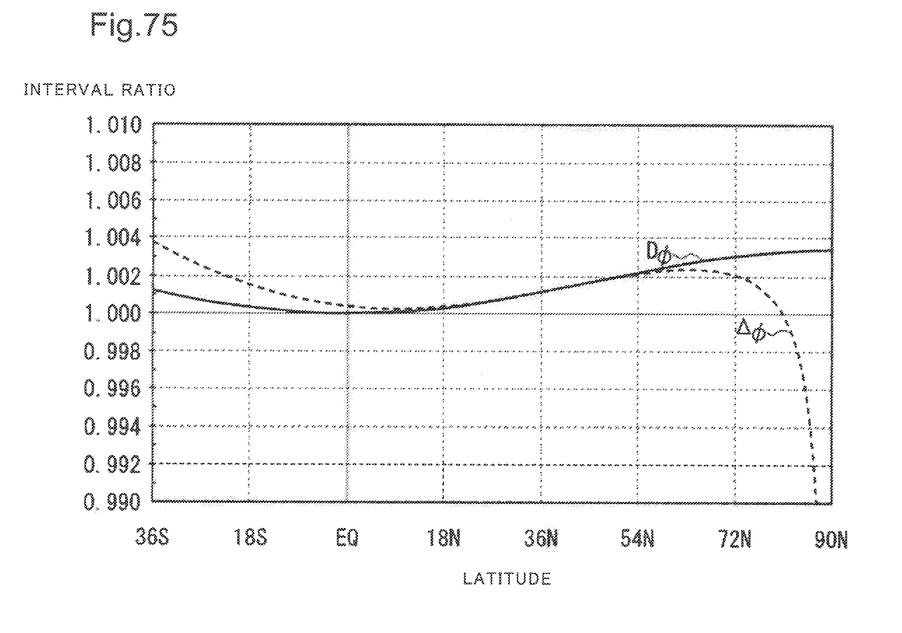

Next, a change of a longitude line interval will be described. FIG. 75 is a graph illustrating a latitude dependency of a longitude line interval ratio in which a reference latitude θ₀ is a latitude of 36 degrees north. An interval ratio of FIG. 75 is defined in the same manner as in FIG. 71. In FIG. 75, a line illustrated as Dφ is obtained by dividing a value determined by Equation (60) by an equatorial radius a and a cosine cos θ. A line illustrated as Δφ is obtained by dividing a value determined by Equation (63), Equation (76), and Equation (85) by an equatorial radius a and a cosine cos θ. It is understandable that a latitude dependency of a longitude line interval Dφ in the WGS 84 coordinate system and a latitude dependency of a longitude line interval Δφ in projection coordinates substantially coincide in a range approximately from a latitude of 14 degrees north to a latitude of 55 degrees north, when a reference latitude θ₀ is set to be a latitude of 36 degrees north.

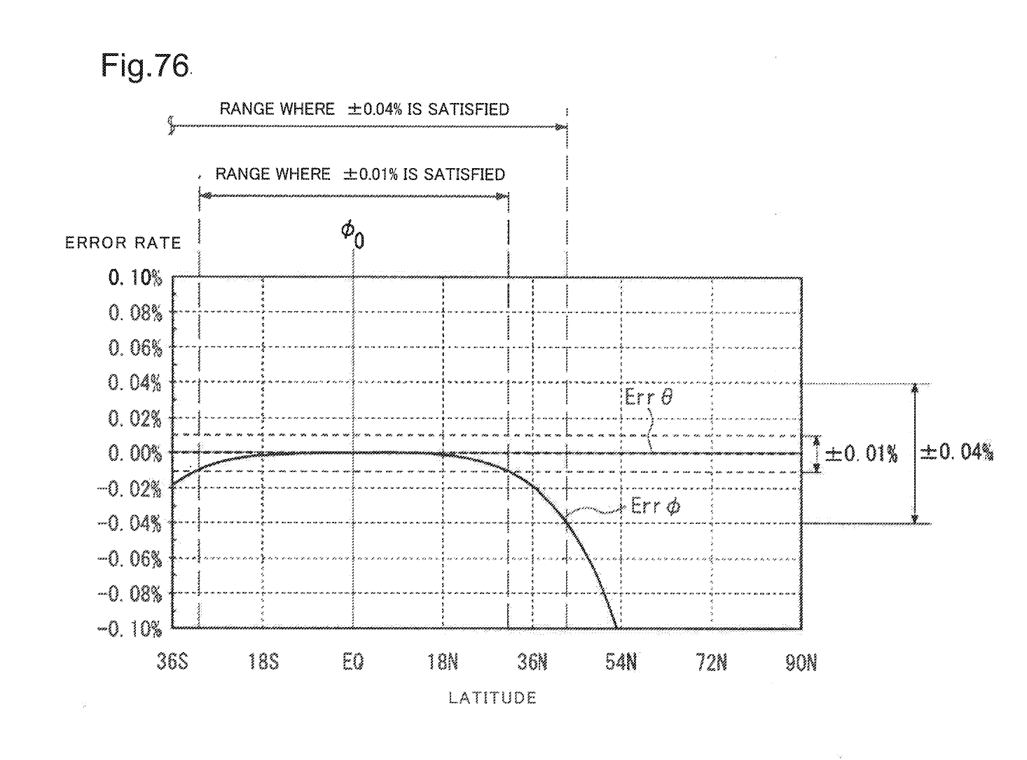

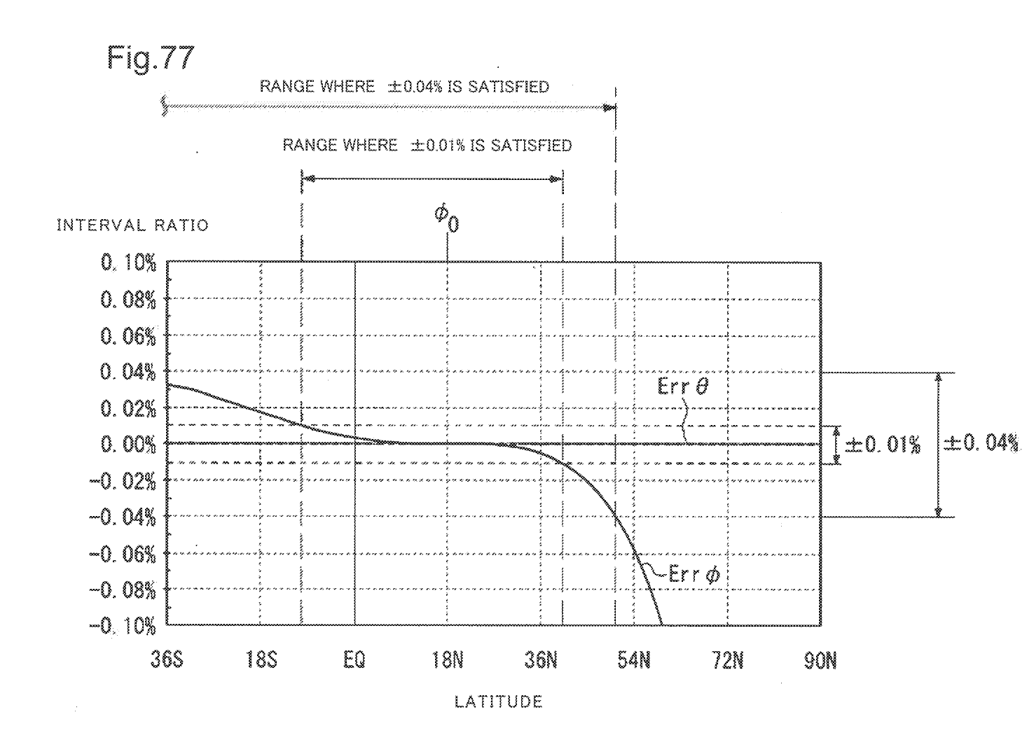

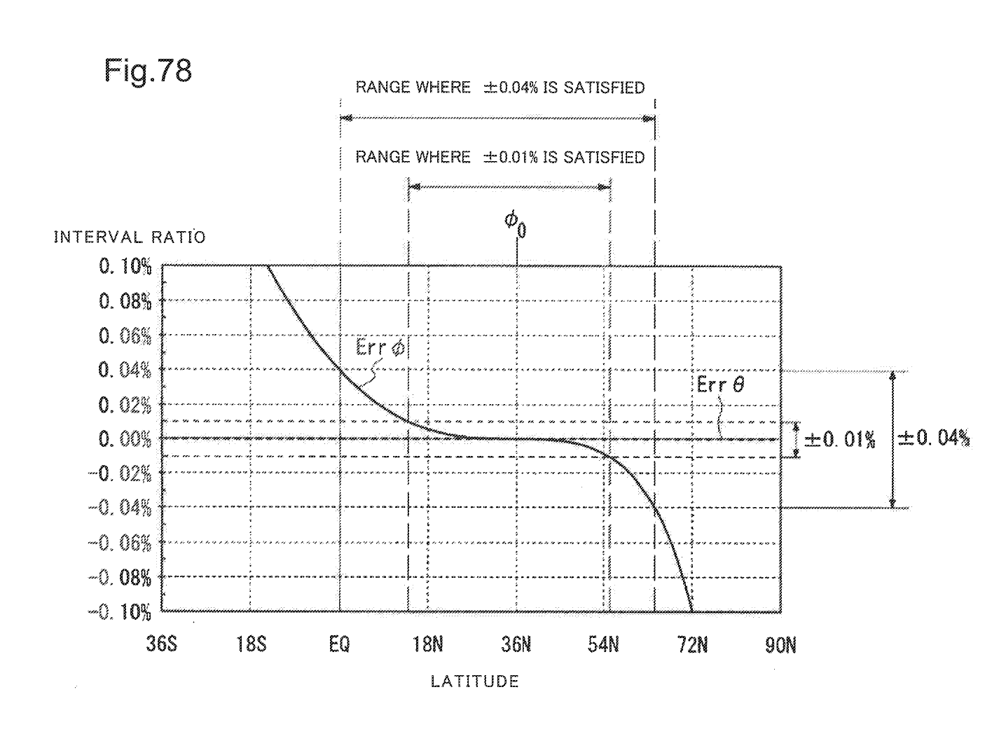

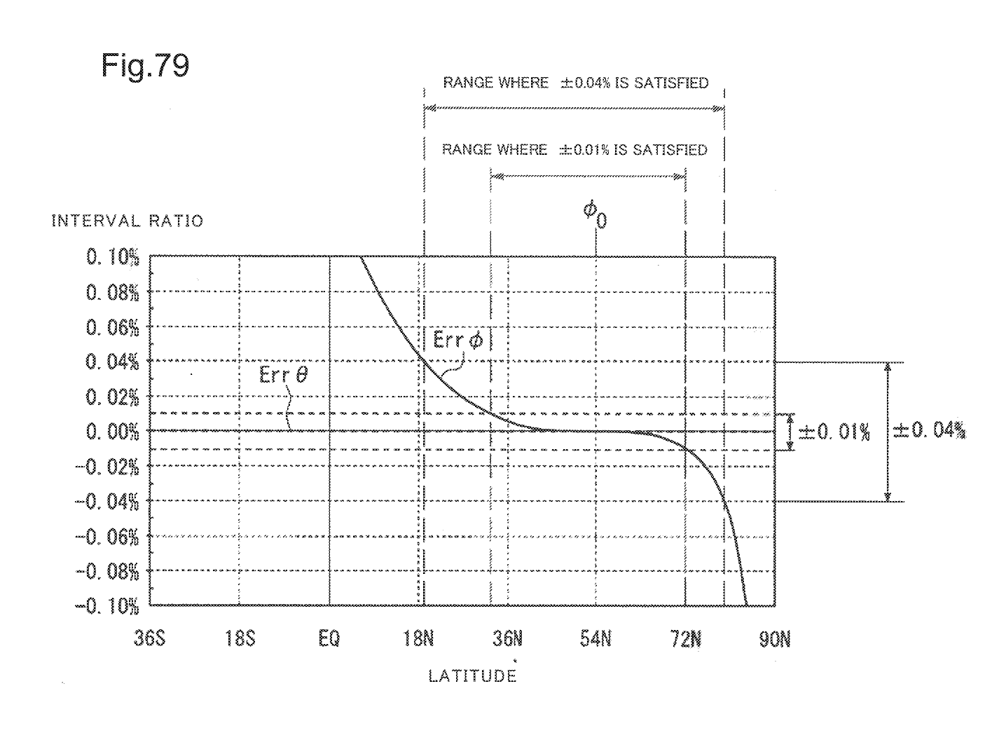

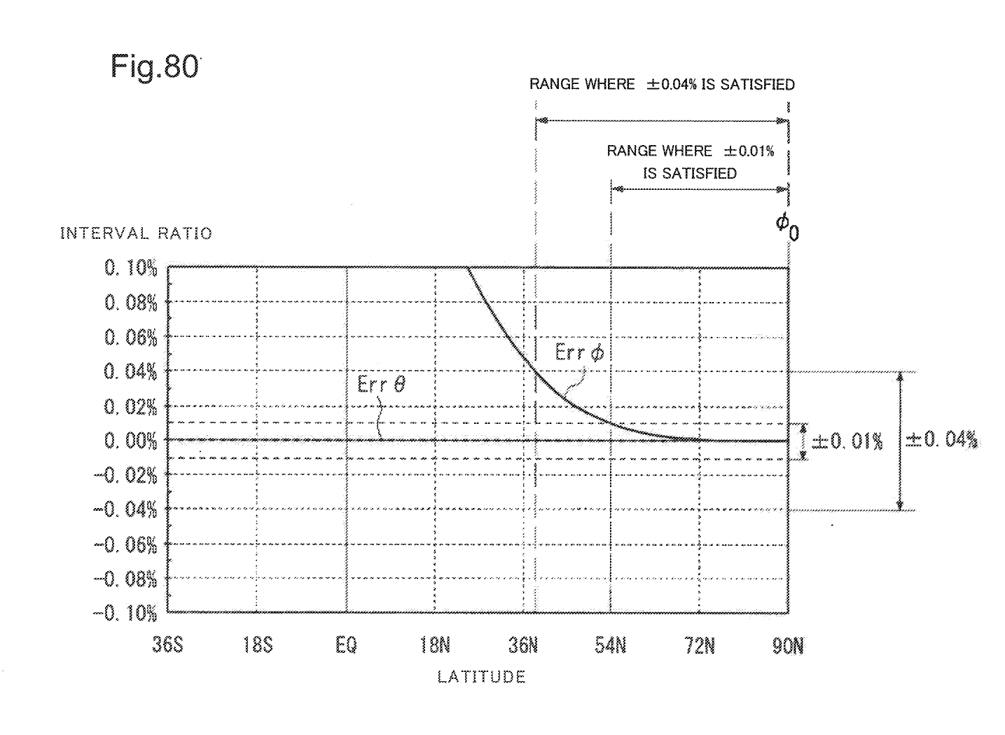

Next, an error rate between a latitude interval and a longitude interval in which a reference latitude θ₀ is changed will be described. The error rate referred to is a value indicating whether a projection latitude line interval and a projection longitude line interval after transformation are different from a latitude line interval and a longitude line interval in a spheroid EB, respectively. FIG. 76 is a graph illustrating latitude dependencies of an error rate Errθ of a latitude line interval and an error rate Errφ of a longitude line interval in which the reference latitude θ₀ is the equator (a latitude of 0 degrees north). FIG. 77 is a graph illustrating latitude dependencies of an error rate Errθ of a latitude line interval and an error rate Errφ of a longitude line interval in which the reference latitude θ₀ is a latitude of 18 degrees north. FIG. 78 is a graph illustrating latitude dependencies of an error rate Errθ of a latitude line interval and an error rate Errφ of a longitude line interval in which the reference latitude θ₀ is a latitude of 36 degrees north. FIG. 79 is a graph illustrating latitude dependencies of an error rate Errθ of a latitude line interval and an error rate Errφ of a longitude line interval in which the reference latitude θ₀ is a latitude of 54 degrees north. FIG. 80 is a graph illustrating latitude dependencies of an error rate Errθ of a latitude line interval and an error rate Errφ of a longitude line interval in which the reference latitude θ₀ is the North Pole (a latitude of 90 degrees north). The error rate Errθ of a latitude line interval is obtained by dividing a difference between Δθ and Dθ by Dθ. The error rate Errφ of a longitude line interval is obtained by dividing a difference between Δφ and Dφ by Dφ.

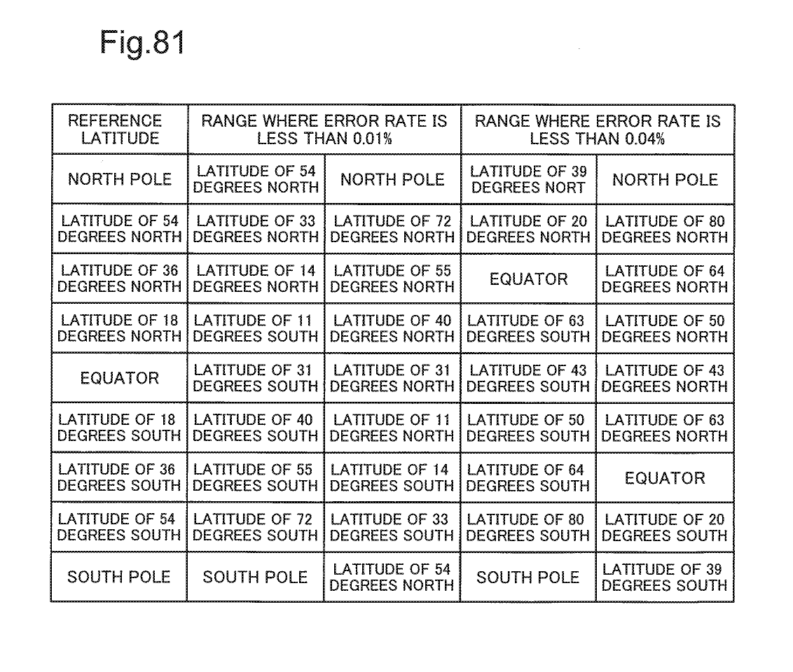

As described above, the error rate Errθ of a latitude line interval is sufficiently small at each reference latitude. However, when the reference latitude θ₀ is changed, an occurrence form of the error rate Errφ of a longitude line interval is changed. FIG. 81 is a table illustrating, upon changing a reference latitude, a latitude range where an error rate Errφ of a longitude line interval is less than a maximum error of 0.01% in a plane rectangular coordinate system and a latitude range where an error rate Errφ of a longitude line interval is less than an error of 0.04% at a standard meridian in the Universal Transverse Mercator. As illustrated in FIG. 81, the error rate Errφ of a longitude line interval can be suppressed to a sufficiently small value in a wide latitude range of several tens degrees.

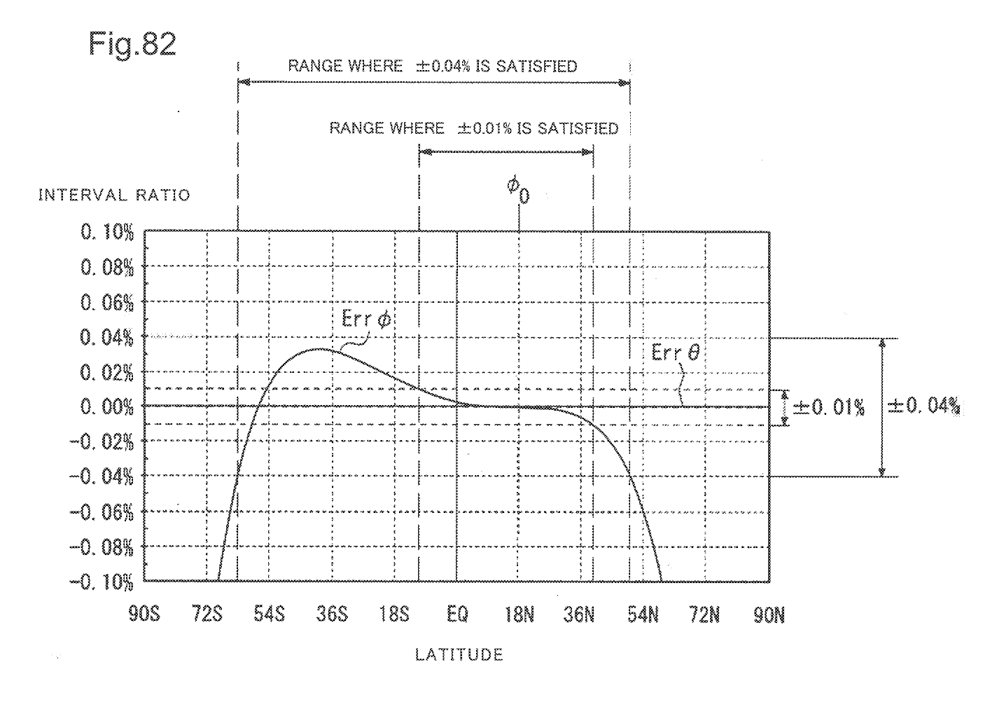

As illustrated in FIG. 81, when a latitude of 18 degrees north is set as a reference latitude θ₀, a range where the error rate Errφ of a longitude line interval is less than 0.04% is broad, and a south limit is a latitude of 63 degrees south. FIG. 82 is a graph illustrating latitude dependencies of an error rate Errθ of a latitude line interval and an error rate Errφ of a longitude line interval in which the reference latitude θ₀ is a latitude of 18 degrees north. It is thought that this is because the third-order term with respect to a latitude θ that is dominant at a high latitude and the fourth-order term with respect to a latitude θ that appears at a low latitude compare with each other. It is conceivable that this phenomenon is the same as in a case in which a latitude of 18 degrees south is set as a reference latitude θ₀ in FIG. 81.

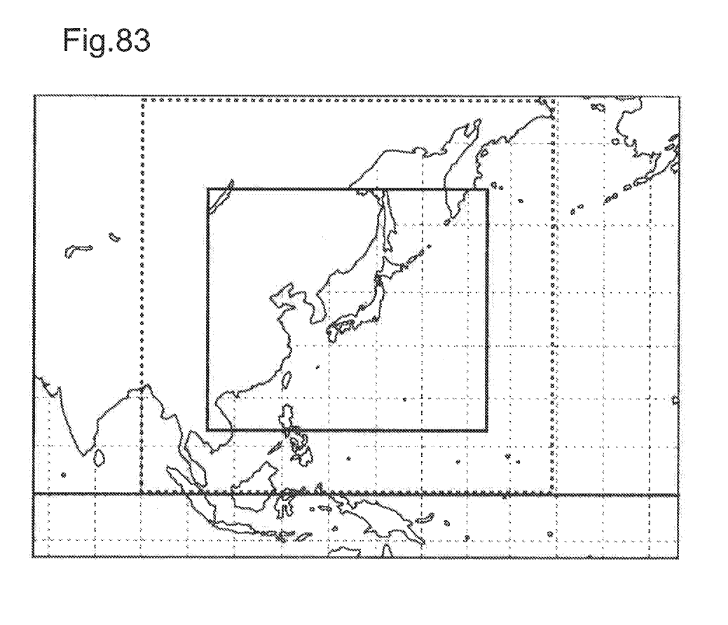

Assuming that the reference latitude θ₀ is set as a latitude of 35 degrees north, the error rate Errφ of a longitude line interval becomes less than 0.01% in a range from a latitude of 13 degrees north to a latitude of 54 degrees north and becomes less than 0.04% in a range from the equator (a latitude of 0 degrees north) to a latitude of 63 degrees north. FIG. 83 is a diagram illustrating ranges where an error rate Errφ of a longitude line interval near our country is less than 0.01% and less than 0.04% in which a latitude of 35 degrees north and a longitude of 135 degrees east are designated as a reference. In FIG. 83, the range where the error rate Errφ of a longitude line interval is less than 0.01% and the range where the error rate Errφ of a longitude line interval is less than 0.04% are illustrated with a solid line and a chain line, respectively. In FIG. 83, a longitude range is substantially the same as a latitude range, but the longitude range is not limited thereto. However, except that the reference latitude θ₀ is the North Pole or the South Pole, a value of a correction coefficient λ_{φ} of a longitude direction is different from 1, and therefore when the earth is orbited in an east-west direction, no return to a start point is made. Therefore, the longitude range is preferably approximately ±90 degrees at most with respect to a reference longitude.

As illustrated in FIG. 83, when the coordinate transformation method according to the present exemplary embodiment is used, it is possible to transform coordinates on a spheroid EB to projection coordinates on a true sphere CB at an error rate of less than 0.01% in a wide region to the extent that a territory and a territorial sea of our nation are included.

Further, when the coordinate transformation method according to the present exemplary embodiment is used by designating a latitude of 35 degrees north and a longitude of 135 degrees east as a reference, it is possible to transform coordinates on a spheroid EB to coordinates on a true sphere CB at an error rate of less than 0.04% in a wide region ranging from the equator to central Siberia at northern and southern ends and from the Indian Ocean to the central Pacific Ocean at eastern and western ends.

The geographical information management device 400 according to the present exemplary embodiment can be mounted in, for example, a passenger plane. In this case, when determining appropriate reference latitude and reference longitude and calculating transformation parameters, the device can execute appropriate coordinate transformation during a relatively long-distance flight using the calculated transformation parameters in light of a general flight leg of a passenger plane.

When, for example, a flight in which London is a start point is considered, for example, a passenger plane mounted with the geographical information management device 400 can be operated to Tokyo or New York at a coordinate transformation error rate of equal to or less than 0.01% via a single transformation parameter calculation. Further, the passenger plane can be operated to Rio de Janeiro at a coordinate transformation error rate of equal to or less than 0.04% via a single correction parameter calculation. To be operated to Rio de Janeiro at a coordinate transformation error rate of equal to or less than 0.01%, it is necessary for the geographical information management device 400 mounted in the passenger plane to calculate correction parameters twice. The following table represents a latitude range, a reference latitude, and an error rate of each operational route (flight leg).

TABLE 1

| | | | Applied | |
|---|---|---|---|---|
| Departure | | Latitude Range | Reference | |
| Place | Destination | of Flight Leg | Latitude | Error Rate |
| EGLL | RJAA | N35-N71 | N54 | equal to or |
| London | Tokyo (Narita) | | | less than |
| N51:28:39 | N35:45:50 | | | 0.01% |
| W000:27:41 | E140:23:30 | | | |
| EGLL | KJFK | N42-N52 | N54 | equal to or |
| London | New York | | | less than |
| N51:28:39 | N45:28:05 | | | 0.01% |
| W000:27:41 | W073:44:29 | | | |
| EGLL | SBGL | S23-N52 | S18 | equal to or |
| London | Rio de Janeiro | | | less than |
| N51:28:39 | S22:48:32 | | | 0.04% |
| W000:27:41 | W043:14:37 | | N36 + EQ | equal to or |
| | | | | less than |
| | | | | 0.01% |

In the table, departure places, destinations, and airport names are represented using the ICAO (International Civil Aviation Organization) code. In ICAO code, EGLL, RJAA, and SBGL represent Heathrow Airport (London, England), New Tokyo International Airport (Narita Airport, Japan), John F. Kennedy International Airport (New York, U.S.A.), and Antonio Carlos Jobim International Airport (Rio de Janeiro, Brazil), respectively.

On the other hand, to execute navigation calculation with an error rate of less than 0.01% by using, for example, a map of normalized orthonormal coordinates, it is necessary to execute a recalculation per approximately one degree thirty minutes. Therefore, frequent calculations are needed and a computer having high throughput is needed. This results in an increase in size of a calculation system, and therefore calculation executed by a moving body such as a passenger plane or the like is not realistic.

In contrast, the geographical information management device 400 can execute highly accurate coordinate transformation as described above by calculating correction parameters approximately once every several hours. Therefore, the device can be easily mounted in a moving body such as a passenger plane or the like in which downsizing of the calculation system is needed.

The geographical information management device 400 according to the present exemplary embodiment can project coordinates on the earth that is a spheroid on a true sphere with a suppressed error in a region broader than ever before. Thereby, the geographical information management device 400 can execute arithmetic processing using coordinate information of a true sphere on a true sphere in which mathematical processing is easily executed. Therefore, information on an operation of an aircraft can be further highly accurately processed in a small device at higher speed.

### Other Exemplary Embodiments

The present invention is not limited to the above-described exemplary embodiments and can be appropriately modified without departing from the spirit of the present invention. It goes without saying that, for example, the coordinate transformation unit according to the fourth exemplary embodiment can be added to the arithmetic unit 6 according to the second exemplary embodiment or the arithmetic unit 8 according to the third exemplary embodiment. In this case, the storage device 2 may be replaced with the storage device 7.

This application is based upon and claims the benefit of priority from Japanese patent application No. 2013-271712, filed on Dec. 27, 2013, the disclosure of which is incorporated herein in its entirety by reference.

### REFERENCE SIGNS LIST

1 Input device
2, 7 Storage device
3, 6, 8 Arithmetic unit
4 Display device
5 Bus
31 Candidate point detection unit
32 Intersection point detection unit
33 Overlapping determination unit
34 Coordinate transformation unit
100, 200, 400 Geographical information management device
A, B Airspace
C, C₁, C₂ Reference circle
CB True sphere
D1 Basic shape database
D2 Airspace information database
D3 Parameter information database
D4 Transformation source information database
EB Spheroid
L, LA, LB, L₁ to L₄ Line segment
LAB, LPA Straight line
OBJ Observation object

What is claimed is:

1. A shape determination device comprising:
a candidate point detection unit which detects, as a candidate point, a point of intersection between a first reference circle to which an inputted first line segment on an inputted true sphere belongs and a second reference circle to which an inputted second line segment on the true sphere belongs; and
an intersection point detection unit which determines whether the candidate point is an intersection point between the first line segment and the second line segment.

2. The shape determination device according to claim 1, wherein
when a unit normal vector with respect to the first reference circle is V₁, a unit normal vector with respect to the second reference circle is V₂, a parameter indicating a radius of the first reference circle is S₁, a parameter indicating a radius of the second reference circle is S₂, and a discriminant D is the following equation,
D=1−(\vec{V₁}·\vec{V₂})²−s₁²−s₂²+2s₁s₂(\vec{V₁}·\vec{V₂}) [Math. 1]
the candidate point detection unit calculates values of V₁, V₂, s₁, s₂, and the discriminant D,
determines that there are two candidate points when the discriminant D is more than 0,
determines that there is no candidate point when the discriminant D is less than 0,
determines that there is one candidate point when the discriminant D is 0 and the following equation is satisfied, and
(\vec{V₂}·\vec{V₁})²<1 [Math. 2]
determines that a start point and an end point of the first line segment and a start point and an end point of the second line segment are candidate points when the discriminant D is 0 and the above equation is not satisfied.

3. The shape determination device according to claim 2, wherein
the intersection point detection unit
determines that the candidate point belongs to a line segment when the line segment is a circle,
determines whether the line segment is an major arc when the line segment is not a circle,
determines, when the line segment is a major arc, that the candidate point is an intersection point when at least any one of the following two numerical equations is established in which a start point of the line segment is PS, an end point of the line segment is PE, a position vector of the candidate point is Pc, and a normal vector with respect to a reference circle to which the line segment belongs is V, and
\vec{P_{c}}·(\vec{V}×\vec{PS})≧0 [Math. 3]
\vec{P_{c}}·(\vec{V}×\vec{PE})≦0 [Math. 4]
determines, when the line segment is not a major arc, that the candidate point is an intersection point when both of the two numerical equations are established.

4. The shape determination device according to claim 3, wherein
when real numbers β, γ, and δ are calculated using the following numerical equations, respectively,
$$\begin{matrix}β = \frac{{s}_{1} - {s}_{2} ( {\vec{V}}_{1} \cdot \vec{{V}_{2}} )}{1 - {( {\vec{V}}_{1} \cdot \vec{{V}_{2}} )}^{2}} & [ Math . 5 ] \\ γ = \frac{{s}_{2} - {s}_{1} ( {\vec{V}}_{1} \cdot \vec{{V}_{2}} )}{1 - ( {\vec{V}}_{1} \cdot \vec{{V}_{2}} )} & [ Math . 6 ] \\ δ = \frac{\pm \sqrt{D}}{1 - {( {\vec{V}}_{1} \cdot \vec{{V}_{2}} )}^{2}} & [ Math . 7 ]\end{matrix}$$
the intersection point detection unit calculates a position vector of the candidate point Pc that is a position vector of the intersection point using the following equation.
\vec{P_{c}}=β\vec{V₁}+γ\vec{V₂}+δ\vec{V₁}×\vec{V₂} [Math. 8]

5. The shape determination device according to claim 1, further comprising
an overlapping determination unit which determines whether an inputted first region surrounded by line segments on the true sphere and an inputted second region surrounded by line segments on the true sphere are overlapped with each other.

6. The shape determination device according to claim 5, wherein
the overlapping determination unit
determines whether the first region and the second region have an intersection point,
determines that the second region is present outside the first region when the first region and the second region have intersection points and the first region and the second region are circumscribed at all of the intersection points,
determines that the second region is at least partially overlapped with the first region when the first region and the second region have intersection points and there is an intersection point at which the first region and the second region are not circumscribed among all of the intersection points, and
determines an inside/outside relation between the first region and the second region when the first region and the second region have no intersection point.

7. The shape determination device according to claim 6, wherein
when the first region and the second region have no intersection point, the overlapping determination unit
sets a second point on a line segment configuring the second region,
sets a first point on a line segment configuring the first region,
sets a straight line passing through the first point and the second point,
detects all intersection points between the set line segment and the first region,
sets a first intersection point closest to the second point among the detected intersection points,
sets a normal vector with respect to an outgoing line vector toward the second point from the first intersection point,
determines that the first region is present outside the second region when the normal vector is present outside the second region, and
determines that the first region is present inside the second region when the normal vector is not present outside the second region.

8. The shape determination device according to claim 1, further comprising
a coordinate transformation unit which calculates and stores a transformation parameter from previously provided information that specifies a shape of a spheroid, inputs information indicating coordinates in the spheroid, transforms the information indicating the coordinates of the spheroid to coordinates in the true sphere from the stored transformation parameter and a predetermined numerical equation, and outputs information indicating the coordinates in the true sphere obtained by the transformation.

9. The shape determination device according to claim 8, wherein
the coordinate transformation unit transforms three-dimensional polar coordinates of the spheroid to polar coordinates of the true sphere using the stored transformation parameter, and transforms the polar coordinates of the true sphere to three-dimensional orthogonal coordinates of the true sphere.

10. The shape determination device according to claim 9, wherein
the spheroid represents a shape of the earth,
a radius, a latitude, and a longitude of the earth are used for the polar coordinates of the spheroid, and a radius, a latitude, and a longitude of the true sphere are used for the polar coordinates of the true sphere.

11. The shape determination device according to claim 10, wherein
the coordinate transformation unit
determines the transformation parameter under a condition where
in a predetermined reference latitude, a latitude line interval of the spheroid is equal to a latitude line interval in a projection reference latitude of the true sphere,
in the reference latitude, a longitude line interval of the spheroid is equal to a longitude line interval in the projection reference latitude of the true sphere,
in the reference latitude, a first-order change rate of a latitude direction of the latitude line interval of the spheroid is equal to a first-order change rate of a latitude direction of the latitude line interval in the projection reference latitude of the true sphere,
in the reference latitude, a first-order change rate of a latitude direction of the longitude line interval of the spheroid is equal to a first-order change rate of a latitude direction of the longitude line interval in the projection reference latitude of the true sphere, and
in the reference latitude, a second-order change rate of a latitude direction of the longitude line interval of the spheroid is equal to a second-order change rate of a latitude direction of the longitude line interval in the projection reference latitude of the true sphere.

12. The shape determination device according to claim 11, wherein
when a latitude of the spheroid is θ, a longitude of the spheroid is φ, a latitude of the true sphere is Θ, a longitude of the true sphere is Φ, an equatorial radius of the spheroid is a, an altitude is h, an eccentricity of the spheroid is e, a radius of the true sphere is R, the reference latitude is θ₀, a reference longitude is φ₀, and an integral constant upon determining the projection reference latitude Θ₀ using the following equation is C,
$${Θ}_{0} = {tan}^{- 1} ( \frac{\sqrt{1 - {e}^{2}}}{\sqrt{1 - {e}^{2} {sin}^{2} {θ}_{0}}} tan {θ}_{0} ) \qquad [ Math . 9 ]$$
the coordinate transformation unit
transforms, when the transformation parameter for transforming an equatorial radius a of the spheroid to a radius R of the true sphere is Pr, an inputted equatorial radius a of the spheroid to a radius R of the true sphere using the following numerical equation,
$$R = Pr \cdot a \\ Pr = \frac{\sqrt{( 1 - {e}^{2} )}}{( 1 - {e}^{2} {sin}^{2} {θ}_{0} )} \qquad [ Math . 10 ]$$
transforms, when the transformation parameter for transforming a longitude φ of the spheroid to a longitude Φ of the true sphere is λ_{φ}, a longitude φ of the spheroid to a longitude Φ of the true sphere using the following numerical equation,
$$Φ = {λ}_{φ} ( φ - {φ}_{0} ) \\ {λ}_{φ} = \sqrt{\frac{1 - {e}^{2} {sin}^{2} {θ}_{0} ( 1 + {cos}^{2} {θ}_{0} )}{1 - {e}^{2}}} \qquad [ Math . 11 ]$$
transforms, when Π is a third-kind elliptical integral, a latitude θ of the spheroid to a latitude Θ of the true sphere using the following numerical equation, and
$$Θ = \frac{a ( 1 - {e}^{2} )}{R} Π ( {e}^{2} ; θ , e ) + C \qquad [ Math . 12 ]$$
calculates three-dimensional orthogonal coordinates (X,Y,Z) of the true sphere using the following numerical equation.
X=(R+h)cos Θ cos Φ
Y=(R+h)cos Θ sin Φ
Z=(R+h)sin Θ [Math. 13]

13. The shape determination device according to claim 12, wherein
instead of the following numerical equation using an elliptical integral,
$$Θ = \frac{a ( 1 - {e}^{2} )}{R} Π ( {e}^{2} ; θ , e ) + C \qquad [ Math . 14 ]$$
the coordinate transformation unit transforms a latitude θ of the spheroid to a latitude Θ of the true sphere on the basis of the following numerical equation where the transformation parameters for transforming the latitude θ of the spheroid to the latitude Θ of the true sphere are λ₀, λ₂, λ₄, λ₆, λ₈, and λ_{θ} and a third flattening is n.
$$\begin{matrix}Θ = {λ}_{θ} θ + {λ}_{2} sin 2 θ + {λ}_{4} sin 4 θ + {λ}_{6} sin 6 θ + {λ}_{8} sin 8 θ + {λ}_{0} \\ n = \frac{f}{2 - f} \\ {λ}_{θ} = \frac{a}{( 1 + n ) R} ( 1 + \frac{{n}^{2}}{4} + \frac{{n}^{4}}{64} ) \\ \begin{matrix} {λ}_{2} = \frac{- 3 a}{2 ( 1 + n ) R} ( n - \frac{{n}^{3}}{8} ) \\ {λ}_{4} = \frac{15 a}{16 ( 1 + n ) R} ( {n}^{2} - \frac{{n}^{4}}{4} ) \\ {λ}_{6} = \frac{- 35 a {n}^{3}}{48 ( 1 + n ) R} \\ {λ}_{8} = \frac{315 a {n}^{4}}{512 ( 1 + n ) R} \\ {λ}_{0} = {Θ}_{0} - ( {λ}_{θ} {θ}_{0} + {λ}_{2} sin 2 {θ}_{0} + {λ}_{4} sin 4 {θ}_{0} + {λ}_{6} sin 6 {θ}_{0} + {λ}_{8} sin 8 {θ}_{0} )\end{matrix}\end{matrix} \qquad [ Math . 15 ]$$

14. A non-transitory computer readable storage medium recording thereon a shape determination program, causing a computer to perform a method comprising:
detecting, as a candidate point, a point of intersection between a first reference circle to which an inputted first line segment on an inputted true sphere belongs and a second reference circle to which an inputted second line segment on the true sphere belongs; and
determining whether the candidate point is an intersection point between the first line segment and the second line segment.

15. A shape determination method comprising:
detecting, as a candidate point, a point of intersection between a first reference circle to which an inputted first line segment on an inputted true sphere belongs and a second reference circle to which an inputted second line segment on the true sphere belongs; and
determining whether the candidate point is an intersection point between the first line segment and the second line segment.

16. A shape determination device comprising:
a candidate point detection means for detecting, as a candidate point, a point of intersection between a first reference circle to which an inputted first line segment on an inputted true sphere belongs and a second reference circle to which an inputted second line segment on the true sphere belongs; and
an intersection point detection means for determining whether the candidate point is an intersection point between the first line segment and the second line segment.
